(19) United States
(12) Patent Application Publication
(10) Pub. No.: US 2025/0390203 A1
(43) Pub. Date: Dec. 25, 2025

(54) TECHNIQUES FOR MANAGING EVENTS

(71) Applicant: Apple Inc., Cupertino, CA (US)

(72) Inventors: Marcel V. MULLER, Campbell, CA (US); Hannah S. STORY, San Mateo, CA (US)

(21) Appl. No.: 19/214,179

(22) Filed: May 21, 2025

Related U.S. Application Data
(60) Provisional application No. 63/662,883, filed on Jun. 21, 2024.

(51) Int. Cl. G06F 3/0484; G06F 3/0482; G06F 3/14

(52) U.S. Cl. CPC G06F 3/0484; G06F 3/0482; G06F 3/1454

(57) ABSTRACT

The present disclosure generally relates to managing events. Some techniques are for receiving and responding to an event invitation in accordance with some embodiments. Other techniques are for presenting events in accordance with some embodiments. Other techniques are for adding user interface elements to events in accordance with some embodiments. Other techniques are for sharing an event in accordance with some embodiments.

### CROSS-REFERENCE TO RELATED APPLICATIONS

This patent application claims priority to U.S. Provisional Patent Application Ser. No. 63/662,883, entitled “TECHNIQUES FOR MANAGING EVENTS” filed Jun. 21, 2024, which is hereby incorporated by reference in its entirety for all purposes.

### FIELD

The present disclosure relates generally to computer user interfaces, and more specifically to techniques for managing events.

### BACKGROUND

Digital invitations to events can present challenges, such as managing guest lists and tracking RSVPs efficiently. Additionally, coordinating and sending updates or reminders can become cumbersome without a streamlined system.

### SUMMARY

Some techniques for managing events using electronic devices are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices.

Accordingly, the present technique provides electronic devices with faster, more efficient processes and interfaces for managing events. Such processes and interfaces optionally complement or replace other processes for managing events. Such processes and interfaces reduce the cognitive burden on a user and produce a more efficient human-machine interface. For battery-operated computing devices, such processes and interfaces conserve power and increase the time between battery charges.

In some embodiments, a method that is performed at a first computer system that is in communication with one or more input devices and one or more display generation components is described. In some embodiments, the method comprises: while the first computer system is within proximity to a second computer system, different from the first computer system, and without detecting an input via the one or more input devices, receiving, from the second computer system via a peer-to-peer connection, an invitation to an event; in response to receiving the invitation to the event from the second computer system, displaying, via the one or more display generation components, a first representation of the event concurrently with a control for accepting the invitation to the event; while displaying the control for accepting the invitation to the event, detecting, via the one or more input devices, an input corresponding to the control for accepting the invitation to the event; and in response to detecting the first input corresponding to the control for accepting the invitation to the event, displaying, via the one or more display generation components, an indication that the invitation to the event has been accepted.

In some embodiments, a non-transitory computer-readable storage medium storing one or more programs configured to be executed by one or more processors of a first computer system that is in communication with one or more input devices and one or more display generation components is described. In some embodiments, the one or more programs includes instructions for: while the first computer system is within proximity to a second computer system, different from the first computer system, and without detecting an input via the one or more input devices, receiving, from the second computer system via a peer-to-peer connection, an invitation to an event; in response to receiving the invitation to the event from the second computer system, displaying, via the one or more display generation components, a first representation of the event concurrently with a control for accepting the invitation to the event; while displaying the control for accepting the invitation to the event, detecting, via the one or more input devices, an input corresponding to the control for accepting the invitation to the event; and in response to detecting the first input corresponding to the control for accepting the invitation to the event, displaying, via the one or more display generation components, an indication that the invitation to the event has been accepted.

In some embodiments, a transitory computer-readable storage medium storing one or more programs configured to be executed by one or more processors of a first computer system that is in communication with one or more input devices and one or more display generation components is described. In some embodiments, the one or more programs includes instructions for: while the first computer system is within proximity to a second computer system, different from the first computer system, and without detecting an input via the one or more input devices, receiving, from the second computer system via a peer-to-peer connection, an invitation to an event; in response to receiving the invitation to the event from the second computer system, displaying, via the one or more display generation components, a first representation of the event concurrently with a control for accepting the invitation to the event; while displaying the control for accepting the invitation to the event, detecting, via the one or more input devices, an input corresponding to the control for accepting the invitation to the event; and in response to detecting the first input corresponding to the control for accepting the invitation to the event, displaying, via the one or more display generation components, an indication that the invitation to the event has been accepted.

In some embodiments, a first computer system configured to communicate with one or more input devices and one or more display generation components is described. In some embodiments, the first computer system comprises one or more processors and memory storing one or more programs configured to be executed by the one or more processors. In some embodiments, the one or more programs includes instructions for: while the first computer system is within proximity to a second computer system, different from the first computer system, and without detecting an input via the one or more input devices, receiving, from the second computer system via a peer-to-peer connection, an invitation to an event; in response to receiving the invitation to the event from the second computer system, displaying, via the one or more display generation components, a first representation of the event concurrently with a control for accepting the invitation to the event; while displaying the control for accepting the invitation to the event, detecting, via the one or more input devices, an input corresponding to the control for accepting the invitation to the event; and in response to detecting the first input corresponding to the control for accepting the invitation to the event, displaying, via the one or more display generation components, an indication that the invitation to the event has been accepted.

In some embodiments, a first computer system configured to communicate with one or more input devices and one or more display generation components is described. In some embodiments, the first computer system comprises means for performing each of the following steps: while the first computer system is within proximity to a second computer system, different from the first computer system, and without detecting an input via the one or more input devices, receiving, from the second computer system via a peer-to-peer connection, an invitation to an event; in response to receiving the invitation to the event from the second computer system, displaying, via the one or more display generation components, a first representation of the event concurrently with a control for accepting the invitation to the event; while displaying the control for accepting the invitation to the event, detecting, via the one or more input devices, an input corresponding to the control for accepting the invitation to the event; and in response to detecting the first input corresponding to the control for accepting the invitation to the event, displaying, via the one or more display generation components, an indication that the invitation to the event has been accepted.

In some embodiments, a computer program product is described. In some embodiments, the computer program product comprises one or more programs configured to be executed by one or more processors of a first computer system that is in communication with one or more input devices and one or more display generation components. In some embodiments, the one or more programs include instructions for: while the first computer system is within proximity to a second computer system, different from the first computer system, and without detecting an input via the one or more input devices, receiving, from the second computer system via a peer-to-peer connection, an invitation to an event; in response to receiving the invitation to the event from the second computer system, displaying, via the one or more display generation components, a first representation of the event concurrently with a control for accepting the invitation to the event; while displaying the control for accepting the invitation to the event, detecting, via the one or more input devices, an input corresponding to the control for accepting the invitation to the event; and in response to detecting the first input corresponding to the control for accepting the invitation to the event, displaying, via the one or more display generation components, an indication that the invitation to the event has been accepted.

In some embodiments, a method that is performed at a computer system that is in communication with one or more input devices and one or more display generation components is described. In some embodiments, the method comprises: detecting, via the one or more input devices, an input corresponding to a request to view one or more events; in response to detecting the input corresponding to the request to view the one or more events, displaying, via the one or more display generation components, a first preview of a first event, wherein: in accordance with a determination that the first event includes shared content, the first preview of the first event includes at least a portion of content from the shared content; and in accordance with a determination that the first event does not include the shared content, the first preview of the first event does not include the portion of the content from the shared content.

In some embodiments, a non-transitory computer-readable storage medium storing one or more programs configured to be executed by one or more processors of a computer system that is in communication with one or more input devices and one or more display generation components is described. In some embodiments, the one or more programs includes instructions for: detecting, via the one or more input devices, an input corresponding to a request to view one or more events; in response to detecting the input corresponding to the request to view the one or more events, displaying, via the one or more display generation components, a first preview of a first event, wherein: in accordance with a determination that the first event includes shared content, the first preview of the first event includes at least a portion of content from the shared content; and in accordance with a determination that the first event does not include the shared content, the first preview of the first event does not include the portion of the content from the shared content.

In some embodiments, a transitory computer-readable storage medium storing one or more programs configured to be executed by one or more processors of a computer system that is in communication with one or more input devices and one or more display generation components is described. In some embodiments, the one or more programs includes instructions for: detecting, via the one or more input devices, an input corresponding to a request to view one or more events; in response to detecting the input corresponding to the request to view the one or more events, displaying, via the one or more display generation components, a first preview of a first event, wherein: in accordance with a determination that the first event includes shared content, the first preview of the first event includes at least a portion of content from the shared content; and in accordance with a determination that the first event does not include the shared content, the first preview of the first event does not include the portion of the content from the shared content.

In some embodiments, a computer system configured to communicate with one or more input devices and one or more display generation components is described. In some embodiments, the computer system comprises one or more processors and memory storing one or more programs configured to be executed by the one or more processors. In some embodiments, the one or more programs includes instructions for: detecting, via the one or more input devices, an input corresponding to a request to view one or more events; in response to detecting the input corresponding to the request to view the one or more events, displaying, via the one or more display generation components, a first preview of a first event, wherein: in accordance with a determination that the first event includes shared content, the first preview of the first event includes at least a portion of content from the shared content; and in accordance with a determination that the first event does not include the shared content, the first preview of the first event does not include the portion of the content from the shared content.

In some embodiments, a computer system configured to communicate with one or more input devices and one or more display generation components is described. In some embodiments, the computer system comprises means for performing each of the following steps: detecting, via the one or more input devices, an input corresponding to a request to view one or more events; in response to detecting the input corresponding to the request to view the one or more events, displaying, via the one or more display generation components, a first preview of a first event, wherein: in accordance with a determination that the first event includes shared content, the first preview of the first event includes at least a portion of content from the shared content; and in accordance with a determination that the first event does not include the shared content, the first preview of the first event does not include the portion of the content from the shared content.

In some embodiments, a computer program product is described. In some embodiments, the computer program product comprises one or more programs configured to be executed by one or more processors of a computer system that is in communication with one or more input devices and one or more display generation components. In some embodiments, the one or more programs include instructions for: detecting, via the one or more input devices, an input corresponding to a request to view one or more events; in response to detecting the input corresponding to the request to view the one or more events, displaying, via the one or more display generation components, a first preview of a first event, wherein: in accordance with a determination that the first event includes shared content, the first preview of the first event includes at least a portion of content from the shared content; and in accordance with a determination that the first event does not include the shared content, the first preview of the first event does not include the portion of the content from the shared content.

In some embodiments, a method that is performed at a computer system that is in communication with one or more input devices and one or more display generation components is described. In some embodiments, the method comprises: displaying, via the one or more display generation components, a user interface of a first event, wherein the user interface of the first event includes a control for adding a user interface element of a respective application; detecting, via the one or more input devices, a set of one or more inputs including an input corresponding to the control for adding the user interface element of the respective application; and in response to detecting the set of one or more inputs: in accordance with a determination that the respective application is a first application, adding a user interface element of the first application to the user interface of the first event; and in accordance with a determination that the respective application is a second application different from the first application, adding a user interface element of the second application to the user interface of the first event.

In some embodiments, a non-transitory computer-readable storage medium storing one or more programs configured to be executed by one or more processors of a computer system that is in communication with one or more input devices and one or more display generation components is described. In some embodiments, the one or more programs includes instructions for: displaying, via the one or more display generation components, a user interface of a first event, wherein the user interface of the first event includes a control for adding a user interface element of a respective application; detecting, via the one or more input devices, a set of one or more inputs including an input corresponding to the control for adding the user interface element of the respective application; and in response to detecting the set of one or more inputs: in accordance with a determination that the respective application is a first application, adding a user interface element of the first application to the user interface of the first event; and in accordance with a determination that the respective application is a second application different from the first application, adding a user interface element of the second application to the user interface of the first event.

In some embodiments, a transitory computer-readable storage medium storing one or more programs configured to be executed by one or more processors of a computer system that is in communication with one or more input devices and one or more display generation components is described. In some embodiments, the one or more programs includes instructions for: displaying, via the one or more display generation components, a user interface of a first event, wherein the user interface of the first event includes a control for adding a user interface element of a respective application; detecting, via the one or more input devices, a set of one or more inputs including an input corresponding to the control for adding the user interface element of the respective application; and in response to detecting the set of one or more inputs: in accordance with a determination that the respective application is a first application, adding a user interface element of the first application to the user interface of the first event; and in accordance with a determination that the respective application is a second application different from the first application, adding a user interface element of the second application to the user interface of the first event.

In some embodiments, a computer system configured to communicate with one or more input devices and one or more display generation components is described. In some embodiments, the computer system comprises one or more processors and memory storing one or more programs configured to be executed by the one or more processors. In some embodiments, the one or more programs includes instructions for: displaying, via the one or more display generation components, a user interface of a first event, wherein the user interface of the first event includes a control for adding a user interface element of a respective application; detecting, via the one or more input devices, a set of one or more inputs including an input corresponding to the control for adding the user interface element of the respective application; and in response to detecting the set of one or more inputs: in accordance with a determination that the respective application is a first application, adding a user interface element of the first application to the user interface of the first event; and in accordance with a determination that the respective application is a second application different from the first application, adding a user interface element of the second application to the user interface of the first event.

In some embodiments, a computer system configured to communicate with one or more input devices and one or more display generation components is described. In some embodiments, the computer system comprises means for performing each of the following steps: displaying, via the one or more display generation components, a user interface of a first event, wherein the user interface of the first event includes a control for adding a user interface element of a respective application; detecting, via the one or more input devices, a set of one or more inputs including an input corresponding to the control for adding the user interface element of the respective application; and in response to detecting the set of one or more inputs: in accordance with a determination that the respective application is a first application, adding a user interface element of the first application to the user interface of the first event; and in accordance with a determination that the respective application is a second application different from the first application, adding a user interface element of the second application to the user interface of the first event.

In some embodiments, a computer program product is described. In some embodiments, the computer program product comprises one or more programs configured to be executed by one or more processors of a computer system that is in communication with one or more input devices and one or more display generation components. In some embodiments, the one or more programs include instructions for: displaying, via the one or more display generation components, a user interface of a first event, wherein the user interface of the first event includes a control for adding a user interface element of a respective application; detecting, via the one or more input devices, a set of one or more inputs including an input corresponding to the control for adding the user interface element of the respective application; and in response to detecting the set of one or more inputs: in accordance with a determination that the respective application is a first application, adding a user interface element of the first application to the user interface of the first event; and in accordance with a determination that the respective application is a second application different from the first application, adding a user interface element of the second application to the user interface of the first event.

In some embodiments, a method that is performed at a first computer system that is in communication with one or more input devices and one or more display generation components is described. In some embodiments, the method comprises: receiving, from a second computer system different from the first computer system, an invitation to an event; after receiving the invitation to the event, detecting, via the one or more input devices, an input corresponding to a request to attend the event; after detecting the input corresponding to the request to attend the event, detecting, via the one or more input devices, an input corresponding to a request to view information corresponding to the event; and in response to detecting the input corresponding to the request to view information corresponding to the event: in accordance with a determination that a first set of one or more criteria is satisfied, displaying, via the one or more display generation components, a control to share the event with another computer system; and in accordance with a determination that the first set of one or more criteria is not satisfied, forgoing display of, via the one or more display generation components, the control to share the event with another computer system.

In some embodiments, a non-transitory computer-readable storage medium storing one or more programs configured to be executed by one or more processors of a first computer system that is in communication with one or more input devices and one or more display generation components is described. In some embodiments, the one or more programs includes instructions for: receiving, from a second computer system different from the first computer system, an invitation to an event; after receiving the invitation to the event, detecting, via the one or more input devices, an input corresponding to a request to attend the event; after detecting the input corresponding to the request to attend the event, detecting, via the one or more input devices, an input corresponding to a request to view information corresponding to the event; and in response to detecting the input corresponding to the request to view information corresponding to the event: in accordance with a determination that a first set of one or more criteria is satisfied, displaying, via the one or more display generation components, a control to share the event with another computer system; and in accordance with a determination that the first set of one or more criteria is not satisfied, forgoing display of, via the one or more display generation components, the control to share the event with another computer system.

In some embodiments, a transitory computer-readable storage medium storing one or more programs configured to be executed by one or more processors of a first computer system that is in communication with one or more input devices and one or more display generation components is described. In some embodiments, the one or more programs includes instructions for: receiving, from a second computer system different from the first computer system, an invitation to an event; after receiving the invitation to the event, detecting, via the one or more input devices, an input corresponding to a request to attend the event; after detecting the input corresponding to the request to attend the event, detecting, via the one or more input devices, an input corresponding to a request to view information corresponding to the event; and in response to detecting the input corresponding to the request to view information corresponding to the event: in accordance with a determination that a first set of one or more criteria is satisfied, displaying, via the one or more display generation components, a control to share the event with another computer system; and in accordance with a determination that the first set of one or more criteria is not satisfied, forgoing display of, via the one or more display generation components, the control to share the event with another computer system.

In some embodiments, a first computer system configured to communicate with one or more input devices and one or more display generation components is described. In some embodiments, the first computer system comprises one or more processors and memory storing one or more programs configured to be executed by the one or more processors. In some embodiments, the one or more programs includes instructions for: receiving, from a second computer system different from the first computer system, an invitation to an event; after receiving the invitation to the event, detecting, via the one or more input devices, an input corresponding to a request to attend the event; after detecting the input corresponding to the request to attend the event, detecting, via the one or more input devices, an input corresponding to a request to view information corresponding to the event; and in response to detecting the input corresponding to the request to view information corresponding to the event: in accordance with a determination that a first set of one or more criteria is satisfied, displaying, via the one or more display generation components, a control to share the event with another computer system; and in accordance with a determination that the first set of one or more criteria is not satisfied, forgoing display of, via the one or more display generation components, the control to share the event with another computer system.

In some embodiments, a first computer system configured to communicate with one or more input devices and one or more display generation components is described. In some embodiments, the first computer system comprises means for performing each of the following steps: receiving, from a second computer system different from the first computer system, an invitation to an event; after receiving the invitation to the event, detecting, via the one or more input devices, an input corresponding to a request to attend the event; after detecting the input corresponding to the request to attend the event, detecting, via the one or more input devices, an input corresponding to a request to view information corresponding to the event; and in response to detecting the input corresponding to the request to view information corresponding to the event: in accordance with a determination that a first set of one or more criteria is satisfied, displaying, via the one or more display generation components, a control to share the event with another computer system; and in accordance with a determination that the first set of one or more criteria is not satisfied, forgoing display of, via the one or more display generation components, the control to share the event with another computer system.

In some embodiments, a computer program product is described. In some embodiments, the computer program product comprises one or more programs configured to be executed by one or more processors of a first computer system that is in communication with one or more input devices and one or more display generation components. In some embodiments, the one or more programs include instructions for: receiving, from a second computer system different from the first computer system, an invitation to an event; after receiving the invitation to the event, detecting, via the one or more input devices, an input corresponding to a request to attend the event; after detecting the input corresponding to the request to attend the event, detecting, via the one or more input devices, an input corresponding to a request to view information corresponding to the event; and in response to detecting the input corresponding to the request to view information corresponding to the event: in accordance with a determination that a first set of one or more criteria is satisfied, displaying, via the one or more display generation components, a control to share the event with another computer system; and in accordance with a determination that the first set of one or more criteria is not satisfied, forgoing display of, via the one or more display generation components, the control to share the event with another computer system.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient processes and interfaces for managing events, thereby increasing the effectiveness, efficiency, and user satisfaction with such devices. Such processes and interfaces may complement or replace other processes for managing events.

### DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3A is a block diagram of an exemplary multifunction device with a display and a touch-sensitive surface in accordance with some embodiments.

FIGS. 3B-3G illustrate the use of Application Programming Interfaces (APIs) to perform operations in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 6A-6F illustrate exemplary user interfaces for sharing an event invitation in accordance with some embodiments.

FIG. 7 is a flow diagram illustrating a process for receiving and responding to an event invitation in accordance with some embodiments.

FIGS. 8A-8AK illustrate exemplary user interfaces for interacting with an event invitation in accordance with some embodiments.

FIG. 9 is a flow diagram illustrating a process for presenting events in accordance with some embodiments.

FIG. 10 is a flow diagram illustrating a process for adding user interface elements to events in accordance with some embodiments.

FIG. 11 is a flow diagram illustrating a process for sharing an event in accordance with some embodiments.

### DETAILED DESCRIPTION

The following description sets forth exemplary processes, parameters, and the like. It should be recognized, however, that such description is not intended as a limitation on the scope of the present disclosure but is instead provided as a description of exemplary embodiments.

There is a need for electronic devices that provide efficient processes and interfaces for managing events. For example, electronic devices receive and accept an invitation to an event received via a peer-to-peer connection. In another example, electronic devices display previews of events with shared content based on whether an event includes the shared content. In another example, an event is selectively added user interface elements of different applications. In another example, electronic devices display controls to share an event based on if criteria are satisfied. Such techniques can reduce the cognitive burden on a user who accesses event notifications, thereby enhancing productivity. Further, such techniques can reduce processor and battery power otherwise wasted on redundant user inputs.

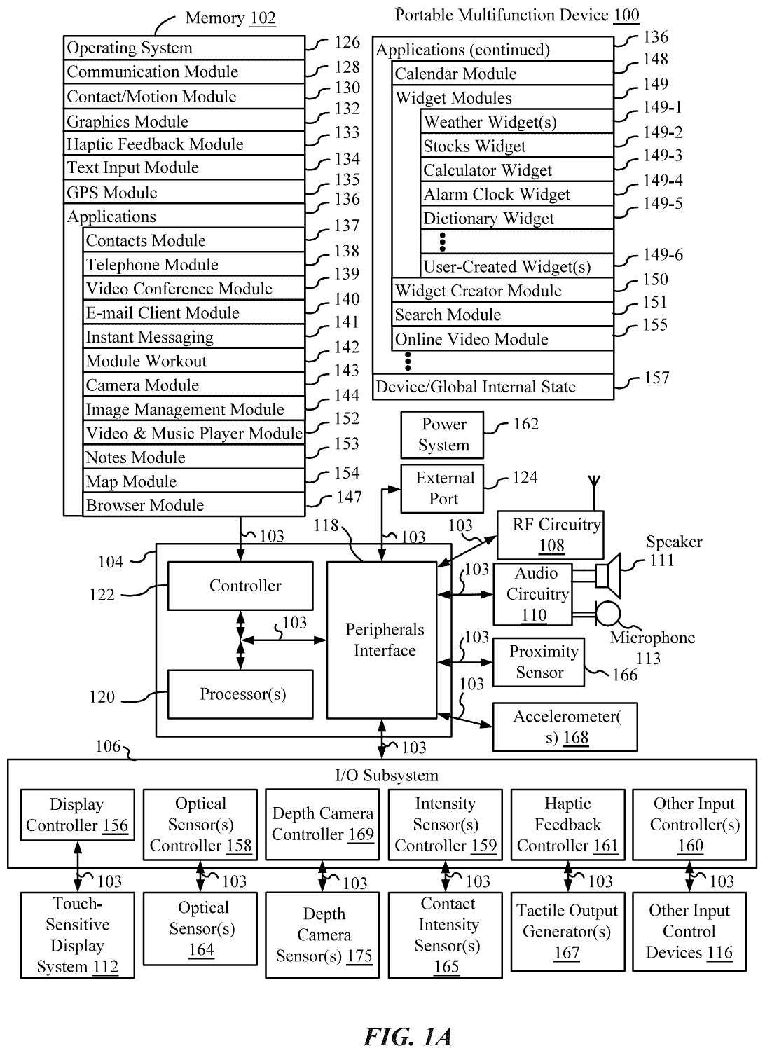

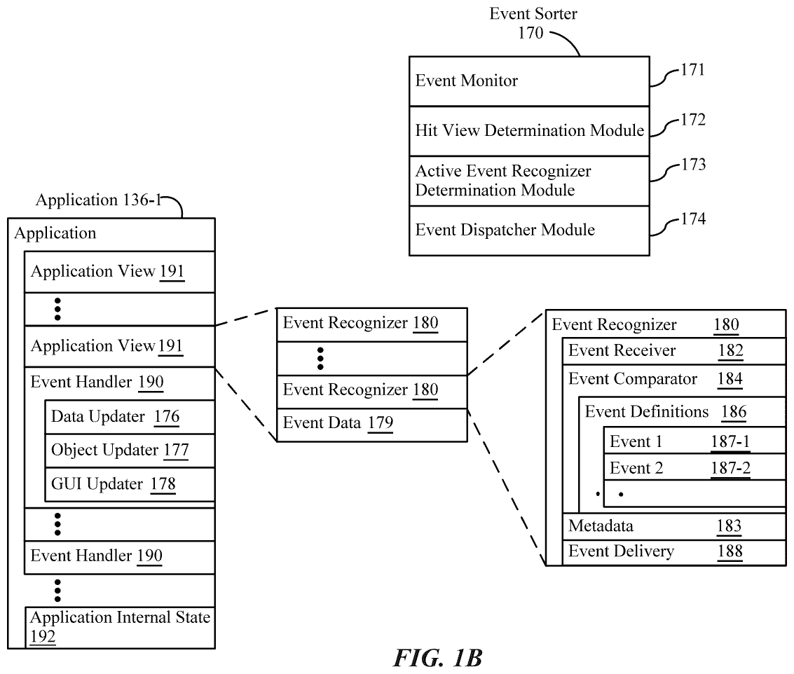

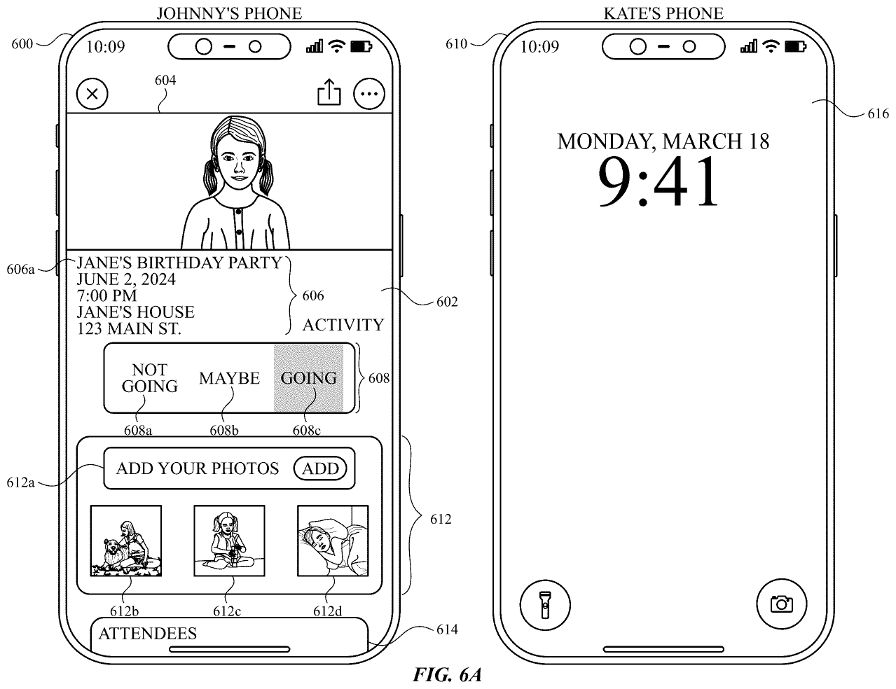

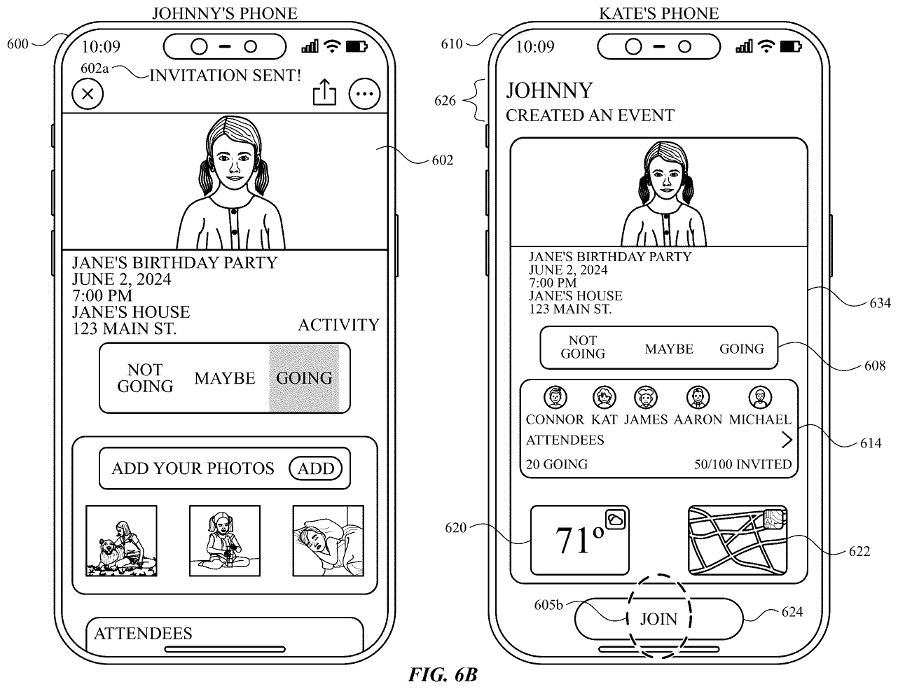

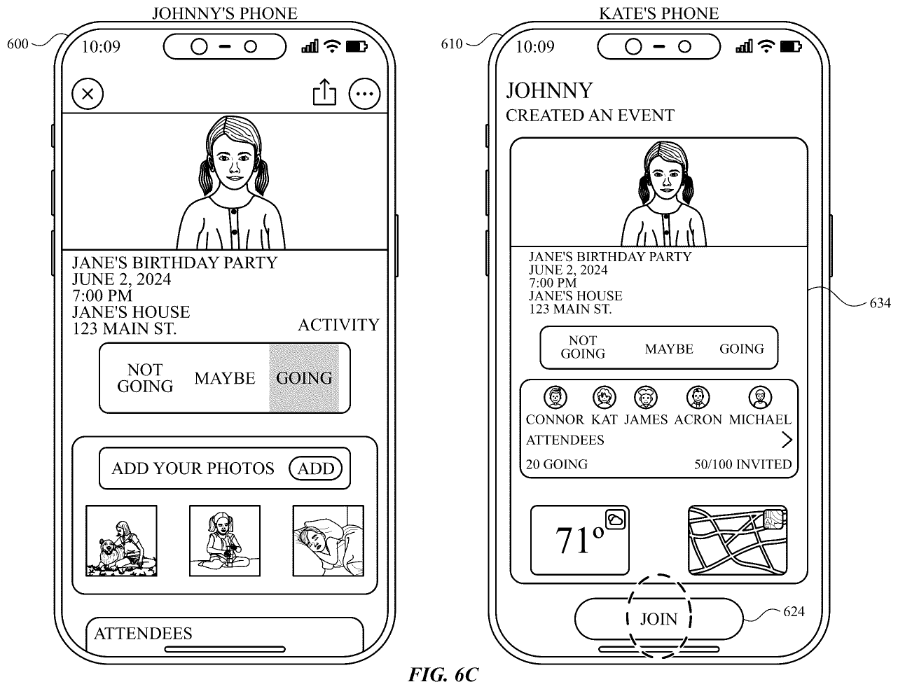

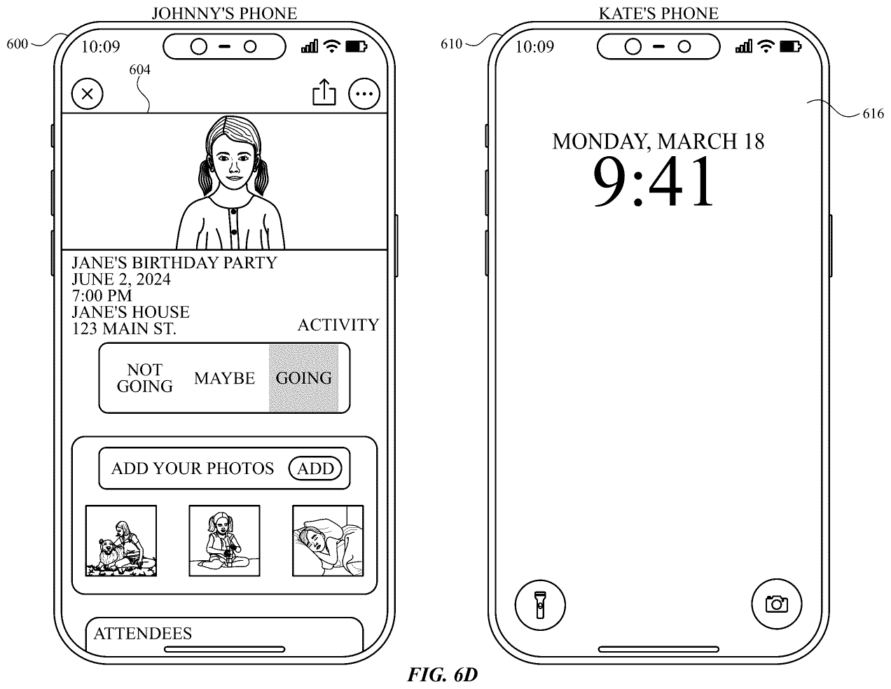

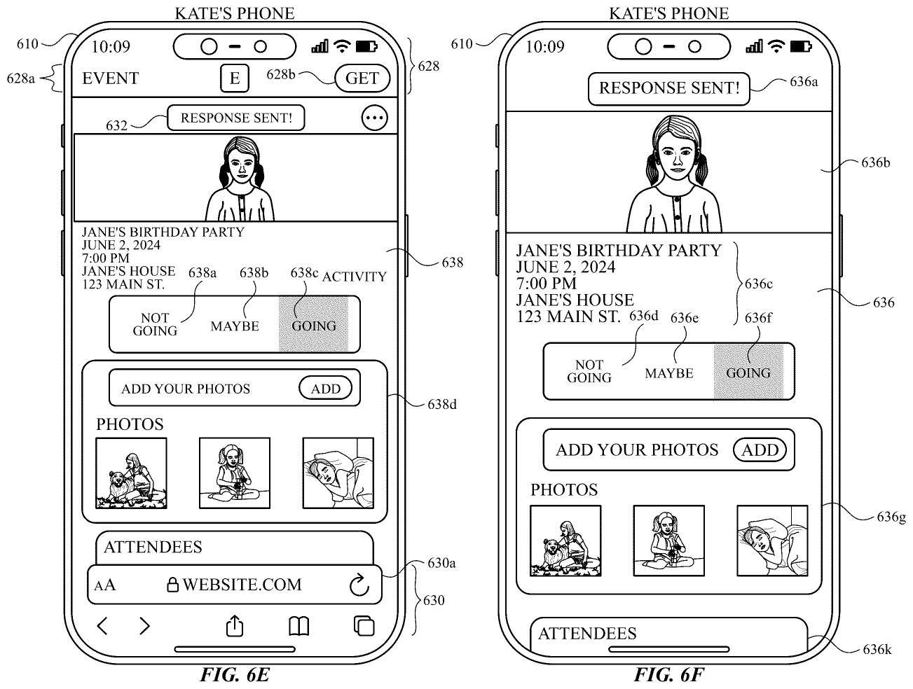

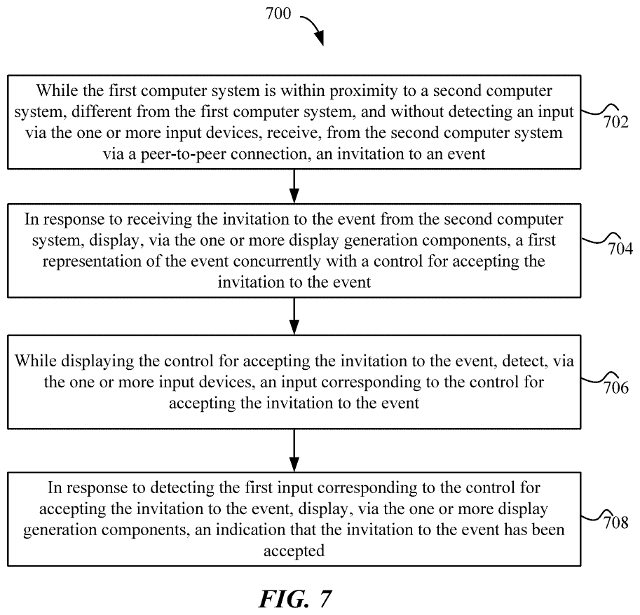

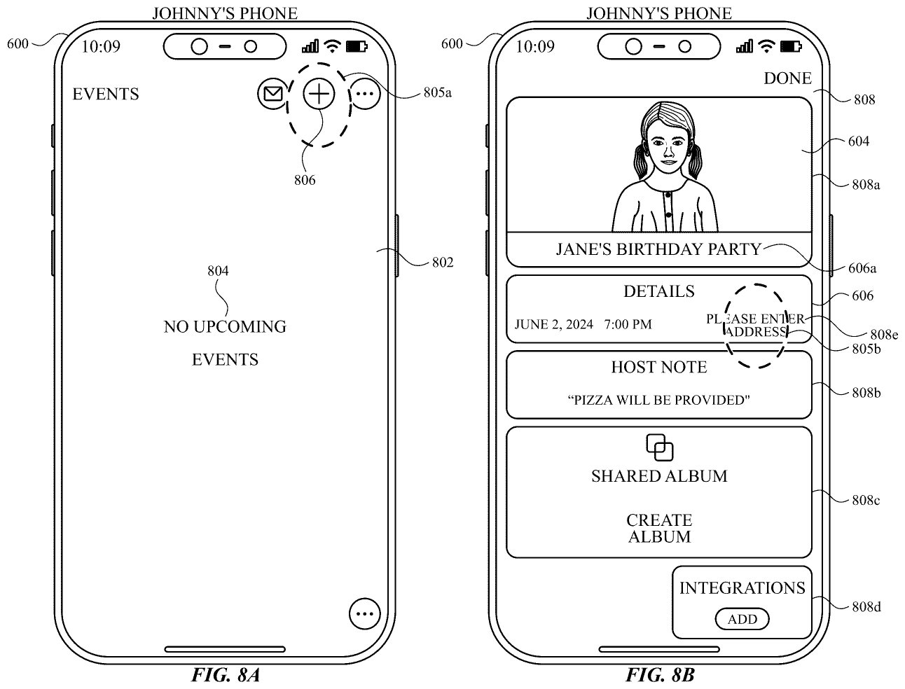

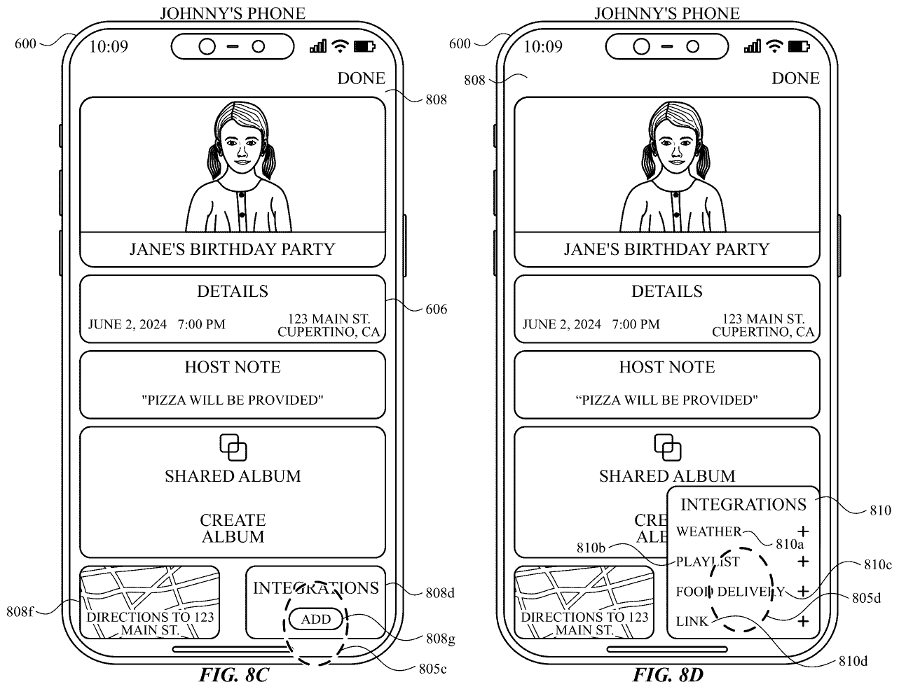

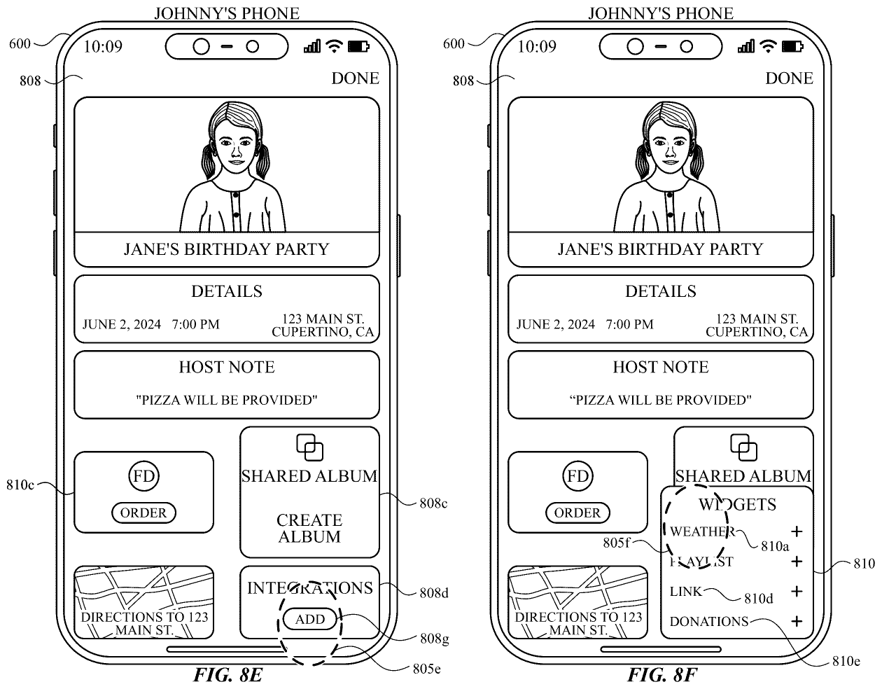

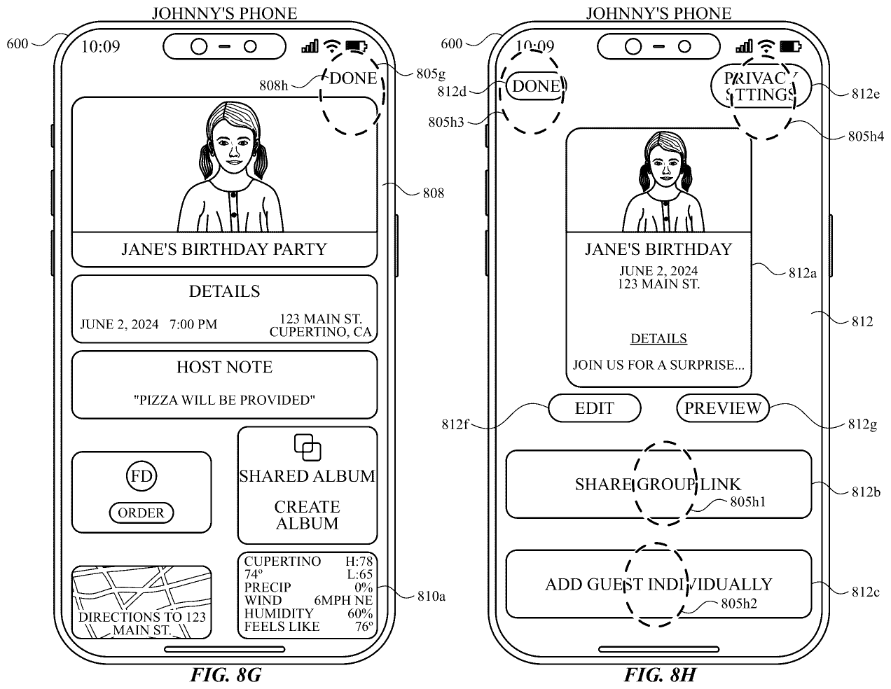

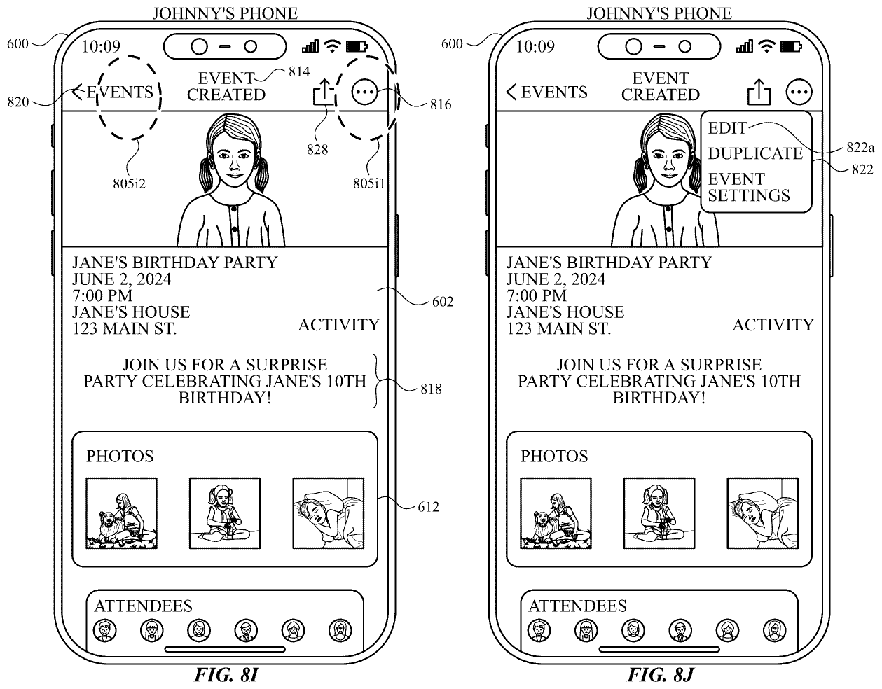

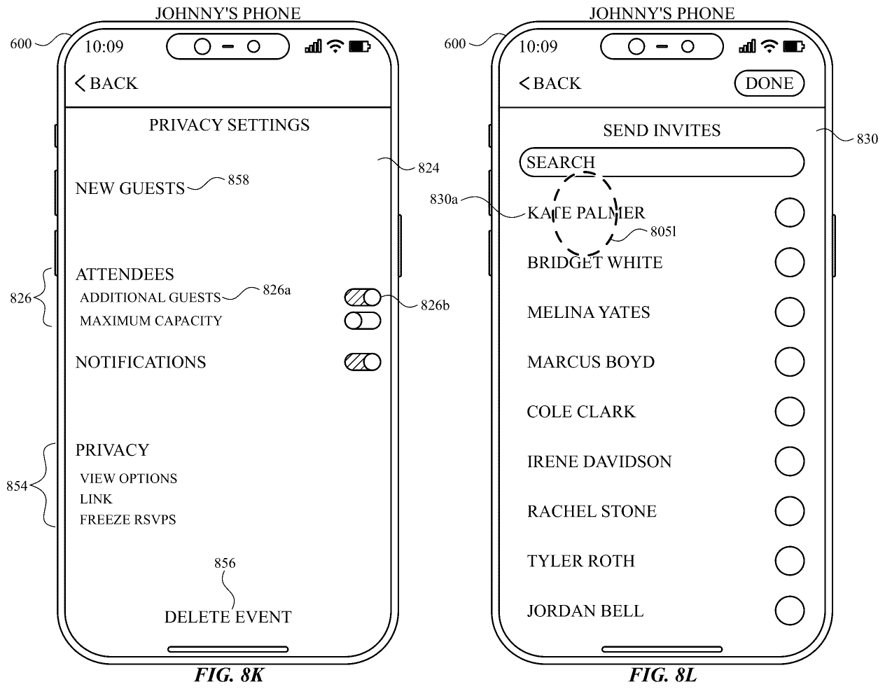

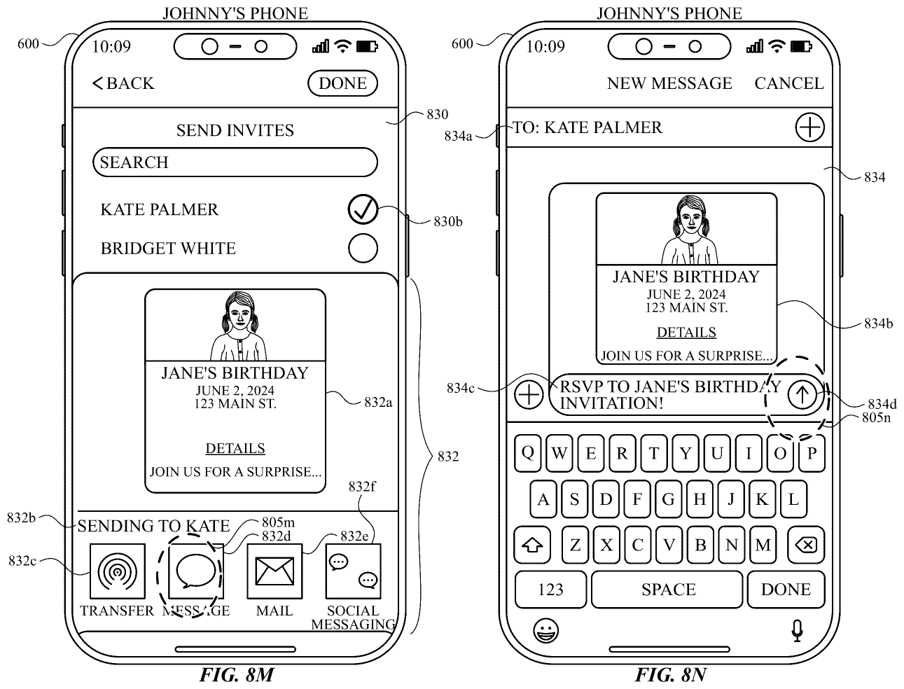

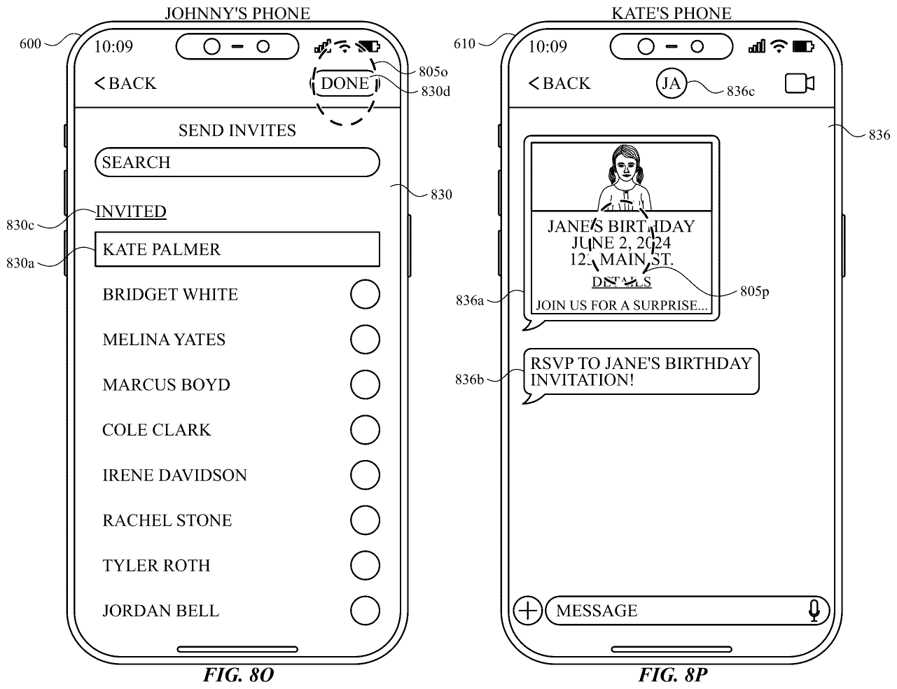

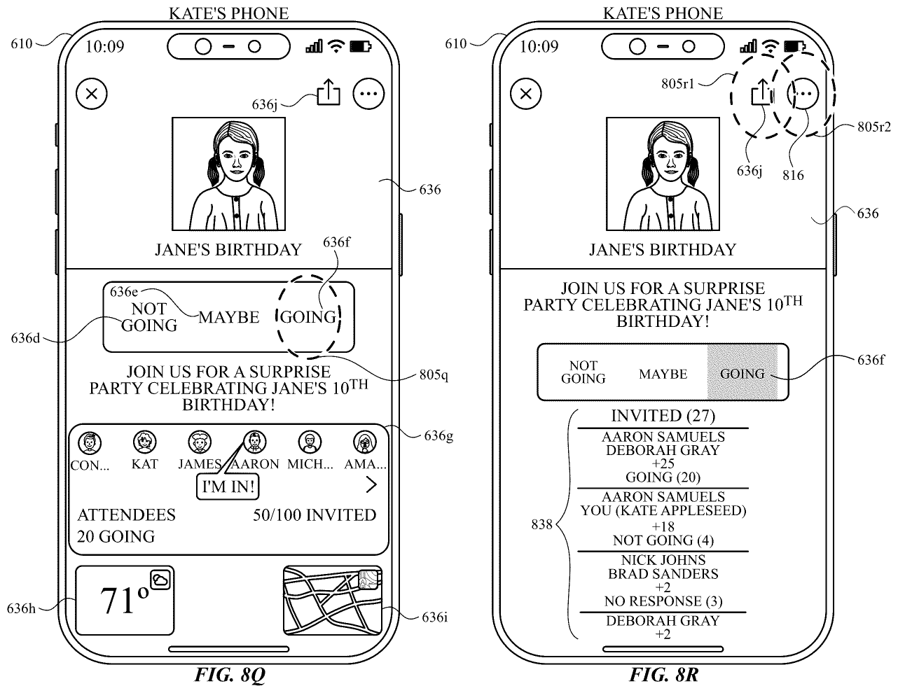

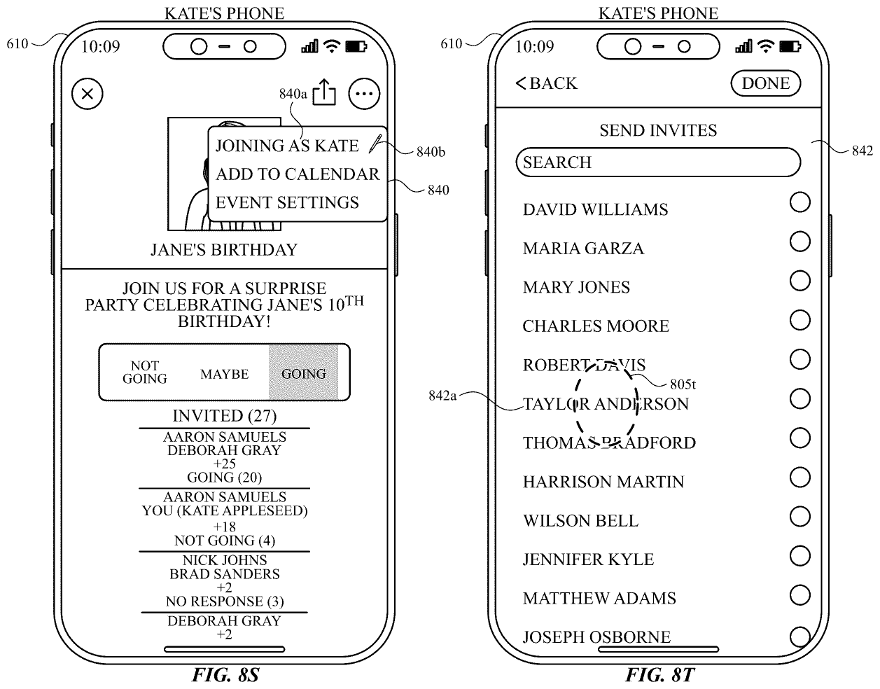

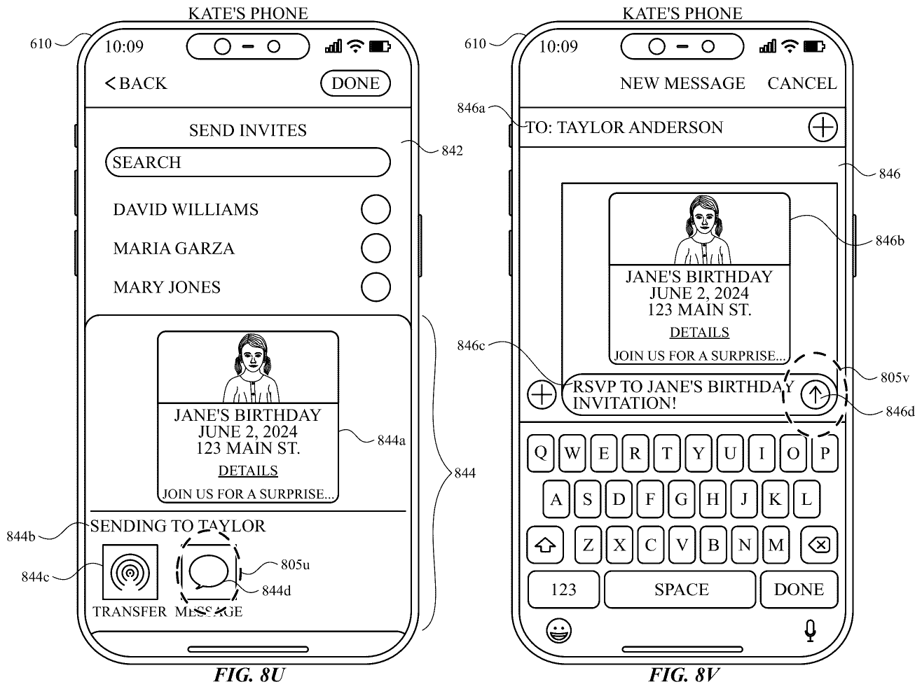

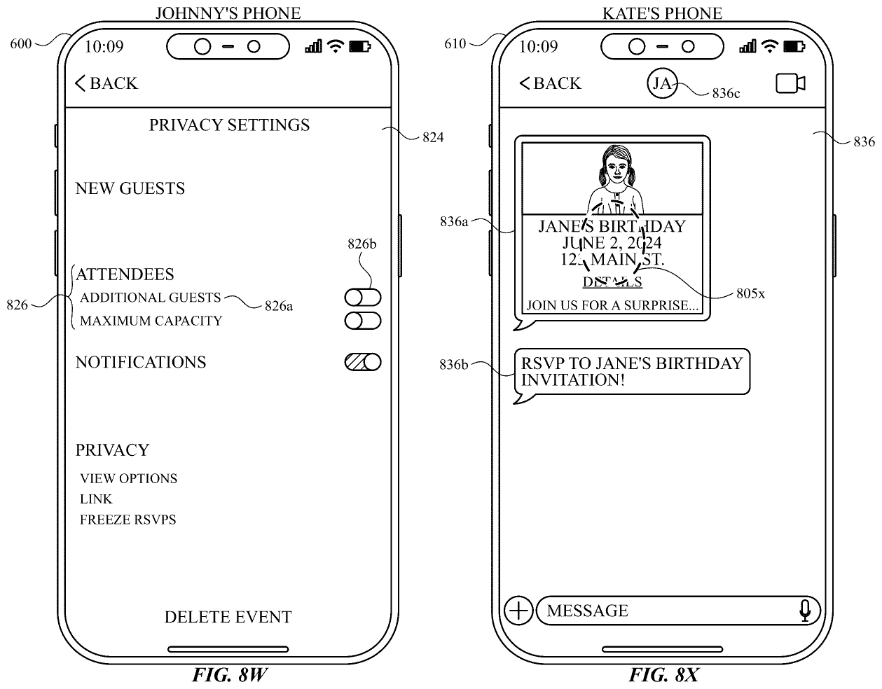

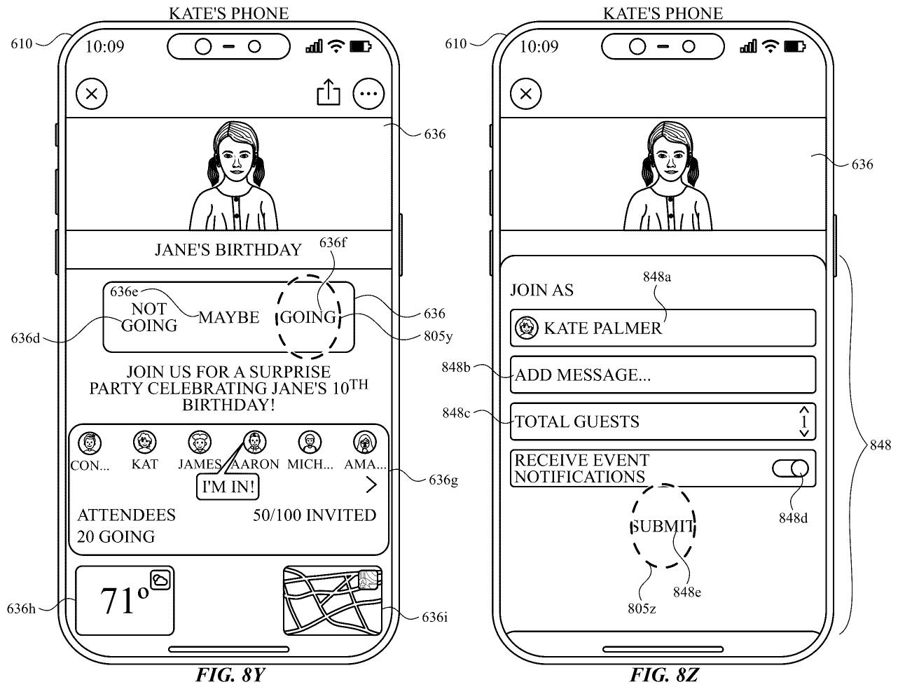

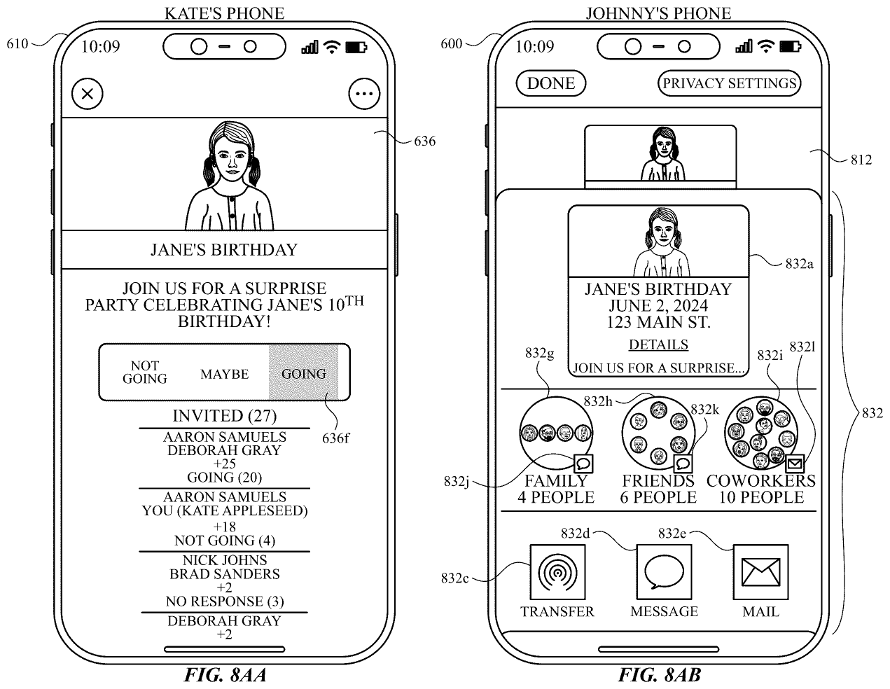

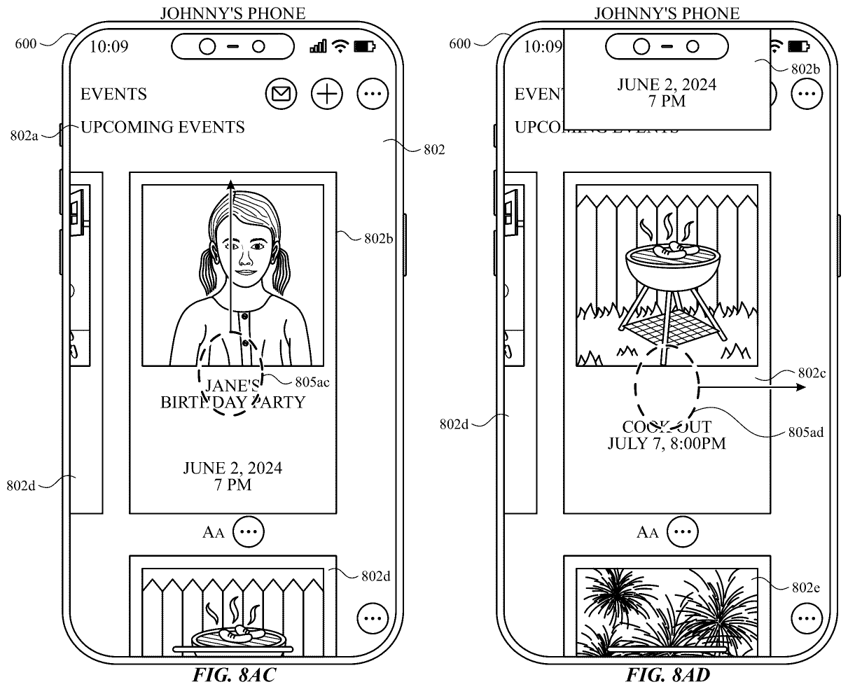

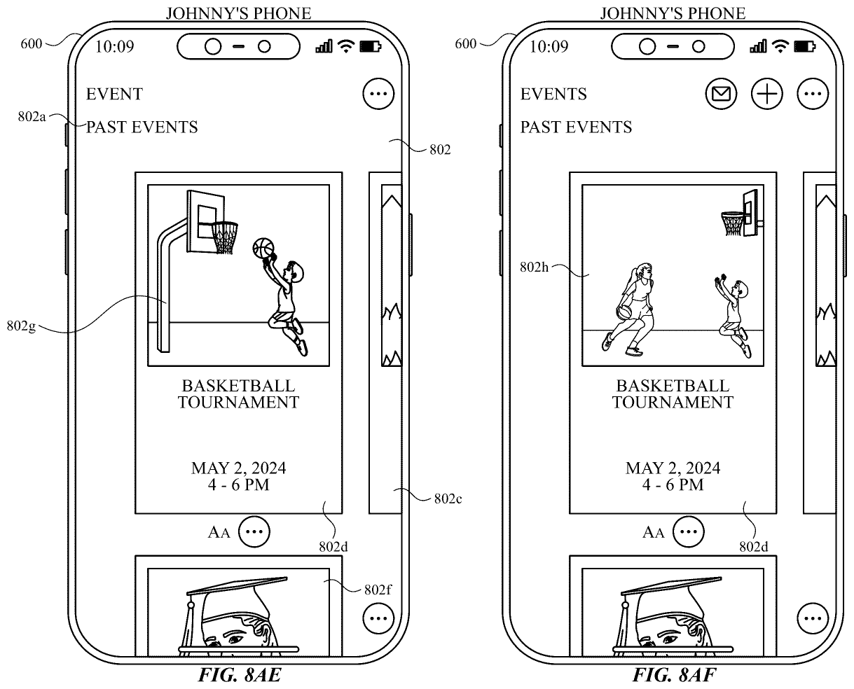

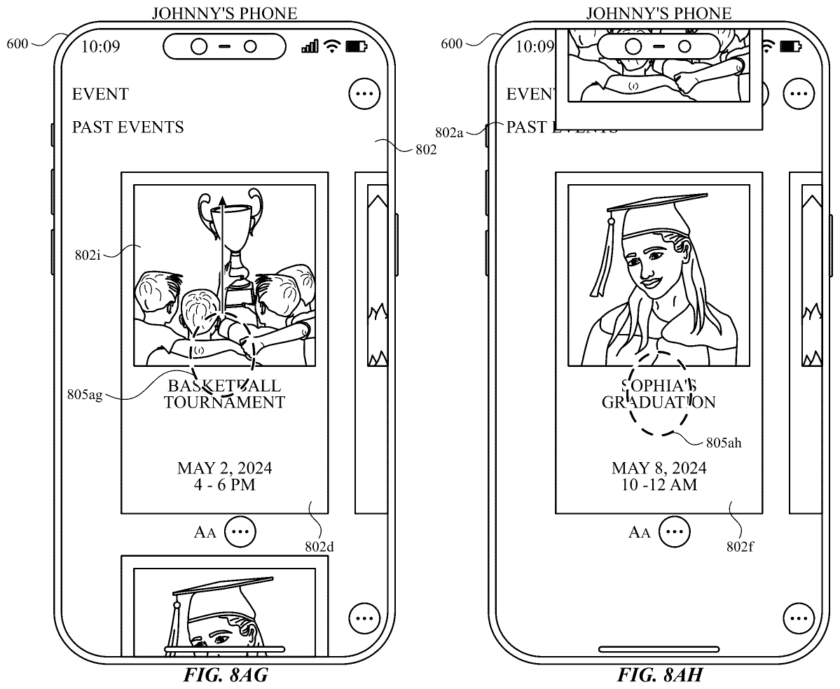

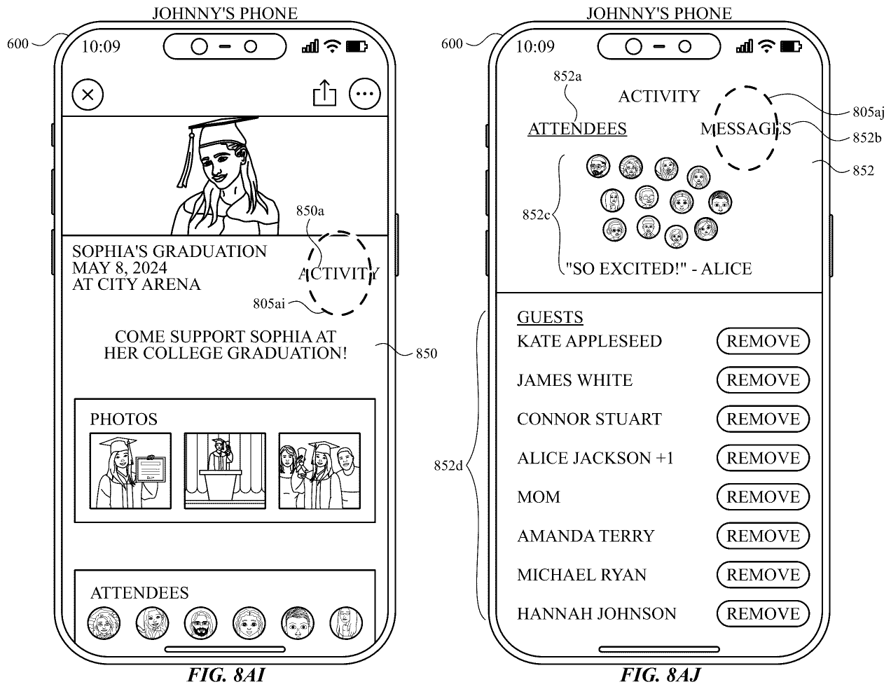

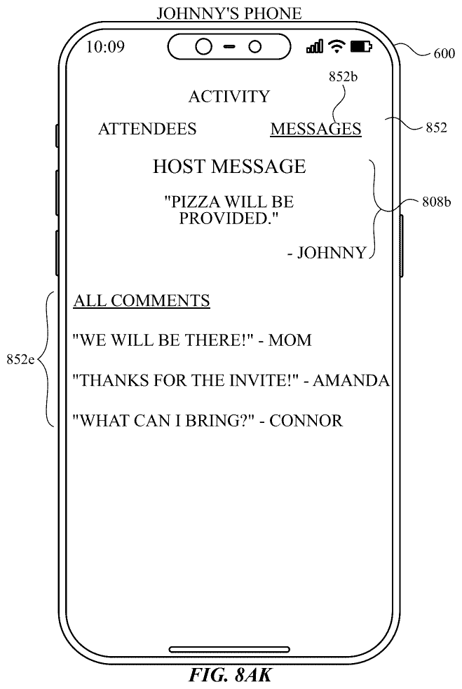

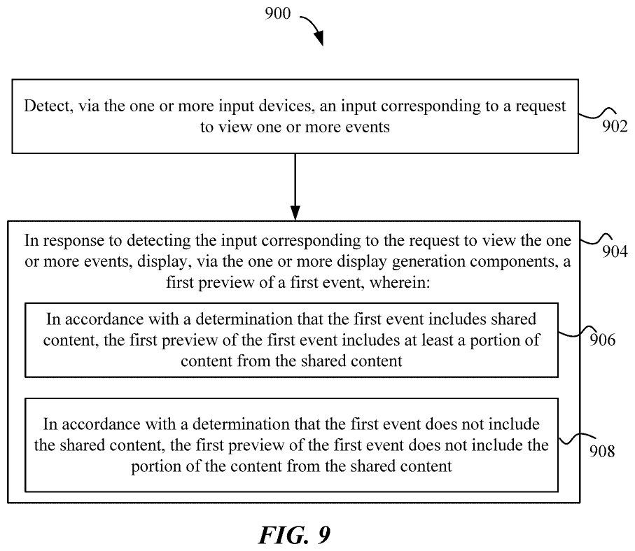

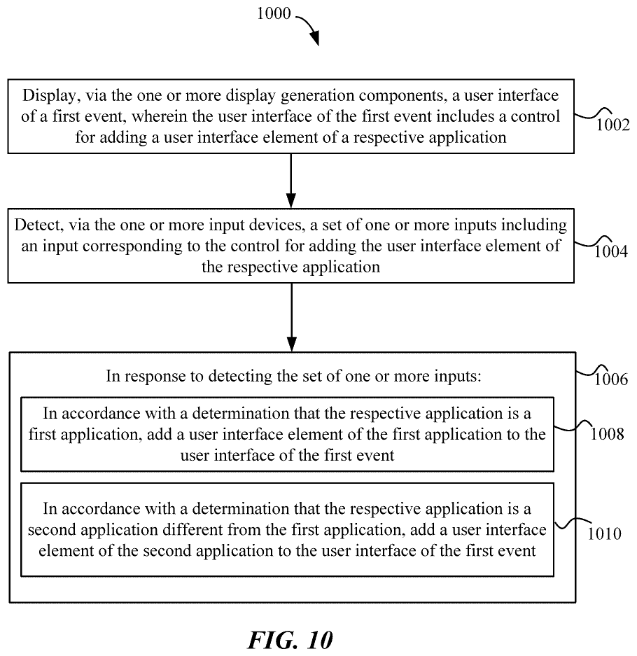

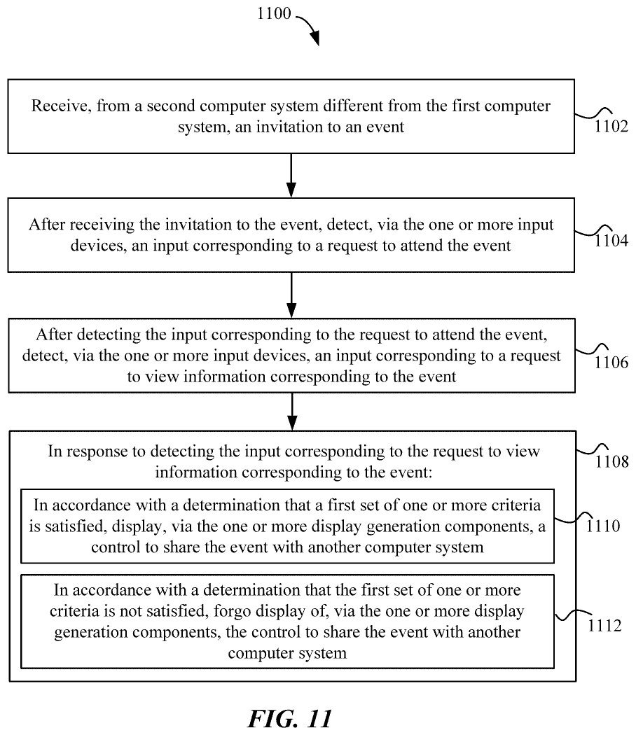

Below, FIGS. 1A-1B, 2, 3A-3G, 4A-4B, and 5A-5B provide a description of exemplary devices for performing the techniques for managing events. FIGS. 6A-6F illustrate exemplary user interfaces for sharing an event invitation in accordance with some embodiments. FIG. 7 is a flow diagram illustrating a process for receiving and responding to an event invitation in accordance with some embodiments. The user interfaces in FIGS. 6A-6F are used to illustrate the processes described below, including the processes in FIG. 7. FIGS. 8A-8AK illustrate exemplary user interfaces for interacting with an event invitation in accordance with some embodiments. FIG. 9 is a flow diagram illustrating a process for presenting events in accordance with some embodiments. The user interfaces in FIGS. 8A-8AK are used to illustrate the processes described below, including the processes in FIG. 9. FIG. 10 is a flow diagram illustrating a process for adding user interface elements to events in accordance with some embodiments. The user interfaces in FIGS. 8A-8AK are used to illustrate the processes described below, including the processes in FIG. 10. FIG. 11 is a flow diagram illustrating a process for sharing an event in accordance with some embodiments. The user interfaces in FIGS. 8A-8AK are used to illustrate the processes described below, including the processes in FIG. 11.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

In addition, in processes described herein where one or more steps are contingent upon one or more conditions having been met, it should be understood that the described processes can be repeated in multiple repetitions so that over the course of the repetitions all of the conditions upon which steps in the process are contingent have been met in different repetitions of the process. For example, if a process requires performing a first step if a condition is satisfied, and a second step if the condition is not satisfied, then a person of ordinary skill would appreciate that the claimed steps are repeated until the condition has been both satisfied and not satisfied, in no particular order. Thus, a process described with one or more steps that are contingent upon one or more conditions having been met could be rewritten as a process that is repeated until each of the conditions described in the process has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a process until all of the conditions upon which steps in the process are contingent have been met. A person having ordinary skill in the art would also understand that, similar to a process with contingent steps, a system or computer readable storage medium can repeat the steps of a process as many times as are needed to ensure that all of the contingent steps have been performed.

Although the following description uses terms “first,” “second,” etc. to describe various elements, these elements should not be limited by the terms. In some embodiments, these terms are used to distinguish one element from another. For example, a first touch could be termed a second touch, and, similarly, a second touch could be termed a first touch, without departing from the scope of the various described embodiments. In some embodiments, the first touch and the second touch are two separate references to the same touch. In some embodiments, the first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component (e.g., a display device such as a head-mounted display (HMD), a display, a projector, a touch-sensitive display, or other device component that presents visual content to a user, for example on or in the display generation component itself or produced from the display generation component and visible elsewhere). The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs (such as computer programs (e.g., including instructions)) and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

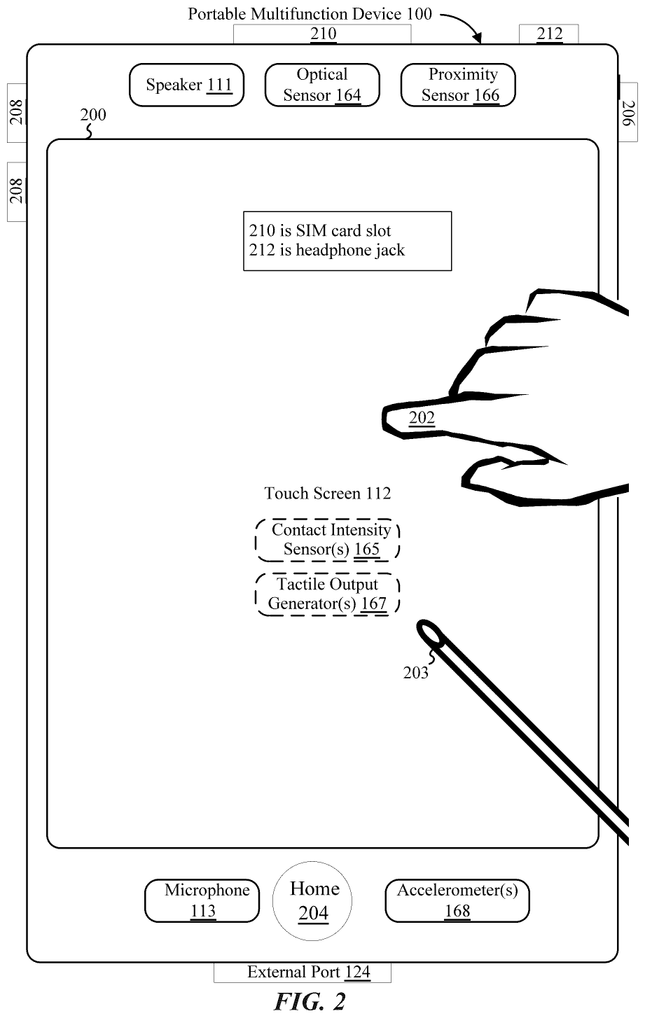

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both cars) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2). In some embodiments, the electronic device is a computer system that is in communication (e.g., via wireless communication, via wired communication) with one or more input devices. In some embodiments, the one or more input devices include a touch-sensitive surface (e.g., a trackpad, as part of a touch-sensitive display). In some embodiments, the one or more input devices include one or more camera sensors (e.g., one or more optical sensors 164 and/or one or more depth camera sensors 175), such as for tracking a user's gestures (e.g., hand gestures and/or air gestures) as input. In some embodiments, the one or more input devices are integrated with the computer system. In some embodiments, the one or more input devices are separate from the computer system. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more depth camera sensors 175. FIG. 1A shows a depth camera sensor coupled to depth camera controller 169 in I/O subsystem 106. Depth camera sensor 175 receives data from the environment to create a three dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100 so that the user's image with depth information is, optionally, obtained for video conferencing while the user views the other video conference participants on the touch screen display and to capture selfies with depth map data. In some embodiments, the depth camera sensor 175 is located on the back of device, or on the back and the front of the device 100. In some embodiments, the position of depth camera sensor 175 can be changed by the user (e.g., by rotating the lens and the sensor in the device housing) so that a depth camera sensor 175 is used along with the touch screen display for both video conferencing and still and/or video image acquisition.

In some embodiments, a depth map (e.g., depth map image) contains information (e.g., values) that relates to the distance of objects in a scene from a viewpoint (e.g., a camera, an optical sensor, a depth camera sensor). In one embodiment of a depth map, each depth pixel defines the position in the viewpoint's Z-axis where its corresponding two-dimensional pixel is located. In some embodiments, a depth map is composed of pixels wherein each pixel is defined by a value (e.g., 0-255). For example, the “0” value represents pixels that are located at the most distant place in a “three dimensional” scene and the “255” value represents pixels that are located closest to a viewpoint (e.g., a camera, an optical sensor, a depth camera sensor) in the “three dimensional” scene. In other embodiments, a depth map represents the distance between an object in a scene and the plane of the viewpoint. In some embodiments, the depth map includes information about the relative depth of various features of an object of interest in view of the depth camera (e.g., the relative depth of eyes, nose, mouth, ears of a user's face). In some embodiments, the depth map includes information that enables the device to determine contours of the object of interest in a z direction.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

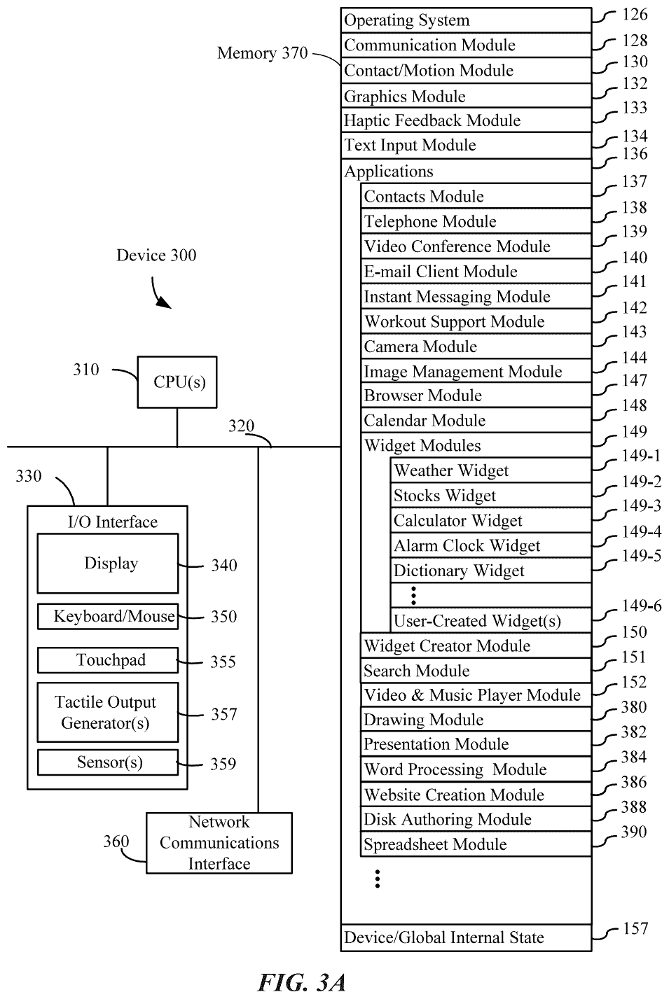

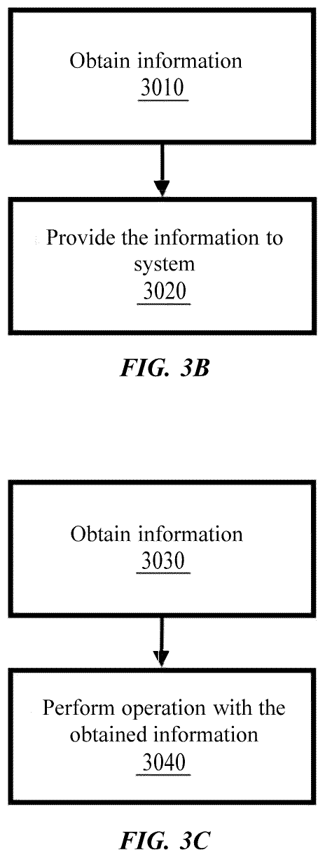

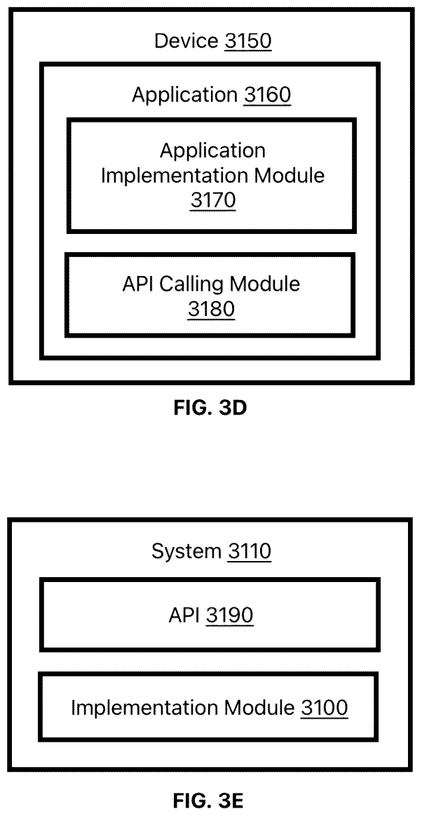

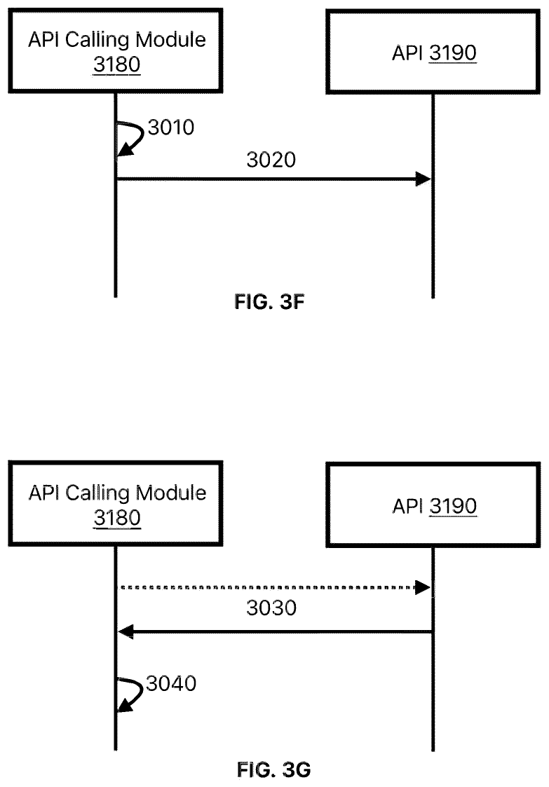

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3A) stores device/global internal state 157, as shown in FIGS. 1A and 3A. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, IOS, WINDOWS, or an embedded operating system such as Vx Works) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing; to camera 143 as picture/video metadata; and to applications that provide location-based services such as weather widgets, local yellow page widgets, and map/navigation widgets).

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the processes described in this application (e.g., the computer-implemented processes and other information processing processes described herein). These modules (e.g., sets of instructions) need not be implemented as separate software programs (such as computer programs (e.g., including instructions)), procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3A) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits processes and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (e.g., 187-1 and/or 187-2) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definitions 186 include a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3A is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3A is, optionally, stored in one or more of the previously mentioned memory devices. Each of the above-identified modules corresponds to a set of instructions for performing a function described above. The above-identified modules or computer programs (e.g., sets of instructions or including instructions) need not be implemented as separate software programs (such as computer programs (e.g., including instructions)), procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first party application). In some embodiments, application 3160 is an application that is provided to device 3150 via an operating system update file (e.g., a first party application or a second party application). In some embodiments, application 3160 is an application that is provided via an application store. In some embodiments, the application store can be an application store that is pre-installed on device 3150 at purchase (e.g., a first party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information, electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low-level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing a secure connection, such as with an accessory), a device detection API (e.g., for locating nearby devices, such as media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, implementation module 3100 is a system (e.g., operating system, and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, and/or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example when an input is detected, the direct sensor data is frequently processed into one or more input events that are provided (e.g., via an API) to a receiving software process that makes some determination based on the input events, and then information is sent (e.g., via an API) to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is a third-party application (e.g., an application that is provided by an application store, downloaded via a network, and/or read from a storage device). In some embodiments, the application controls the first computer system to perform processes 700, 900, 1000, and 1100 (FIGS. 7, 9, 10, and 11) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module 3180) to access and use one or more functions, methods, procedures, data structures, classes, and/or other services provided by an implementation module of the system process. The API can define one or more parameters that are passed between the different module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces that are, optionally, implemented on, for example, portable multifunction device 100.

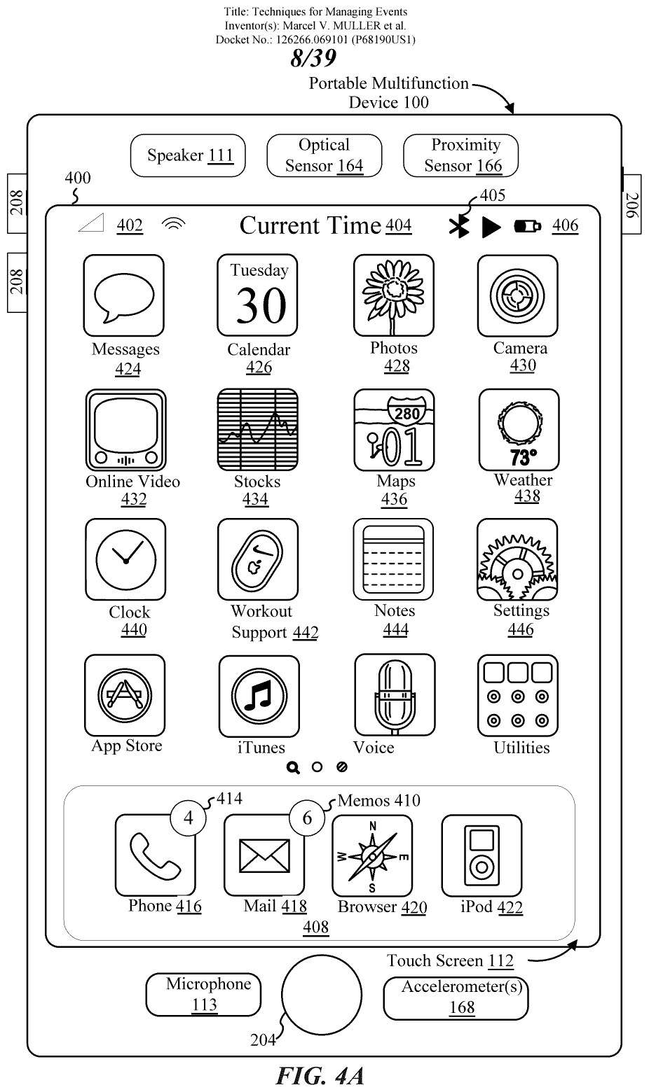

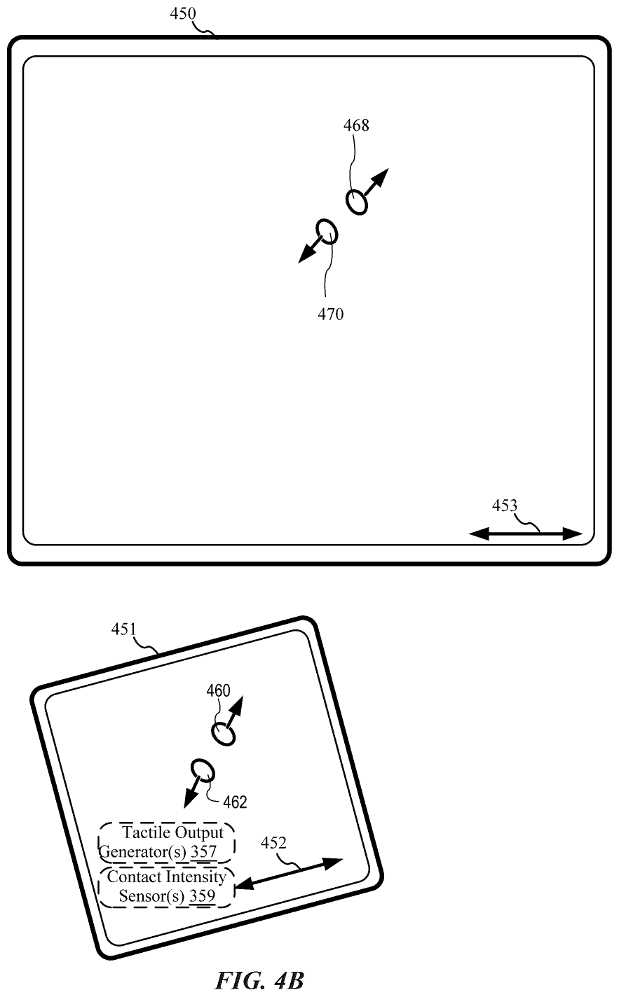

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3A) with a touch-sensitive surface 451 (e.g., a tablet or touchpad 355, FIG. 3A) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar processes are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

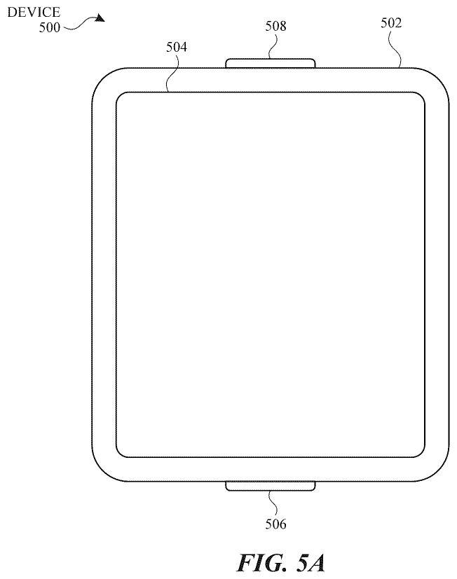

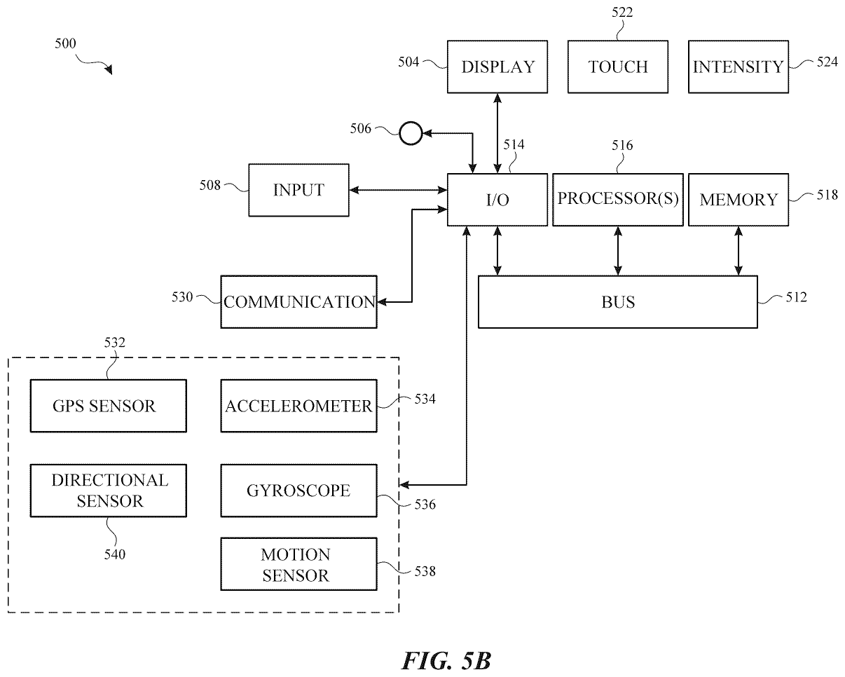

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3A-3G. Device 500 has bus 512 that operatively couples I/O section 514 with one or more computer processors 516 and memory 518. I/O section 514 can be connected to display 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage mediums, for storing computer-executable instructions, which, when executed by one or more computer processors 516, for example, can cause the computer processors to perform the techniques described below, including processes 700, 900, 1000, and 1100 (FIGS. 7, 9, 10, and 11). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B, but can include other or additional components in multiple configurations.

As used here, the term “affordance” refers to a user-interactive graphical user interface object that is, optionally, displayed on the display screen of devices 100, 300, and/or 500 (FIGS. 1A, 3A-3G, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

It should be recognized that an input detected via one or more input devices can include one or more inputs, such as a selection input, a non-selection input, a movement input, a non-movement input, an air gesture input (sometimes referred to as an air gesture as described above), a non-air gesture input, a gaze input, a non-gaze input, a verbal input, and/or a non-verbal input. In some embodiments, a selection input is an input that chooses and/or selects a subject (e.g., an element, a user interface element, a user interface object, a user interface, a person, a user, an animal, an electronic device, a computer system, and/or an object) from multiple subjects or a state from multiple states. In some embodiments, a selection input specifies a subject in which to perform an operation. Examples of a selection input include a tap input, a verbal input, an audible command, a gaze input, an air gesture input, a mouse click, a squeeze input of a portion of an electronic stylus, a blink of one or more eyes of a subject, depression of rotatable input mechanism, and/or a submission of a physical hardware element. In some embodiments, a non-selection input is an input that does not correspond to a user interface element being displayed. In some embodiments, a non-selection input does not specify a subject for which to perform an operation. Examples of a non-selection input include a verbal input, an audible request, an audible command, an audible statement, a movement input, a hold-and-drag input, a gaze input, an air gesture input, and/or a mouse movement. In some embodiments, a movement input is an input that starts at a first position and moves to a second position different from the first position. In such embodiments, the movement input can end at the second position or move back to the first position. Examples of a movement input include a swipe gesture input, a flick gesture input, movement of a subject, movement of a mouse, movement of an input on a touch-sensitive surface, an air gesture moving from one location to another, rotation of a physical input mechanism, and/or rotation of an electronic stylus. In some embodiments, a non-movement input is an input that does not start at a first position and move to a second position different from the first position before ending at the second position or moving back to the first position. Examples of a non-movement input include a verbal input, an audible request, an audible command, an audible statement, a tap input, a hold-and-drag input, a gaze input, an air gesture input, mouse movement, and/or a mouse click. Examples of an air gesture input include a hand gesture to pick up, a hand gesture to press, an air-tap gesture, an air-swipe gesture, an air pinch gesture, air de-pinch gesture, a tap-and-hold air gesture, a hand rotation, and/or a clench-and-hold air gesture. In some embodiments, multiple inputs are combined to represent a single input, such as an air gesture input combined with a selection input where the air gesture input or the gaze input identifies a target and the selection input determines when the target should be identified.

Attention is now directed towards embodiments of user interfaces (“UI”) and associated processes that are implemented on an electronic device, such as portable multifunction device 100, device 300, or device 500.

FIGS. 6A-6F illustrate exemplary user interfaces for sharing an event invitation in accordance with some embodiments. The user interfaces in these figures are used to illustrate the processes described below, including the processes in FIG. 7.

FIGS. 6A-6F illustrate a process for receiving an invitation to an event from another computer system in response to being in proximity to the other computer system. Stated differently, a computer system does not receive the invitation based on an input via an input component, such as a send button, but receives the invitation in response to being in proximity to the other computer system that is sending the invitation.

Starting at FIG. 6A, computer system 600 displays an invitation for an event titled “Jane's Birthday Party”. The owner of computer system 600, Johnny, is the host of the event. FIG. 6A illustrates Johnny's phone (e.g., computer system 600) on the left and Kate's phone (e.g., computer system 610) on the right. Computer system 610 belongs to Kate. In the example of FIGS. 6A-6F, computer system 600 is sending the invitation and computer system 610 is receiving the invitation. As illustrated in FIG. 6A, computer system 600 displays invitation user interface 602. Within invitation user interface 602, computer system 600 displays details 606, which include title, date, time, and location of the event. As indicated by title 606a within details 606, invitation user interface 602 is an invitation for Jane's Birthday Party. Invitation user interface 602 includes photo 604, which is a photo of Jane that Johnny uploaded to the event. Invitation user interface 602 also includes controls 608, which include RSVP options for the user of computer system 600. Specifically, controls 608 include not going control 608a, maybe control 608b, and going control 608c. In some embodiments, in response to detecting an input from a guest directed to not going control 608a, computer system 600 displays the guest's name in a “not going” list. Additionally, in response to detecting that a guest will not be attending the event, computer system 600 does not allow the guest access to one or more features of invitation user interface 602, such as photos control 612. In some embodiments, in response to detecting an input from a guest directed to maybe control 608b, computer system 600 displays the guest's name in a “maybe” list. Additionally, in response to detecting that a guest may or may not be attending the event, computer system 600 does not allow the guest access to one or more features of invitation user interface 602, such as photos control 612. As illustrated in FIG. 6A, computer system 600 displays going control 608c as shaded, which indicates that the user of computer system 600 is going to the party. Below controls 608, computer system 600 includes photos controls 612, which includes add photos control 612a, photo 612b, photo 612c, and photo 612d. It should be noted that computer system 600 displays photos control 612a because the user of computer system 600 is marked as “going” to the party and therefore has access to invitation user interface 602 and the controls within invitation user interface 602. At the bottom of invitation user interface 602, computer system 600 partially displays attendees tile 614, which will be discussed further below.

At FIG. 6A, computer system 610 (e.g., Kate's phone) is a different computer system than computer system 600 (e.g., Johnny's phone). As illustrated in FIG. 6A, computer system 610 displays lockscreen user interface 616, which indicates that computer system 610 is in a locked state. At FIG. 6A, computer system 600 and computer system 610 are within close proximity to one another. In some embodiments, close proximity refers to Johnny's phone and Kate's phone being very close, such as touching or near touching. For example, close proximity refers to Johnny's phone and Kate's phone touching or near touching. In some embodiments, close proximity refers to Johnny's phone and Kate's phone being within a certain distance from one another (e.g., within two inches). In some embodiments, close proximity refers to Johnny's phone and Kate's phone being in wireless communication with each other via a particular mechanism, such as NFC, Bluetooth, and/or a peer-to-peer network. For example, Johnny's phone might send data to Kate's phone via NFC when the devices are tapped together, or via Bluetooth when both devices are connected to the same network. In some embodiments, the phones might synchronize data when both are connected to the same Wi-Fi network, enabling seamless communication between the devices.

As illustrated in FIG. 6B, in response to being in close proximity to computer system 600, computer system 610 receives the invitation, as indicated by computer system 610 displaying preview user interface 634. It should be noted that Kate was not previously invited to Jane's Birthday Party and is receiving the invitation for the first time. In some embodiments, if Kate was previously invited to the event, she still receives the invitation if computer system 600 sends the invitation again. Preview user interface 634 includes similar elements of invitation user interface 602 as displayed by computer system 600 in FIG. 6A, including details 606 (e.g., title, date, time, and location of the event), controls 608, and attendees tile 614. Above invitation user interface 602, computer system 610 displays indicator 626, “Johnny created an event,” which indicates the name of the host (e.g., the name of the user of computer system 600). In some embodiments, as will be discussed below, computer system 610 receives the invitation from a guest of the event, in which case computer system 610 displays indicator 626 as the name of the guest that is sending the invitation (e.g., “Ana created an event”). Because Kate has not accepted or denied the invitation, computer system 610 does not display any of indicators 608a-c as selected. Within attendees tile 614 (e.g., as illustrated on computer system 600 in FIG. 6A), computer system 610 displays six guest profiles (e.g., name and photo representation) out of the 20 guests that are attending Jane's Birthday Party. At the bottom of preview user interface 634, computer system 610 displays weather integration 620 and map integration 622. Computer system 610 displays weather integration 620 to indicate the weather at the location and/or time of the event (e.g., 71°) and an icon of the weather application in the top right corner of integration 620. Computer system 610 displays map integration 622 to provide directions to the address of the event and an icon of the map application in the top right corner of integration 622. In some embodiments, in response to an input directed to integration 620 or integration 622, computer system 610 opens the respective application. For example, in response to detecting an input directed to integration 620, computer system 610 opens and displays a full-size weather application. In some embodiments, computer system 610 displays invitation user interface 602 overlaid onto lockscreen user interface 616 while computer system 610 is in a locked state.

The left side of FIG. 6B illustrates computer system 600 as illustrated in FIG. 6A. That is, computer system 600 displays the elements of invitation user interface 602 in FIG. 6B as in FIG. 6A even after sending the invitation. However, computer system 600 in FIG. 6B displays indicator 602a, “Invitation Sent,” which indicates that computer system 600 sent the invitation to computer system 610.

At FIG. 6B, computer system 600 and computer system 610 are still in close proximity to one another. FIG. 6B also illustrates join control 624 below preview user interface 634. At FIG. 6B, computer system 610 detects tap input 605b directed to join control 624.

FIG. 6C is an alternative to FIG. 6B. In this embodiment, after receiving the invitation, computer system 600 and computer system 610 are no longer in close proximity. Even though computer system 600 and computer system 610 are no longer in close proximity, computer system 610 maintains the display of preview user interface 634. Despite the lack of proximity, computer system 610 receives the invitation and Kate is able to perform an input directed to join control 624, as illustrated by computer system 610 displaying preview user interface 634 in FIG. 6C as in FIG. 6B.

FIG. 6D is an alternative to FIG. 6B. In this embodiment, in response to detecting that computer system 600 and computer system 610 are not in close proximity to one another, computer system 610 does not display preview user interface 632. Due to the lack of proximity, computer system 610 does not receive the invitation, as illustrated by computer system 610 displaying lockscreen user interface 616 and remaining in a locked state. Stated differently, because computer system 600 and computer system 610 are not within close proximity, computer system 610 does not receive the invitation and therefore does not change from its original state as illustrated in FIG. 6A. Further, computer system 610 cannot RSVP to the event as computer system 610 does not display the invitation while not in proximity to computer system 600.

FIGS. 6E and 6F do not illustrate computer system 600 as computer system 610 has already received the invitation and proximity to computer system 600 is no longer required in some embodiments. As illustrated in FIG. 6E, in response to detecting input 605b directed to join control 624 at FIG. 6B (e.g., alternatively to input 605c at FIG. 6C), computer system 610 displays invitation user interface 638 within a website user interface. That is, in response to accepting the invitation in FIG. 6B, computer system 610 displays invitation user interface 638 within a website view corresponding to the event. As illustrated in FIG. 6E, computer system 610 displays invitation user interface 638 within a website user interface, as indicated by indicators 628 and indicators 630. Indicators 628 indicate that computer system 610 does not have an application corresponding to the event installed (e.g., sometimes referred to as the Event application). Indicators 628 include representation 628a of the Event application (e.g., the application with which computer system 600 created the event and/or the invitation) and control 628b, with which the user of computer system 610 can download the Event application onto computer system 610. By including URL control 630a (e.g., website.com) and various other internet controls, indicators 630 indicate that computer system 610 is displaying invitation user interface 638 within a website user interface.

Also illustrated in FIG. 6E, in response to detecting input 605b at FIG. 6B, FIG. 6E illustrates indicator 632 (e.g., “Response sent!”) which indicates that computer system 610 sent a response to computer system 600 confirming that the Kate accepted the invitation and will be attending the party. Also illustrated in FIG. 6E, in response to detecting input 605b at FIG. 6B, FIG. 6E illustrates going control 638c as selected. In some embodiments, in response to detecting input 605b, computer system 610 displays invitation user interface 638 with no controls selected so that Kate can manually select one of controls 638a-c. In response to detecting that Kate accepted the invitation, computer system 610 displays and gives Kate access to photos controls 638d. Note that computer system 610 did not display photos controls 638d in preview interface 634 because Kate did not yet have access to the full functionalities (e.g., photos) of the event. In some embodiments, computer system 610 displays photos controls 638d within preview user interface 634.

FIG. 6F illustrates an alternative display to FIG. 6E. In some embodiments, in response to detecting input 605b at FIG. 6B, computer system 610 displays invitation user interface 636, as illustrated in FIG. 6E, in the Event application. That is, in FIG. 6F, in response to Kate accepting the invitation, computer system 610 displays invitation user interface 636 within the Event application when computer system 610 has the Event application downloaded. User interface 636 includes user interface elements as illustrated via computer system 600 in FIG. 6A, including photo 636b, details 636c, controls 636d-f, photos 636g, and attendees tile 636k.

FIG. 7 is a flow diagram illustrating a process (e.g., process 700) for receiving and responding to an event invitation in accordance with some embodiments. Some operations in process 700 are, optionally, combined, the orders of some operations are, optionally, changed, and some operations are, optionally, omitted.

As described below, process 700 provides an intuitive way for receiving and responding to an event invitation. Process 700 reduces the cognitive burden on a user, thereby creating a more efficient human-machine interface. For battery-operated computing devices, enabling a user to interact with such devices faster and more efficiently conserves power and increases the time between battery charges.

In some embodiments, process 700 is performed at a first computer system (e.g., 610) that is in communication (e.g., wired communication and/or wireless communication) with one or more input devices (e.g., a camera, a depth sensor, a microphone, a hardware input mechanism, a rotatable input mechanism, a heart monitor, a temperature sensor, and/or a touch-sensitive surface) and one or more display generation components (e.g., a display screen, a projector, and/or a touch-sensitive display). In some embodiments, the first computer system is a phone, a watch, a tablet, a fitness tracking device, a wearable device, an accessory, a speaker, a light, a head-mounted display (HMD), and/or a personal computing device.

While the first computer system is within proximity (e.g., of a first radio and/or component of the first computer system, such as a Near-Field Communication (NFC) component) (e.g., as described above with respect to FIGS. 6A-6B) to (and/or of) a second computer system (e.g., 600), different from the first computer system, and without detecting an input (e.g., a selection input and/or a non-selection input) via the one or more input devices (e.g., without detecting an input corresponding to a request to connect to and/or obtain content, information, and/or an invitation from the second computer system), the first computer system receives (702), from the second computer system via a peer-to-peer connection (e.g., near field communication (NFC), Bluetooth, Zigbee, Wi-Fi Direct, Z-wave, and/or Infrared (IR) connection), an invitation (e.g., as described above with respect to FIGS. 6A-6B) to an event (e.g., an invitation, a calendar invite, a calendar event, an event from an application, a gathering of one or more invited guests, a social function, and/or a period of one or more planned activities) (e.g., as described above with respect to FIGS. 6A-6B). In some embodiments, the second computer system is a phone, a watch, a tablet, a fitness tracking device, a wearable device, an accessory, a speaker, a light, a head-mounted display (HMD), and/or a personal computing device. In some embodiments, the second computer system is in communication with one or more input devices and/or one or more output devices, such as a camera, a speaker, a microphone, a sensor, and/or a display generation component. In some embodiments, the second computer system is the same type of computer system as the first computer system (e.g., both personal devices and/or user devices). In some embodiments, the second computer system is a different type of computer system than the first computer system (e.g., the second computer system is a personal device and the first computer system is a communal device). In some embodiments, a selection input includes a tap input, a verbal input, an audible command, a gaze input, an air gesture, a mouse click, and/or a submission of a user-interface element and/or a physical hardware element. In some embodiments, a non-selection input includes a verbal input, an audible request, an audible command, an audible statement, a swipe input, a hold-and-drag input, a gaze input, an air gesture, and/or a mouse movement. In some embodiments, the proximity corresponds to a distance configured to enable communication with the second computer system via a set of one or more input devices (e.g., an ultra-wideband sensor, a NFC sensor, a Bluetooth radio, and/or a Wi-Fi radio). In some embodiments, the event is from an application of the second computer system. In some embodiments, the event is an event that is ongoing (e.g., current) and/or an event that is upcoming (e.g., future). In some embodiments, the invitation to the event is received while the one or more display generation components is in an off and/or standby state. In some embodiments, the invitation to the event is received while displaying, via the one or more display generation components, a lock screen. In some embodiments, the invitation to the event is received while the first computer system is in a locked state.

In response to receiving the invitation to the event from the second computer system (and/or while the first computer system is within proximity to the second computer system without detecting an input via the one or more input devices), the first computer system displays (704), via the one or more display generation components, a first representation (e.g., a preview of and/or a portion of content corresponding to) (e.g., 634) of the event concurrently with a control (e.g., an affordance, a button, and/or an add user interface element) (e.g., 624) for accepting the invitation to the event. In some embodiments, the first representation includes text, images, and/or videos. In some embodiments, the first representation of the event is displayed in a notification on top of another user interface separate and/or distinct from the notification.

While displaying the control for accepting the invitation to the event (and/or while displaying the first representation of the event), the first computer system detects (706), via the one or more input devices, an input (e.g., a selection input and/or a non-selection input) (e.g., 605b) corresponding to the control for accepting the invitation to the event. In some embodiments, the input corresponding to the control for accepting the invitation to the event is detected while the first computer system is within proximity to the second computer system. In some embodiments, the input corresponding to the control for accepting the invitation to the event is detected while the first computer system is not within proximity to the second computer system. In some embodiments, the input corresponding to the control for accepting the invitation to the event includes a tap input on the control for accepting the invitation to the event. In some embodiments, the input corresponding to the control for accepting the invitation to the event includes an audible command to accept the invitation to the event (e.g., “I am going”).

In response to detecting the first input corresponding to the control for accepting the invitation to the event, the first computer system displays (708), via the one or more display generation components, an indication (e.g., a text, a graphical image, a symbol, and/or an animation) (e.g., 632, 636, 636a, 636f, 638, and/or 638c) that the invitation to the event has been accepted. In some embodiments, the indication that the invitation to the event has been accepted includes a representation a user is going to the event (e.g., a checkmark, displaying the word “going,” and/or emphasizing the attendance of the user to the event). Displaying a representation of an event concurrently with a control for accepting the event in response to receiving an invitation for the event via a peer-to-peer connection allows the first computer system to provide a feature for quickly sharing and/or accepting invitations to events using a peer-to-peer connection, thereby reducing the number of inputs needed to perform an operation, providing improved visual feedback to the user, and/or providing improved visual feedback to the user.

In some embodiments, in response to detecting the first input corresponding to the control for accepting the invitation to the event, the first computer system displays, via the one or more display generation components (e.g., concurrently with the indication that the invitation to the event has been accepted), an indication (e.g., a text, a graphical image, a symbol, and/or an animation) (e.g., 632 and/or 636a) corresponding to sending (e.g., to the second computer system or another computer system (e.g., a server and/or a device) different from the second computer system) a response (e.g., an indication that the invitation has been accepted) to the invitation. In some embodiments, the indication includes a representation that the response is being sent and/or has been sent. In some embodiments, the computer system ceases display of the indication corresponding to sending the response to the invitation in response to detecting that the response has been sent. Displaying an indication corresponding to sending a response to an invitation allows the first computer system to indicate what operation the first computer system is performing and/or has performed, thereby performing an operation when a set of conditions has been met without requiring further user input and/or providing improved visual feedback to the user.

In some embodiments, the indication that the invitation to the event has been accepted includes an indication (e.g., 636f and/or 638c) that a user is attending (and/or going to) the event. In some embodiments, the indication that the user is attending the event includes an identification of the user (e.g., as provided to one or more other users attending the event). Displaying an indication that a user is attending the event in response to accepting an invitation to the event allows the first computer system to indicate to a user how others will see the user with respect to the event, thereby performing an operation when a set of conditions has been met without requiring further user input and/or providing improved visual feedback to the user.

In some embodiments, in response to detecting the first input corresponding to the control for accepting the invitation to the event, the first computer system displays, via the one or more display generation components, a second representation (e.g., a preview of and/or a portion of content corresponding to) (e.g., 636 and/or 638) of the event different from the first representation of the event. In some embodiments, in response to detecting the first input corresponding to the control for accepting the invitation to the event, the first computer system ceases display of, via the one or more display generation components, the first representation (e.g., 634) of the event (e.g., before displaying or concurrently with display of the second representation). Displaying a different representation of an event after accepting an invitation to the event allows the first computer system to provide different and/or more information after accepting the invitation to the event, thereby performing an operation when a set of conditions has been met without requiring further user input and/or providing improved visual feedback to the user.

In some embodiments, the first representation (e.g., 634) of the event consists of a first amount of detail (e.g., information, features, media, controls, and/or user interface elements) corresponding to the event. In some embodiments, the second representation (e.g., 636) of the event consists of a second amount of detail (e.g., information, features, media, controls, and/or user interface elements), different from (more or less than) the first amount of detail, corresponding to the event. Including different amounts of detail before and after accepting an invitation to an event allows detail to be tailored to a stage of accepting the invitation to the event and/or increase an amount of detail provided about the event after accepting the invitation to the event, thereby reducing the number of inputs needed to perform an operation, performing an operation when a set of conditions has been met without requiring further user input, and/or providing improved visual feedback to the user.

In some embodiments, the second representation of the event includes (and/or is) a widget (e.g., managed by a system process other than an application corresponding to the event) (e.g., 636). A representation of an event being a widget allows the first computer system to dynamically show and/or allow interaction with content corresponding to the event, thereby performing an operation when a set of conditions has been met without requiring further user input and/or providing improved visual feedback to the user.

In some embodiments, the second representation of the event includes a list (e.g., 636k) of one or more attendees for the event (e.g., a list of one or more users that have responded (e.g., accepted and/or declined) to an invitation to the event). In some embodiments, the list of one or more attendees includes individual indications of a number of attendees up to a predefined number of attendees. In some embodiments, an individual indication of an attendee includes a name of the attendee and/or a graphical representation of the attendee. In some embodiments, the list of one or more attendees includes an identification of a number of attendees for the event. A representation of an event including a list of one or more attendees for the event allows (1) the first computer system to reflect a current state of the event and/or (2) a user of first the computer system to identify how others have responded to invitations to the event, thereby reducing the number of inputs needed to perform an operation, performing an operation when a set of conditions has been met without requiring further user input, and/or providing improved visual feedback to the user.

In some embodiments, the second representation of the event includes a control (e.g., 636d and/or 636a) for indicating that a user (e.g., of the computer system) will not be attending the event (e.g., for declining the invitation to the event after accepting the invitation to the event). In some embodiments, while displaying the second representation of the event, the computer system detects an input (e.g., a selection input and/or a non-selection input) corresponding to the control for indicating that the user will not be attending the event. In some embodiments, in response to detecting the input corresponding to the control for indicating that the user will not be attending the event, the computer system displays, via the one or more display generation components, a third representation (e.g., a preview of and/or a portion of content corresponding to) of the event different from the second representation of the event (and/or the first representation of the event). In some embodiments, the third representation of the event is the first representation of the event. In some embodiments, in response to detecting the input corresponding to the control for indicating that the user will not be attending the event, the computer system displays, via the one or more display generation components, an indication (e.g., a text, a graphical image, a symbol, and/or an animation) that the invitation to the event has been declined. A representation of an event including a control for indicating that a user will not be attending the event allows the first computer system to modify a previous decision to accept an invitation to the event while displaying information corresponding to the event, thereby reducing the number of inputs needed to perform an operation, performing an operation when a set of conditions has been met without requiring further user input, and/or providing improved visual feedback to the user.

In some embodiments, the first representation (e.g., 634) of the event includes a first set of information (e.g., a title, a date, a location, a map, a list of one or more songs, and/or a list of one or more images) in a first order. In some embodiments, the second representation (e.g., 636 and/or 638) of the event includes the first set of information in a second order different from the first order. In some embodiments, the first representation of the event includes a second set of information (e.g., a location, a map, a list of one or more songs, and/or a list of one or more images). In some embodiments, the second representation of the event does not include the second set of information. In some embodiments, the second representation of the event includes a third set of information (e.g., a location, a map, a list of one or more songs, and/or a list of one or more images). In some embodiments, the first representation of the event does not include the third set of information. A representation of an event including information in a different order before and after accepting an invitation to the event allows the first computer system to order information relative to a state of accepting the invitation and/or ensure that certain information is in a more prominent position at different points in accepting the invitation, thereby performing an operation when a set of conditions has been met without requiring further user input and/or providing improved visual feedback to the user.

In some embodiments, the first representation (e.g., 634) is displayed within a user interface (e.g., a lockscreen, a home screen, a capture user interface, a media user interface, and/or a browser user interface) of a first process (and/or a first application). In some embodiments, the second representation (e.g., 636 and/or 638) is displayed in a user interface of a second process (and/or a second application different from the first application) (e.g., and not of the first process and/or the first application) different from the first process. In some embodiments, the first process is a system process and/or application. In some embodiments, the second process is a user process and/or application. In some embodiments, the first process is part of an operating system of the computer system. In some embodiments, the second process is not part of an operating system of the computer system. In some embodiments, the second process corresponds to an event application. In some embodiments, the first process does not correspond to an event application. In some embodiments, the first process corresponds to a process for communicating with other devices within proximity. In some embodiments, the second process is an event application and/or a calendar application. Displaying different representations of an event in user interfaces of different processes allows the first computer system to use different processes before and after an invitation to the event is accepted such that applications specific to the event are only used after accepting the invitation, thereby performing an operation when a set of conditions has been met without requiring further user input and/or providing improved visual feedback to the user.

In some embodiments, while displaying the first representation (e.g., 634) of the event concurrently with the control for accepting the invitation to the event, the first computer system detects that the first computer system is no longer within proximity (e.g., of a first radio and/or component of the first computer system, such as a Near-Field Communication (NFC) component) to (and/or of) the second computer system (and/or without detecting an input (e.g., a selection input and/or a non-selection input) via the one or more input devices, such as without detecting an input corresponding to a response to the invitation). In some embodiments, in response to detecting that the first computer system is no longer within proximity to the second computer system, the first computer system ceases display of, via the one or more display generation components, the first representation of the event and the control for accepting the invitation to the event. In some embodiments, in response to detecting that the first computer system is no longer within proximity to the second computer system, the first computer system maintains display of the first representation of the event or the control for accepting the invitation to the event. In some embodiments, in response to detecting that the first computer system is no longer within proximity to the second computer system, the first computer system displays, via the one or more display generation components, a user interface of an application that corresponds to the event. Ceasing display of a representation of an event and a control for accepting an invitation to the event in response to detecting that a computer system is no longer within proximity of a computer system sending the invitation allows such invitations to be temporary and only visible while within proximity, thereby reducing the number of inputs needed to perform an operation, performing an operation when a set of conditions has been met without requiring further user input, and/or providing improved visual feedback to the user.

In some embodiments, while displaying the first representation (e.g., 634) of the event concurrently with the control for accepting the invitation to the event, the first computer system maintains display of the first representation of the event and the control for accepting the invitation to the event while the first computer system is no longer within proximity (e.g., of a first radio and/or component of the first computer system, such as a Near-Field Communication (NFC) component) to (and/or of) the second computer system (e.g., before detecting an input corresponding to the control for accepting the invitation to the event). Maintaining display of a representation of an event and a control for accepting an invitation to the event while a computer system is no longer within proximity of a computer system sending the invitation allows a quick technique for inviting others to events without requiring such computer systems to be maintained within proximity, thereby performing an operation when a set of conditions has been met without requiring further user input and/or providing improved feedback to the user.

In some embodiments, the input (e.g., 605b) corresponding to the control for accepting the invitation to the event is detected (1) while the first computer system is within proximity (e.g., of a first radio and/or component of the first computer system, such as a Near-Field Communication (NFC) component) to (and/or of) the second computer system or (2) while the first computer system is not within proximity (e.g., of a first radio and/or component of the first computer system, such as a Near-Field Communication (NFC) component) to (and/or of) the second computer system. While a computer system is within proximity of another computer system, detecting an input corresponding to a control for accepting an invitation to an event that was received while within proximity of the other computer system allows the first computer system to provide a temporary experience for joining events while in proximity with another computer system, thereby performing an operation when a set of conditions has been met without requiring further user input and/or providing improved feedback to the user. While a computer system is not within proximity of another computer system, detecting an input corresponding to a control for accepting an invitation to an event that was received while within proximity of the other computer system allows the first computer system to continue to allow interactions with events received while within proximity to the other computer system, thereby performing an operation when a set of conditions has been met without requiring further user input and/or providing improved feedback to the user.

In some embodiments, before the first computer system is within proximity to the second computer system, the first computer system displays, via the one or more display generation components, a first user interface of an application (e.g., an event application, such as a calendar or third party application), wherein the first user interface of the application is continued to be displayed while receiving the invitation to the event, and wherein the first representation (e.g., 634) of the event and the control for accepting the invitation to the event are displayed within a second user interface (e.g., the first user interface or another user interface different from the first user interface) of the application. In some embodiments, a lockscreen or other user interface of an operating system of the first computer system is displayed while receiving the invitation to the event (e.g., a user interface that does not correspond and/or does not relate to the event and/or the invitation to the event). In some embodiments, the first representation of the event and the control for accepting the invitation to the event are displayed within the second user interface (e.g., with or without displaying the lockscreen or other user interface of the operating system). Displaying a representation of an event and a control for accepting an invitation to the event within a user interface of an application that had a user interface being displayed before and while receiving the invitation to the event allows the first computer system to require that the first computer system is already displaying a user interface of the application before going through a process to receive and/or accept the invitation, thereby performing an operation when a set of conditions has been met without requiring further user input and/or providing improved feedback to the user.

In some embodiments, a user (e.g., a user account) (e.g., “Kate”) corresponding the first computer system (e.g., 610) was not invited to the event before receiving the invitation to the event. In some embodiments, the user is invited to the event in conjunction with (e.g., as part of, while, after, and/or in response to) receiving the invitation to the event. In some embodiments, the invitation is a general invitation and not specific to the user. In some embodiments, the user is never specifically invited to the event and instead accepts the general invitation. An invitation to an event received via a peer-to-peer connection acting as an invitation to the event allows different users to be invited to an event without requiring information corresponding to the different users to be entered into a form for sending invitations, thereby performing an operation when a set of conditions has been met without requiring further user input and/or providing improved feedback to the user.

In some embodiments, the event corresponds to a first application (e.g., an event application, such as a calendar or third party application) (and/or a first process, such as an application process). In some embodiments, while (and/or before) receiving the invitation to the event, the first computer system displays (and/or maintains display of), via the one or more display generation components, a user interface (e.g., 616) of a second application (and/or a second process, such as a system process or an application process) different from the first application. Displaying a user interface that does not relate to an event while receiving an invitation to the event allows the first computer system to surface information (e.g., a representation of the event and/or a control for accepting the invitation to the event) in response to receiving the invitation without requiring the first computer system display a related user interface, thereby performing an operation when a set of conditions has been met without requiring further user input and/or providing improved feedback to the user.

In some embodiments, the invitation to the event is received while the first computer system is in a locked state (e.g., the one or more display generation components are in an off or standby mode and/or the first computer system is displaying, via the one or more display generation components, a lockscreen) (e.g., 616). Receiving an invitation to an event while the first computer system is in a locked state allows the computer system to be invited to the event without requiring user authentication when the invitation is sent based on the first computer system being within proximity of the second computer system, thereby performing an operation when a set of conditions has been met without requiring further user input and/or providing improved feedback to the user.

In some embodiments, the first representation of the event and the control for accepting the invitation to the event are displayed while the first computer system is in the locked state (e.g., the first computer system is displaying, via the one or more display generation components, a lockscreen) (e.g., as described with respect to FIG. 6B). Displaying a representation of an event and a control for accepting an invitation to the event while the first computer system is in a locked state allows the first computer system to respond to some inputs even while the first computer system is in the locked state, thereby performing an operation when a set of conditions has been met without requiring further user input and/or providing improved feedback to the user.

Note that details of the processes described above with respect to process 700 (e.g., FIG. 7) are also applicable in an analogous manner to other processes described herein. For example, process 900 optionally includes one or more of the characteristics of the various processes described above with reference to process 700. For example, the first event of process 900 can be the event of process 700. For brevity, these details are not repeated herein.

FIGS. 8A-8AK illustrate exemplary user interfaces for interacting with an event invitation in accordance with some embodiments. The user interfaces in these figures are used to illustrate the processes described below, including the processes in FIGS. 9-11.

FIGS. 8A-8AK illustrate processes of creating, sharing, viewing, and editing an event invitation from the perspectives of the creator of the event as well as from the perspective of a guest of the event. FIGS. 8A-8AK illustrate computer system 600 and computer system 610 as illustrated and described with respect to FIGS. 6A-6F. Because the example of FIGS. 8A-8AK includes previous and upcoming events, it should be noted that the current date of the example of FIGS. 8A-8AK is May 10, 2024.

FIGS. 8A-8H illustrate a process of a computer system adding integrations to a user interface for an event. Such integrations are then accessibly by users who receive invitations to the event and/or have indicated that they are attending the event. The event that the computer system is creating is Jane's Birthday Party as illustrated and described with respect to FIGS. 6A-6F.

FIG. 8A illustrates computer system 600, which is the computer system belonging to the creator of the Jane's Birthday Party event (e.g., Johnny). As illustrated in FIG. 8A, computer system 600 displays event dashboard user interface 802. Event dashboard user interface 802 is a user interface where computer system 600 displays previews of different events. In some embodiments, the previews that computer system 600 displays include previous and/or upcoming events, which will be discussed in further detail below. Event dashboard user interface 802 as illustrated in FIG. 8A includes indicator 804, “No Upcoming Events,” which indicates that Johnny has not created or accepted any upcoming events. Computer system 600 displays add control 806 at the top of event dashboard user interface 802, which is a control to create a new event. At FIG. 8A, computer system 600 detects tap input 805a directed to add control 806.

As illustrated in FIG. 8B, in response to detecting input 805a, computer system 600 displays create event user interface 808, which is a user interface with which Johnny adds details to create an invitation for the event. As illustrated in FIG. 8B, within create event user interface 808, computer system 600 displays section 808a, which includes photo 604 of Jane and event title 606a, “Jane's Birthday Party” as illustrated in FIGS. 6A-6F. Below section 808a, computer system 600 displays details 606 as described above with respect to FIG. 6A. Details 606 includes the date and time of the event as well as a control (e.g., 808c) for Johnny to enter an address where the party will take place. Below details 606, computer system 600 displays host note 808b, which is a note from the host (e.g., Johnny) that will be visible to guests of the event once the guests accept the invitation. Below host note 808b, computer system 600 displays album control 808c, with which Johnny adds photos to the invitation that will be visible to guests of the event once the guests accept the invitation. At FIG. 8B, Johnny has not yet added any photos to the invitation. In some embodiments, after computer system 600 creates the event, attendees and/or Johnny can add photos to the event by selecting album control 808c. In some embodiments, attendees and/or Johnny can add one or more photos to the event via a share control within the photos application within a computer system. Although the above describes each of the elements of the event invitation including details of the event, in some embodiments, each of the above details are added individually by Johnny by selecting each corresponding control and typing in the corresponding information. In some embodiments, in response to detecting input 805a directed to control 806, computer system 600 displays one or more prompts to populate the information corresponding to the event. At FIG. 8B, computer system 600 detects tap input 805b directed to add address control 808c.

In the bottom right corner of create event user interface 808, computer system 600 displays integrations control 808d, with which Johnny adds integrations to the invitation. In this example, integrations are controls that display information, such as weather and directions, or provide access to applications, such as music and donations. At a time between FIG. 8B and FIG. 8C, computer system 600 detects Johnny adding an address (e.g., 123 Main St. Cupertino, CA) to details 606. In response to detecting an added address, computer system 600 displays integration 808f, which is a maps application control that includes directions to the address of the event. In some embodiments, in response to detecting an input directed to integration 808f, computer system 600 opens the maps application and displays directions from the current location of the user to the address of the party. For example, in response to detecting an input directed to integration 808f, computer system 600 displays the maps application displaying a route from the location of computer system 600 to 123 Main St. Cupertino, CA (e.g., the location of the party), including a route time and traffic conditions. At FIG. 8C, computer system 600 detects tap input 805c directed to add control 808g of integrations control 808d.

As illustrated in FIG. 8D, in response to detecting input 805c, computer system 600 displays menu 810, which includes options of different integrations for Johnny to add to create event user interface 808. Integrations 810a-c listed within menu 810 are representations of applications. For example, in some embodiments, an input directed to integration 810a, “Weather,” adds a control to create event user interface 808 that is associated with the weather application. For another example, in some embodiments, an input directed to integration 810b, “Playlist,” adds a control to create event user interface 808 that is associated with a music application. Integration 810d is a control with which Johnny can add a link (e.g., website URL) to create event user interface 808, such as a link to a gift registration or an online menu. Integration 810c, “Food Delivery,” corresponds to a food delivery application. At FIG. 8D, computer system 600 detects tap input 805d directed to integration 810c.

As illustrated in FIG. 8E, in response to detecting input 805d, computer system 600 adds integration 810c to create event user interface 808. Integration 810c on create event user interface 808 allows Johnny (and guests once the event is created and the guest accepts the invitation) access to the food delivery application to order food for the party via a food delivery service. In some embodiments, computer system 600 adds information into integration 810c, such as the address, date, and time of the event to facilitate the food delivery. Note that, to add integration 810c, computer system 600 moved and reshaped album control 808c to create space for integration 810c. Specifically, computer system 600 shrunk album control 808c from a rectangle shape to a square shape and moved album control 808c to the right edge of create event user interface 808. In some embodiments, computer system 600 does not shrink album control 808c or any other controls to create space for integration 810c. On the left edge of create event user interface 808 where computer system 600 previously displayed album control 808c, computer system 600 displays integration 810c. At FIG. 8E, computer system 600 detects tap input 805e directed to add control 808g of integrations control 808d.

As illustrated in FIG. 8F, in response to detecting input 805c, computer system 600 displays menu 810 as illustrated in FIG. 8D. Note that computer system 600 replaced integration 810c “Food Delivery” with integration 810d, “Link” and added integration 810e “Donations” below integration 810d. Computer system 600 moved integration 810d up in the list to replace integration 810c and added integration 810e to the bottom of the list. Stated differently, menu 810 lists integrations sequentially from top to bottom. In some embodiments, in response to detecting an input directed to integration 810c, computer system 600 displays a donation application displaying options for guests to donate money to Johnny for the costs of the event. With integration 810e, Johnny (and guests once the guest accepts the invite) can donate to the party fund. At FIG. 8F, computer system 600 detects tap input 805f directed to integration 810a “Weather.”

As illustrated in FIG. 8G, in response to detecting input 805f, computer system 600 adds integration 810a to create event user interface 808 at the location where computer system 600 previously displayed integrations control 808d. That is, computer system 600 moved integrations control 808d further down create event user interface 808 to allow space for integration 810a, which computer system 600 displays as information associated with weather at the location and date of the party, including the current, high, and low temperatures, as well as other weather factors. In the top right corner of create event user interface 808, computer system 600 displays done control 808h, which completes the creation of the event invitation. At FIG. 8G, computer system 600 detects tap input 805g directed to done control 808h.

As illustrated in FIG. 8H, in response to detecting input 805g, computer system 600 creates the event invitation for Jane's Birthday Party and displays share user interface 812. Share user interface 812 includes preview user interface 812a of the event invitation; control 812b, with which computer system 600 shares the invitation via a link to a group of guests; control 812c, with which computer system 600 shares the invitation with one guest at a time; control 812d, with which computer system 600 dismisses share user interface 812; control 812e, with which computer system 600 displays a privacy settings user interface; control 812f; and control 812g. In some embodiments, in response to detecting an input directed to control 812f, computer system 600 displays options to edit components of the event invitation, such as the time or the integrations. In some embodiments, in response to detecting an input directed to control 812g, computer system 600 displays a full-size preview of the event invitation. In some embodiments, computer system 600 detects tap input 805h1 directed to control 812b. In some embodiments, computer system 600 detects tap input 805h2 directed to control 812c. In some embodiments, computer system 600 detects tap input 805h4 directed to control 812e. At FIG. 8H, computer system 600 detects tap input 805h3 directed to control 812d.

FIGS. 8I-8AB illustrate a process of Johnny and a guest of Jane's Birthday Party sharing the invitation based on a sharing restriction. FIGS. 8I-8AB illustrate both computer system 600, which belongs to the host (e.g., Johnny), and computer system 610, which belongs to the guest (e.g., Kate), as illustrated and described with respect to FIGS. 6A-6F.

As illustrated in FIG. 8I, in response to detecting input 805h3, computer system 600 displays the completed event invitation user interface 602 for Jane's Birthday Party. In addition to the elements of invitation user interface as illustrated and described with respect to FIGS. 6A-6F, invitation user interface 602 includes indicator 814, “Event Created” to indicate to Johnny that computer system 600 completed the creating process of the invitation; control 816, which is a control to open a menu; indicator 818, which is a typed description of the event; and events control 820, which causes computer system 600 to redisplay event dashboard user interface 802 as illustrated in FIG. 8A. Based on a determination that Johnny added photos to invitation user interface 602 at a time before or after FIG. 8G, computer system 600 displays photos 612 within invitation user interface 602 in FIG. 8I. In some embodiments, at FIG. 8I, computer system 600 detects tap input 805i2 directed to events control 820. At FIG. 8I, computer system 600 detects tap input 805i1 directed to control 816.

As illustrated in FIG. 8J, in response to detecting input 805i1, computer system 600 displays menu 822 below control 816. Menu 822 includes different ways for Johnny to interact with the event invitation. For example, with edit control 822a, computer system 600 redisplays create event user interface 808 for computer system 600 to make further edits to the invitation, such as changing the photos or address associated with the event. It should be noted that the elements of menu 822 are specific to the host view and computer system 600 does not display menu 822 in response to detecting an input directed to control 816 when in a guest view, as discussed further below.

FIG. 8K illustrates computer system 600 displaying settings user interface 824 in response to detecting input 805h4 directed to control 812e (e.g., Privacy Settings) as illustrated in FIG. 8H. Settings user interface 824 includes settings and restrictions that computer system 600 can configure, such as settings related to notifications and guests. For example, privacy settings 854 includes options for Johnny to place restrictions on event invitations, such as turning off RSVPs for the event so that no more guests can RSVP. Delete control 856 allows Johnny to delete the event and the associated invitation altogether. New guests control 858 allows Johnny to view new guests that have RSVP'd to the event (e.g., in some embodiments, guests that were invited by other guests). Settings user interface 824 includes attendees section 826, which includes additional guests option 826a. Computer system 600 utilizes additional guests option 826a to determine whether or not an invited guest can share the event invitation with other contacts, a process which will be described and illustrated in detail below. As illustrated in FIG. 8K, option 826a is turned on, as indicated by computer system 600 displaying toggle 826b in an on state.

FIG. 8L illustrates computer system 600 displaying contacts user interface 830 in response to detecting input 805h2 directed to control 812c as illustrated in FIG. 8H. Contacts user interface 830 includes a list of contact names that have not yet been invited to Jane's Birthday Party that are saved on computer system 600. Computer system 600 displays contacts user interface 830 so that Johnny can select a name of a user with whom to share the invitation to Jane's Birthday Party. Across from each contact name is an empty circle to indicate whether or not a name is selected for sharing. In some embodiments, the circles indicate (e.g., with check marks) guests that have already been invited to the event by Johnny or, in some embodiments, by another guest. As illustrated in FIG. 8L, computer system 600 displays the circles within contacts user interface 830 as empty, which indicates that no names are selected to share the invitation. Recall that with control 812c computer system 600 shares the event invitation with contacts individually. Therefore, within contacts user interface 830, computer system 600 allows for Johnny to select one user at a time with whom to share the invitation. At FIG. 8L, computer system 600 detects tap input 805l directed to contact 830a, Kate Palmer.

As illustrated in FIG. 8M, in response to detecting input 805l, computer system 600 displays the circle associated with Kate's contact, circle 830b, as filled in with a check mark, which indicates that computer system 600 selected Kate's name to send the invitation to. Also illustrated in FIG. 8M, in response to detecting input 805l, computer system 600 displays share element 832 overlaid on contact user interface 830. Share element 832 is a user interface element in which computer system 600 selects the method/application with which to send the invitation to Kate. Share element 832 includes preview 832a, which is a minimized preview of the invitation to Jane's Birthday Party; indicator 832b, “Sending to Kate,” which indicates that computer system 600 is sending the invitation to Kate; and methods 832c-f. Methods 832c-f include applications such as messaging and mail that are different ways that computer system 600 can send the invitation to Kate. It should be noted that computer system 600 displays certain methods only when computer system 600 has access to the respective contact information pertaining to the method. For example, computer system 600 displays method 832e, “Mail” because computer system 600 has Kate's e-mail address. For another example, computer system 600 displays method 832d, “Message,” which is the system text messaging application of computer system 600, because computer system 600 has access to Kate's phone number. For another example, computer system 600 displays method 832f, “Social Messaging,” which represents a social media application, because computer system 600 has access to message Kate via the social media application. At FIG. 8M, computer system 600 detects tap input 805m directed to method 832d, the system text messaging application of computer system 600.

As illustrated in FIG. 8N, in response to detecting input 805m, computer system 600 displays sending user interface 834. By displaying sending user interface 834, computer system 600 is preparing to send the invitation to Kate, as indicated by recipient indicator 834a, “To: Kate Palmer.” Sending user interface 834 also includes invitation preview 834b and message 834c at a location corresponding to a message about to be sent. In some embodiments, computer system 600 prepopulates message 834c in response to detecting input 805m to share the invitation with Kate. In some embodiments, Johnny types message 834c using the keyboard of computer system 600. At FIG. 8N, computer system 600 detects tap input 805n directed to send control 834d.

As illustrated in FIG. 8O, in response to detecting input 805n, computer system 600 redisplays contacts user interface 830. In response to sending the invitation to Kate, computer system 600 displays invited tab 830c at the top of contacts user interface 830. Below invited tab 830c, computer system 600 displays contact 830a, Kate Palmer, to indicate that computer system 600 sent the invitation to Kate and therefore Kate is invited to the event. At FIG. 8O, Johnny can select another contact name to send an invitation to.

FIGS. 8P-8V and FIGS. 8X-8AA illustrate processes of sharing the invitation from the perspective of a guest. That is, FIGS. 8P-8V and FIGS. 8X-8AA illustrate computer system 610, Kate's phone, as illustrated and described above with respect to FIGS. 6A-6F.

FIG. 8P illustrates computer system 610 receiving the invitation to Jane's Birthday Party via text message in response to computer system 600 sending the invitation as illustrated in FIG. 8N. As illustrated in FIG. 8P, computer system 610 displays receiving user interface 836. Receiving user interface 836 includes the messages that Johnny sent, message 836a, which is a preview of the invitation to the party, and message 836b, which is text prompting Kate to RSVP to Jane's Birthday Party. Note that computer system 610 displays message 836a and message 836b on the left side of receiving user interface 834, which further indicates that message 836a and message 836b are texts that computer system 610 is receiving. Indicator 836c, “JA,” indicates the initials of the sender of message 836a and message 836b (e.g., Johnny Appleseed). At FIG. 8P, computer system 610 detects tap input 805p directed to message 836a (e.g., the invitation preview).

As illustrated in FIG. 8Q, in response to detecting input 805p, computer system 610 displays invitation user interface 636, including controls 636d-f, attendees tile 636g, and integrations 636h and 636i. Recall computer system 600 adding integration 636h (e.g., weather) and integration 636i (e.g., map) in FIGS. 8C-8G. Because FIG. 8Q illustrates the guest view of the completed invitation, invitation user interface 636 in FIG. 8Q includes integration 636h and integration 636i so that the guest (e.g., Kate) can interact with the applications associated with integration 636h and 636i. For example, in some embodiments, in response to detecting the selection of integration 636i, computer system 610 opens the maps application displaying directions from Kate's current location to the address of the party.

Note that computer system 610 in FIG. 8Q displays share control 636j at the top of invitation user interface 636. Computer system 610 displaying share control 636j while displaying a guest view of invitation user interface 636 indicates that computer system 610 can share the invitation with other users. As discussed above in relation to FIG. 8K, computer system 610 (e.g., Kate's device) can share the invitation due to computer system 600 (e.g., Johnny's device) displaying toggle 826b in an on state. That is, computer system 600 has the option for attendees to send the invitation to additional guests turned on. At FIG. 8Q, computer system 610 detects tap input 805q directed to going control 636f.

As illustrated in FIG. 8R, in response to detecting input 805q, computer system 610 displays going control 636f as shaded, which indicates that Kate is going to the party. Also illustrated in FIG. 8R, in response to detecting input 805q, computer system 610 displays list 838, which is a categorized list of guests, including invited guests, guests who have RSVP′d as “going,” guests who have RSVP′d as “not going,” and guests who have not yet RSVP′d. In some embodiments, at FIG. 8R, computer system 610 detects tap input 805r1 directed to share control 636j. At FIG. 8R, cs6 detects tap input 805r2 directed to control 816.

Recall from the discussion of FIG. 8J that inputs directed to control 816 while in the host view and in the guest view display different menus. As illustrated in FIG. 8S, in response to detecting input 805r2, computer system 610 displays menu 840 below control 816. Note that, even though computer system 610 displays menu 840 in response to detecting an input directed to control 816, menu 840 is a different menu from menu 822 as displayed in FIG. 8J in response to detecting an input directed to control 816. Menu 840 includes different ways for Kate to interact with the event invitation. For example, an input directed to control 840b (e.g., the pencil icon) next to indicator 840a allows Kate to edit her name as it is displayed on the RSVP list. Specifically, Kate can use control 840b to change her name to display as “Best Aunt Ever” on Johnny's guest list. Other functionalities of menu 840 include adding the invitation to Kate's calendar and displaying event settings.

FIG. 8T illustrates computer system 610 displaying contact list user interface 842 in response to detecting input 805r1 in FIG. 8R. That is, in response to detecting input 805r1 directed to share control 828, computer system 610 displays contact list user interface 842 for Kate to select a contact with whom to share the invitation to Jane's Birthday Party. Across from each contact name is an empty circle to indicate whether or not a name is selected for sharing. As illustrated in FIG. 8T, computer system 610 displays the circles within contacts user interface 842 as empty, which indicates that no names are selected to share the invitation. At FIG. 8T, computer system 610 detects tap input 805t directed to contact 842a, Taylor Anderson.

As illustrated in FIG. 8U, in response to detecting input 805t, computer system 610 displays share element 844 overlaid on contact user interface 842. Share element 844 is a user interface element in which Kate selects the method and/or application with which to send the invitation to Taylor. Share element 844 includes preview 844a, which is a minimized preview of the invitation to Jane's Birthday Party; indicator 844b, “Sending to Taylor” which indicates that computer system 610 is sending the invitation to Taylor; and methods 844c-d. Methods 844c-d include Transfer method 844c and Message method 844d, which are different ways that computer system 610 can send the invitation to Taylor. It should be noted that computer system 610 displays certain methods only when computer system 610 has access to the respective contact information pertaining to the method. For example, note that computer system 610 does not display method 832f, Social Messaging, as illustrated in FIG. 8L, when computer system 600 is sending the invitation to Kate. The difference in displayed methods is due to computer system 600 having access to message Kate via Social Messaging but computer system 610 not having access to message Taylor via Social Messaging. At FIG. 8U, computer system 600 detects tap input 805u directed to method 844d, the system text messaging application of computer system 610.

As illustrated in FIG. 8V, in response to detecting input 805u, computer system 610 displays sending user interface 846. By displaying sending user interface 846, computer system 610 is preparing to send the invitation to Taylor, as indicated by recipient indicator 846a, “To: Taylor Anderson.” Sending user interface 846 also includes invitation preview 846b and message 846c at a location corresponding to a message about to be sent. In some embodiments, computer system 610 prepopulates message 846c in response to detecting input 805u to share the invitation with Taylor. In some embodiments, Kate types message 846c using the keyboard of computer system 610. At FIG. 8V, computer system 600 detects tap input 805v directed to send control 846d.

FIG. 8W illustrates computer system 600 (e.g., belonging to Johnny) displaying settings user interface 824 in response to detecting input 805h4 directed to control 812e (e.g., Privacy Settings) as illustrated in FIG. 8H. However, settings user interface 824 as illustrated in FIG. 8W is an alternative situation to the settings as illustrated in FIG. 8K. Specifically, in FIG. 8W, computer system 600 displays toggle 826b as in an off state. That is, in FIG. 8W, computer system 600 restricts guests from sending the invitation to other contacts.

FIG. 8X illustrates computer system 610 as illustrated in FIG. 8P. That is, FIG. 8X illustrates computer system 610 (e.g., belonging to Kate) receiving the invitation via text message in response to computer system 600 sending the invitation as illustrated in FIG. 8N. As illustrated in FIG. 8X, computer system 610 displays receiving user interface 836. Receiving user interface 836 includes the messages that Johnny sent, message 836a, which is a preview of the invitation to the party, and message 836b, which is text prompting Kate to RSVP to Jane's Birthday Invitation. Note that computer system 610 displays message 836a and message 836b on the left side of receiving user interface 836, which further indicates that message 836a and message 836b are texts that computer system 610 is receiving. Indicator 836c, “JA,” indicate the initials of the sender of message 836a and message 836b (e.g., Johnny Appleseed). At FIG. 8X, computer system 610 detects tap input 805x directed to message 836a (e.g., the invitation preview).

As illustrated in FIG. 8Y, in response to detecting input 805x, computer system 610 displays invitation user interface 636 as illustrated in FIG. 8Q, including controls 636a-c, attendees tile 636c, and integrations 636f and 636g. Note that computer system 610 in FIG. 8Y does not display share control 636h at the top of invitation user interface 636 as illustrated in FIG. 8Q. Computer system 610 not displaying share control 636h while displaying a guest view of invitation user interface 636 indicates that computer system 610 cannot (e.g., does to have allowance to) share the invitation with other users. As discussed above in relation to FIG. 8W, computer system 610 (e.g., Kate's phone) cannot share the invitation due to computer system 600 (e.g., Johnny's phone) displaying toggle 826b in an off state. That is, computer system 600 has the option for attendees to send the invitation to additional guests turned off. In some embodiments, computer system 610 does not display share control 636h in FIG. 8Y due to the current time and/or date. For example, computer system 610 displays share control 636h up until a week before the event. At a time when the date of the event is less than a week away, computer system 610 does not display share control 636h. The time restriction as it relates to guests sharing an invitation with other users avoids last minute additions of guests for which the host of the event might not be prepared to accommodate. At FIG. 8X, computer system 610 detects tap input 805y directed to going control 636c.

FIG. 8Z illustrates an alternative user interface to menu 840 as illustrated in 8S. That is, in some embodiments, computer system 610 displays indicator element 848 as illustrated in FIG. 8Z instead of menu 840 in FIG. 8S in response to a guest accepting the invitation. Specifically, as illustrated in FIG. 8Z, in response to detecting input 805y, computer system 610 displays indicator element 848 overlaid on invitation user interface 602. Indicator element 848 is an element that computer system 610 displays as the guest (e.g., Kate) is accepting the invitation. Indicator element 848 allows Kate to customize her RSVP, such as changing her name via control 848a, adding a message via control 848b, adding additional guests via control 848c, and turning on or off event notifications via control 848d. In some embodiments, Kate changes her name by typing a different name into control 848a. In some embodiments, Kate types a message to add to the invitation via control 848b. In some embodiments, Kate adds or removes additional guests to bring to the event by changing the number displayed by control 848c. In some embodiments, the changes Kate submits by inputs on control 848a, 848b, and 848c are sent to the host of the event (and update related information such as attendee count and names of attendees). In some embodiments, Kate performs an input directed to control 848d to turn on or turn off the function of receiving notifications related to the event. At FIG. 8Z, computer system 610 detects tap input 805z directed to submit control 848c.

As illustrated in FIG. 8AA, in response to detecting input 8052, computer system 610 displays invitation user interface 636 as illustrated in FIG. 8R with going control 636c displayed as selected (e.g., shaded). Note that, due to computer system 600 restricting guests from sending the invitation to other contacts, computer system 610 does not display share control 636h on invitation user interface 636.

FIG. 8AB illustrates computer system 600 (e.g., belonging to Johnny) in response to detecting input 805h1 directed to share group control 812b of share user interface 812 as illustrated in FIG. 8H. In FIG. 8AB, computer system 610 displays share element 832 overlaid on share user interface 812. That is, computer system 600 displays share element 832 in response to detecting input 805h1 to share the invitation via a group link (e.g., in a group chat to more than one person at a time). For example, within share element 832, group 832g (e.g., “Family, 4 People”) is a family group chat of four people (e.g., also indicated by the four animated faces). Share element 832 is a user interface element in which Johnny selects the method and/or application with which to send the invitation to a group. Share element 832 includes preview 832a, which is a minimized preview of the invitation to Jane's Birthday Party; groups 832g-i, which are three different group chats to which computer system 600 can send the invitation; and method 832c, method 832d, and method 832e. Method 832c, method 832d, and method 832c include applications such as messaging and mail that are different ways that computer system 600 can send the invitation to a group. At FIG. 8AB, computer system 600 displays group chats in response to detecting input 805h1, which is an input to group share the invitation. Recall that computer system 600 displays certain methods only when computer system 600 has access to the respective contact information pertaining to the method. For example, computer system 600 displays method 832e, “Mail” because computer system 600 has the e-mail address of each contact in each group. For another example, computer system 600 does not display method 832f, “Social Messaging,” which represents a social media application, because computer system 600 does not have access to message each member of each group via the social media application. Computer system 600 displays icon 832j on the corner of group 832g and icon 832k on the corner of group 832h. Icon 832j and icon 832k are icons of the system text messaging application and indicate that computer system 600 has the phone number of each of the contacts within group 832g and group 832h and is able to send the invitation via text message to the groups. Computer system 600 displays icon 832l, an icon of the system e-mail application, on the corner of group 832i. Icon 832l on the corner of group 832i indicates that computer system 600 has the e-mail address of each of the contacts within group 832i and is able to send the invitation via e-mail to group 832i. In some embodiments, computer system 600 displays icon 832l on the corner of group 832i to indicate that computer system 600 does not have the phone number of each of the contacts in group 832i and therefore cannot send the invitation via the system text messaging application.

FIGS. 8AC-8AK illustrate a process of viewing previews of upcoming and past events. Previews of upcoming and past events include previews of invitations for various events that are either in the future or have already happened.

FIG. 8AC illustrates computer system 600 in response to detecting input 805i2 directed to events control 820 as illustrated in FIG. 8I. In response to detecting input 805i2 directed to events control 820, computer system 600 redisplays event dashboard user interface 802 as illustrated in FIG. 8A with various preview of invitations to events. Event dashboard user interface 802 includes preview 802b, the invitation for Jane's Birthday Party, in the middle of event dashboard user interface 802, a partial display of preview 802c, which is an invitation for a barbeque event, below preview 802b, and a partial display of preview 802d, which is an invitation to a basketball game event, to the left of preview 802b. The previews of the event invitations include a photo associated with the event, a title of the event, and a date and time of the event. In some embodiments, the event invitations include an address and/or name of the location of the event. Note that event dashboard user interface 802 includes indicator 802a, “Upcoming Events,” which indicates that computer system 600 is displaying an upcoming event (e.g., as opposed to a past event) via event dashboard user interface 802. At FIG. 8AC, computer system 600 detects swipe up input 805ac directed to event dashboard user interface 802.

As illustrated in FIG. 8AD, in response to detecting input 805ac, computer system 600 scrolls event dashboard user interface 802 to display preview 802c in the middle of event dashboard user interface 802. In the example of FIGS. 8AC-8AK, computer system 600 displays upcoming events vertically and past events horizontally. For example, computer system 600 displays preview 802b, the invitation for Jane's Birthday Party, and preview 802c as having moved vertically. Recall that the current date of the example of FIGS. 8A-8AK is May 10th. Note that both preview 802b and preview 802c are upcoming events (e.g., the date of preview 802b is June 2nd and the date of preview 802c is July 7th). Below preview 802c, computer system 600 displays another upcoming event as preview 802e, a fireworks event. Note that, even though computer system 600 scrolled the upcoming events up vertically, computer system 600 did not move preview 802d because preview 802d is not a vertically displayed event. At FIG. 8AD, computer system 600 detects swipe right input 805ad directed to event dashboard user interface 802.

As illustrated in FIG. 8AE, in response to detecting input 805ad, computer system 600 scrolls event dashboard user interface 802 horizontally to display preview 802d in the middle of event dashboard user interface 802. Note that, because preview 802d is a past event, computer system 600 displays indicator 802a as “Past Events.” Computer system 600 displays an additional past event, preview 802f, a graduation invitation, below preview 802d. Note that computer system 600 partially displays preview 802c, as illustrated in FIG. 8AD, to the right of preview 802d. As illustrated in FIG. 8AE, computer system 600 displays photo 802g, a photo of a child shooting a basketball, within preview 802d. In some embodiments, photo 802g is the cover photo (e.g., the main photo associated with the invitation) that the host of the event uploaded when creating the invitation associated with preview 802d.

As illustrated in FIG. 8AF, at a period of time after FIG. 8AE, computer system 600 ceases to display photo 802g and begins to display photo 802h on preview 802d. Photo 802h is a photo of children playing basketball. Computer system 600 transitions from photo 802g to photo 805h in a slideshow format. That is, computer system 600 displays photo 802g as fading out and photo 802h as fading in.

As illustrated in FIG. 8AG, at a period of time after FIG. 8AG, computer system 600 ceases to display photo 802h and begins to display photo 802i on preview 802d. Photo 805i is a photo of a children's basketball team holding a trophy. Computer system 600 transitions from photo 802h to photo 802i in a slideshow format. That is, computer system 600 displays photo 802h as fading out and photo 802i as fading in. In some embodiments, the photos that computer system 600 displays in the slideshow are uploaded by the host of the event. In some embodiments, the photos that computer system 600 displays in the slideshow are uploaded to a shared album by an attendee of the event, as described above with respect to album control 808c of FIG. DB. At FIG. 8AG, computer system 600 detects swipe up input 805ag directed to event dashboard user interface 802.

As illustrated in FIG. 8AH, in response to detecting input 805ag, computer system 600 scrolls event dashboard user interface 802 vertically to display preview 802f, a graduation invitation, in the middle of event dashboard user interface 802. Note that, because preview 802f is a past event, computer system 600 continues to display indicator 802a as “Past Events.” At FIG. 8AH, computer system 600 detects tap input 805ah directed to preview 802f.

As illustrated in FIG. 8AI, in response to detecting input 805ah, computer system 600 displays invitation user interface 850. Invitation user interface 850 is the invitation associated with the graduation invitation (e.g., preview 802f). Specifically, invitation user interface 850 is the invitation to Sophia's Graduation and includes elements similar to those described above in relation to FIG. 8I. Note that invitation user interface 850 does not include a share control, which indicates that the host of the event placed a restriction on the event in which guests cannot share the event with other contacts. Invitation user interface 850 also includes activity control 850a, which allows a user to view activity associated with the event, such as RSVP lists and messages. At FIG. 8AI, computer system 600 detects tap input 805ai directed to activity control 850a.

As illustrated in FIG. 8AJ, in response to detecting input 805ai, computer system 600 displays activity user interface 852. Activity user interface 852 includes attendees tab 852a and messages tab 852b at the top of activity user interface 852. As illustrated in FIG. 8AJ, computer system 600 displays attendees tab 852a as selected. The elements of attendees tab 852a include indicators 852c, which are animated faces of guests that attended Sophia's Graduation, along with a message from one guest, Alice. Attendees tab 852a also includes guest list 852d, which is a list of guests that attended Sophia's Graduation. Each of the names in list 852d has a corresponding indicator to remove the name from the list of guests. At FIG. 8AJ, computer system 600 detects tap input 805aj directed to messages tab 852b.

As illustrated in FIG. 8AK, in response to detecting input 805aj, computer system 600 displays messages tab 852b as selected. Computer system 600 utilizes messages tab 852b to display messages associated with the event of Sophia's Graduation. The elements of messages tab 852b include host note 808b as illustrated in FIG. 8B and guest messages 852e, which include messages and comments from guests. The messages that computer system 600 displays are written by guests in user interfaces such as indicator element 848 as described above with respect to FIG. 8Z. That is, computer system 600 displays the messages that guests type using control 848b of indicator element 848 onto messages tab 852b. Host note 808b is the message that the host types when creating the event, as discussed above with respect to FIG. 8B.

FIG. 9 is a flow diagram illustrating a process (e.g., process 900) for presenting events in accordance with some embodiments. Some operations in process 900 are, optionally, combined, the orders of some operations are, optionally, changed, and some operations are, optionally, omitted.

As described below, process 900 provides an intuitive way for presenting events. Process 900 reduces the cognitive burden on a user, thereby creating a more efficient human-machine interface. For battery-operated computing devices, enabling a user to interact with such devices faster and more efficiently conserves power and increases the time between battery charges.

In some embodiments, process 900 is performed at a computer system (e.g., 600 and/or 610) that is in communication (e.g., wired communication and/or wireless communication) with one or more input devices (e.g., a camera, a depth sensor, a microphone, a hardware input mechanism, a rotatable input mechanism, a heart monitor, a temperature sensor, and/or a touch-sensitive surface) and one or more display generation components (e.g., a display screen, a projector, and/or a touch-sensitive display). In some embodiments, the computer system is a phone, a watch, a tablet, a fitness tracking device, a wearable device, an accessory, a speaker, a light, a head-mounted display (HMD), and/or a personal computing device.

The computer system detects (902), via the one or more input devices, an input (e.g., a selection input and/or a non-selection input) (e.g., 805ad and/or 805ag) corresponding to a request to view (e.g., display and/or output) one or more events (e.g., a past event, a current event, a future event, and/or an event of a first type). In some embodiments, a selection input includes a tap input, a verbal input, an audible command, a gaze input, an air gesture, a mouse click, and/or a submission of a user-interface element and/or a physical hardware element. In some embodiments, a non-selection input includes a verbal input, an audible request, an audible command, an audible statement, a swipe input, a hold-and-drag input, a gaze input, an air gesture, and/or a mouse movement. In some embodiments, the input corresponding to the request to view one or more events includes a tap input on a control (e.g., an affordance, a button, and/or an add user interface element) for displaying the one or more events. In some embodiments, the input corresponding to the request to view one or more events includes a swipe input on a user interface element of one or more current events (e.g., one or more upcoming events). ISE the event is a past event and/or one or more past events, including, in some embodiments, a specific past event. In some embodiments, the request to view one or more events is a request to view past events. In some embodiments, an event of the first type includes the invitation to the event is with multiple contacts and/or the invitation to the event targeted one or more specific contacts.

In response to detecting the input corresponding to the request to view the one or more events, the computer system displays (904), via the one or more display generation components, a first preview (e.g., 802g and/or 802f) of (e.g., a representation of and/or a portion of content corresponding to) a first event (e.g., an invitation, a calendar invite, a calendar event, an event from an application (e.g., of the computer system), a gathering of one or more invited guests, a social function, and/or a period of one or more planned activities), wherein: (906) in accordance with a determination that the first event (e.g., a gathering of invited guests, social function, and/or period of planned activities) includes shared content (e.g., content associated with and/or corresponding to the first event, content and/or received by the computer system and/or a user from a contact), the first preview of the first event includes at least a portion (e.g., as described above with respect to FIGS. 6AE-6AG) of content (e.g., web pages, audio recordings, music, documents, images and/or videos) from the shared content; and in accordance with (908) a determination that the first event does not include the shared content, the first preview of the first event does not include the portion of the content from the shared content (e.g., as described above with respect to FIG. 8AH). In some embodiments, the first event is an event that previously occurred. In some embodiments, the shared content includes shared media (e.g., photos and/or videos) and/or media corresponding to a shared album. In some embodiments, the portion of the content is a background of the first preview of the first event. Displaying a preview of an event with a portion of content from shared content when the event includes the shared content and without the portion of the content from the shared content when the event does not include the shared content allows the computer system to reflect content that it has access to for the event when the computer system has access to the shared content, thereby performing an operation when a set of conditions has been met without requiring further user input and/or providing improved feedback to the user.

In some embodiments, in accordance with a determination that the shared content includes a first piece of content (e.g., an image, a video, an audio recording, and/or a document) and a second piece of content (e.g., multiple pieces of content) separate from the first piece of content, the first preview of the first event includes the first piece of content for a predetermined period (e.g., 10 seconds to 10 minutes) of time before including the second piece of content (e.g., as described above with respect to FIGS. 6AE-6AG). In some embodiments, in accordance with a determination that the shared content consists of a third piece of content (e.g., a single piece of content, such as not the first piece of content and/or the second piece of content), the first preview of the first event includes the third piece of content without changing to another piece of content different from the third piece of content (e.g., after the predetermined period of time). In some embodiments, the third piece of content is the same as or different from the first piece of content and/or the second piece of content. Changing what content is displayed with the first preview allows the computer system to reflect whether the event has any media added to it, thereby performing an operation when a set of conditions has been met without requiring further user input and/or providing improved feedback to the user.

In some embodiments, the request to view the one or more events includes a request to view one or more past (e.g., previous and/or historical) events (e.g., as described above with respect to FIG. 8AE). In some embodiments, the first event is a past event. In some embodiments, the second event is a past event. The request to view the one or more events being a request to view past events allows the computer system to indicate when events are over and, in some embodiments, include media from the event for those that did not join the past event to experience, thereby performing an operation when a set of conditions has been met without requiring further user input and/or providing improved feedback to the user.

In some embodiments, in response to detecting the input corresponding to the request to view the one or more events, the computer system displays, via the one or more display generation components, a second preview (e.g., a representation of and/or a portion of content corresponding to) (e.g., 802f) of a second event (e.g., an invitation, a calendar invite, a calendar event, an event from an application (e.g., of the computer system), a gathering of one or more invited guests, a social function, and/or a period of one or more planned activities), wherein the second preview is different from the first preview, and wherein the second event is different from the first event. In some embodiments, in accordance with a determination that the second event includes shared content (e.g., content associated with and/or corresponding to the second event, content and/or received by the computer system and/or a user from a contact), the second preview of the second event includes at least a portion of content (e.g., web pages, audio recordings, music, documents, images and/or videos) from the shared content corresponding to the second event. In some embodiments, in accordance with a determination that the second event does not include the shared content corresponding to the second event, the second preview of the second event does not include the portion of the content from the shared content corresponding to the second event. Displaying a second preview of a second event concurrently with a first preview of a first event allows the computer system to provide information related to different events at the same time, thereby performing an operation when a set of conditions has been met without requiring further user input and/or providing improved feedback to the user.

In some embodiments, the input corresponding to the request to view the one or more events. In some embodiments, while displaying the first preview of the first event, the computer system detects, via the one or more input devices, a second input (e.g., a movement input and/or a non-movement input) (e.g., 805ag) separate from the first input. In some embodiments, the second input includes a swipe in a downward motion. In some embodiments, in response to detecting the second input, the computer system displays, via the one or more input devices, a third preview (e.g., 802f) of a third event, wherein the third preview is different from the first preview and the second preview, and wherein the third event is different from the first event and the second event. In some embodiments, in accordance with a determination that the third event includes shared content (e.g., content associated with and/or corresponding to the third event, content and/or received by the computer system and/or a user from a contact), the third preview of the third event includes at least a portion of content (e.g., web pages, audio recordings, music, documents, images and/or videos) from the shared content corresponding to the third event. In some embodiments, in accordance with a determination that the third event does not include the shared content corresponding to the third event, the third preview of the third event does not include the portion of the content from the shared content corresponding to the third event. Displaying a preview of an event in response to detecting a movement input while displaying another preview of another event allows the computer system to provide access to different previews of different events that, in some embodiments, do not fit into displayable area, thereby performing an operation when a set of conditions has been met without requiring further user input and/or providing improved feedback to the user.

In some embodiments, while detecting the input corresponding to the request to view the one or more events, the computer system displays, via the one or more display generation components, a preview (e.g., 802c) (e.g., a representation of and/or a portion of content corresponding to) of a first upcoming event (e.g., an invitation, a calendar invite, a calendar event, an event from an application (e.g., of the computer system), a gathering of one or more invited guests, a social function, and/or a period of one or more planned activities). In some embodiments, the preview of the first upcoming event includes content provided by (e.g., a default and/or preset background corresponding to) a user that created the first upcoming event. In some embodiments, the preview of the first upcoming event includes content added to the first upcoming event when the first upcoming event was created. In some embodiments, the content of the shared content was not provided by a user that created the first event. In some embodiments, the content of the shared content was provided by a user that created the first event but was provided after creating the first event. In some embodiments, the content of the shared content was provided after the first event was created. In some embodiments, the first upcoming event is an event that has no occurred yet. In some embodiments, the first upcoming event is an event that is configured for a date and/or a time that is in the future. In some embodiments, the first event is a past event (e.g., an event that has already occurred). In some embodiments, the first event is an event that is configured for a date and/or a time that is in the past. In some embodiments, in response to detecting the input corresponding to the request to view the one or more events, the computer system ceases display of, via the one or more display generation components, the preview of the first upcoming event. Displaying a preview of an upcoming event when while detecting an input to view one or more past events allows a user to easily navigate between different types of events (e.g., upcoming and past events), thereby performing an operation when a set of conditions has been met without requiring further user input and/or providing improved feedback to the user.

In some embodiments, while detecting the input corresponding to the request to view the one or more events, the computer system displays, via the one or more display generation components, a preview (e.g., 802c and/or 802c) of (e.g., a representation of and/or a portion of content corresponding to) a second upcoming event (e.g., an invitation, a calendar invite, a calendar event, an event from an application (e.g., of the computer system), a gathering of one or more invited guests, a social function, and/or a period of one or more planned activities) with the preview of the first upcoming event, wherein the preview of the second upcoming event is separate from the preview of the first upcoming event, and wherein the second upcoming event is different from the first upcoming event. In some embodiments, the preview of the second upcoming event includes content provided by (e.g., a default and/or preset background corresponding to) a user that created the second upcoming event. In some embodiments, the preview of the second upcoming event includes content added to the second upcoming event when the second upcoming event was created. In some embodiments, the second upcoming event is an event that has no occurred yet. In some embodiments, the second upcoming event is an event that is configured for a date and/or a time that is in the future. In some embodiments, in response to detecting the input corresponding to the request to view the one or more events, the computer system ceases display of, via the one or more display generation components, the preview of the second upcoming event. Displaying multiple previews of upcoming event when detecting an input to view one or more past events allows a user to easily navigate between different types of events (e.g., upcoming and past events), thereby performing an operation when a set of conditions has been met without requiring further user input and/or providing improved feedback to the user.

In some embodiments, the input corresponding to the request to view the one or more events is a first input. In some embodiments, while displaying the preview of the first upcoming event, the computer system detects, via the one or more input devices, a second input (e.g., a movement input and/or a non-movement input) (e.g., 805ad) different from the first input. In some embodiments, the second input is a swipe input, such as to scroll a user interface including the preview of the first upcoming event. In some embodiments, the second input is a request to display a preview of another upcoming event. In some embodiments, in response to detecting the second input, the computer system displays, via the one or more display generation components, a preview (e.g., 802b, 802d, and/or 802e) of a third upcoming event, wherein the preview of the third upcoming event is separate from the preview of the first upcoming event, and wherein the third upcoming event is different from the first upcoming event. In some embodiments, the preview of the third upcoming event includes content provided by (e.g., a default and/or preset background corresponding to) a user that created the third upcoming event. In some embodiments, the preview of the third upcoming event includes content added to the third upcoming event when the third upcoming event was created. In some embodiments, the third upcoming event is an event that has not occurred yet. In some embodiments, the third upcoming event is an event that is configured for a date and/or a time that is in the future. In some embodiments, in response to detecting the second input, the computer system ceases display of, via the one or more display generation components, the preview of the first upcoming event. Displaying previews of different upcoming event when while detecting an input allows a user to easily navigate between different events, thereby performing an operation when a set of conditions has been met without requiring further user input and/or providing improved feedback to the user.

In some embodiments, the computer system detects, via the one or more input devices, a set of one or more inputs (e.g., a selection input and/or a non-selection input) including an input (e.g., a selection input and/or a non-selection input) corresponding to the first preview of the first event. In some embodiments, the set of one or more inputs includes one or more inputs detected while the first preview of the first event is being displayed. In some embodiments, the set of one or more inputs includes one or more inputs detected while the first preview of the first event is not being displayed. In some embodiments, the input corresponding to the first preview of the first event is a tap input on the first preview of the first event. In some embodiments, in response to detecting the set of one or more inputs, the computer system displays, via the one or more display generation components, a user interface (e.g., 852) including a set of one or more messages corresponding to the first event, wherein: in accordance with a determination that a first set of one or more criteria is satisfied (e.g., that a user corresponding to the computer system created the first event and/or is a host of the first event), the user interface includes an option (e.g., a text box, a user interface element, and/or a control) to enter a host message; and in accordance with a determination that a second set of one or more criteria, different from the first set of one or more criteria is satisfied is satisfied (e.g., that a user corresponding to the computer system did not create the first event and/or is not a host of the first event), the user interface does not include an option (e.g., a text box, a user interface element, and/or a control) to enter a host message. Selectively include an option to enter a host message allows the computer system to ensure that certain users have certain functionality, thereby performing an operation when a set of conditions has been met without requiring further user input and/or providing improved feedback to the user. In some embodiments, the set of one or more messages includes one or more messages from users that have accepted an invitation to the first event. In some embodiments, the set of one or more messages includes one or more messages from users that have not accepted an invitation to the first event. In some embodiments, the set of one or more messages includes one or more messages from users that have declined an invitation to the first event. In some embodiments, the set of one or more messages includes one or more messages from one or more attendees of the first event. In some embodiments, the set of one or more messages includes one or more messages from one or more hosts of the first event.

In some embodiments, the one or more messages includes a first set of one or more messages (e.g., 808b) from a host of the first event. In some embodiments, the one or more messages includes a second set of one or more messages (e.g., 852e), different from the first set of one or more messages, from an attendee of the first event. In some embodiments, the first set of one or more messages is displayed in a separate area of the user interface than the second set of one or more message. In some embodiments, the first set of one or more messages is a separate list of messages than the second set of one or more messages. Grouping messages from an attendee in a different area than messages from a host allows the computer system to emphasize different types of users, thereby performing an operation when a set of conditions has been met without requiring further user input and/or providing improved feedback to the user.

In some embodiments, in accordance with the determination that the first event does not include the shared content (and/or in accordance with a determination that the host of the first event defined the media for the first event), the first preview (e.g., 802f) of the first event includes media (e.g., an image, a video, and/or an icon) defined by a host of the first event. In some embodiments, the portion of content from the shared content includes media. In some embodiments, in accordance with the determination that the first event includes the shared content, the first preview of the first event does not include media defined by a host of the first event. A preview of an event including media defined by a host of the event when the event does not include shared content allows the preview to selectively include such media depending on whether shared content is available, thereby performing an operation when a set of conditions has been met without requiring further user input and/or providing improved feedback to the user.

In some embodiments, while displaying the first preview of the first event, the computer system detects, via the one or more input devices, an input (e.g., a selection input and/or a non-selection input) (e.g., 805ah) corresponding to the first preview of the first event. In some embodiments, the input corresponding to the first preview of the first event is a tap input on the first preview of the first event. In some embodiments, in response to detecting the input corresponding to the first preview of the first event, the computer system displays, via the one or more display generation components, information (e.g., 850) corresponding to the first event, wherein the information is not displayed while detecting the input corresponding to the first preview of the first event. In some embodiments, in response to detecting the input corresponding to the first preview of the first event, the computer system ceases display of the first preview of the first event. Displaying additional information corresponding to an event when selecting a preview of the event allows the computer system to limit an amount of information provided to a user at one time while stilling allowing access to more information, thereby performing an operation when a set of conditions has been met without requiring further user input and/or providing improved feedback to the user.

In some embodiments, while displaying the information corresponding to the first event, in accordance with a determination that a first set of one or more criteria is satisfied (e.g., that a host of the first event has enabled sharing for the first event and/or for a user of the computer system), the computer system displays, via the one or more display generation components, a control (e.g., 636j and/or 828) to share (e.g., invite one or more other users to) the first event. In some embodiments, while displaying the control to share the first event, the computer system detects, via the one or more input devices, an input corresponding to the control to share the first event. In some embodiments, the input corresponding to the control to share the first event is a tap input on the control to share the first event. In some embodiments, in response to detecting the input corresponding to the control to share the first event, the computer system initiates a process to share the first event. In some embodiments, the process to share the first event includes displaying, via the one or more display generation components, a user interface to select one or more other users to send an invitation for the first event to. In some embodiments, while displaying the information corresponding to the first event, in accordance with a determination that a second set of one or more criteria, different from the first set of one or more criteria, is satisfied (e.g., that a host of the first event has not enabled sharing for the first event or for a user of the computer system), the computer system forgoes display of, via the one or more display generation components, the control to share the first event (e.g., invitees of the first event are not able to share the first event with other users when the second set of one or more criteria is satisfied) (e.g., as described above with respect to FIG. 8AA). Selectively displaying a control to share an event when displaying additional information for the event depending on whether a host has enabled sharing allows for the host to have greater control of events and who can invite others to the events, thereby performing an operation when a set of conditions has been met without requiring further user input and/or providing improved feedback to the user.

In some embodiments, the computer system detects, via the one or more input devices, a set of one or more inputs (e.g., a selection input and/or a non-selection input) including an input (e.g., a selection input and/or a non-selection input) (e.g., 805r2) detected while displaying the first preview of the first event. In some embodiments, the input detected while displaying the first preview of the first event is a tap input on a control for accessing a set of one or more additional controls. In some embodiments, the input detected while displaying the first preview of the first event is a tap input on the first preview of the first event. In some embodiments, the control for accessing the set of one or more additional controls is displayed with the information corresponding to the first event (e.g., as described above). In some embodiments, one or more controls of the set of one or more additional controls corresponds to the first event. In some embodiments, a control of the one or more controls is a control for initiating a process to change a name of an attendee used for the first event (e.g., other users viewing information corresponding to the first event are able to view the name). In some embodiments, a control of the one or more controls is a control for adding the first event to a calendar. In some embodiments, a control of the one or more controls is a control for accessing one or more settings of the first event. In some embodiments, in response to detecting the set of one or more inputs, the computer system displays, via the one or more display generation components: an indication (and/an identification) (e.g., 840a) of a first name of a user (e.g., an attendee) that is used for the first event (e.g., the first name is provided to other users that access a guest list of the first event); and a control (e.g., 840b) for changing a name of the user that is used for the first event. In some embodiments, while displaying, via the one or more display generation components, the control for changing a name of the user that is used for the first event, the computer system detects, via the one or more input devices, an input (e.g., a selection input and/or a non-selection input) corresponding to the control for changing a name of the user that is used for the first event. In some embodiments, the input corresponding to the control for changing a name of the user that is used for the first event is a tap input on the control for changing a name of the user that is used for the first event. In some embodiments, in response to detecting the input corresponding to the control for changing a name of the user that is used for the first event, the computer system initiates a process to change the first name to another name different from the first name. In some embodiments, the process includes displaying, via the one or more display generation components, a text box for modifying the first name. In some embodiments, after detecting the input corresponding to the control for changing a name of the user that is used for the first event, the computer system displays, via the one or more display generation components, an indication (and/or an identification) (e.g., as described above with respect to FIG. 8Z) of a second name, different from the first name, of the user that is used for the first event (e.g., the second name, and not the first name, is provided to other users that access a guest list of the first event). Enabling a user to change a name used for an event allows the user to customize their appearance to others, thereby performing an operation when a set of conditions has been met without requiring further user input and/or providing improved feedback to the user.

In some embodiments, while detecting the input corresponding to the request to view the one or more events, the computer system displays, via the one or more display generation components, a preview of (e.g., a representation of and/or a portion of content corresponding to) (e.g., 802b, 802c, and/or 802e) a first current event (e.g., an event that is currently taking place, an upcoming event, an invitation, a calendar invite, a calendar event, an event from an application (e.g., of the computer system), a gathering of one or more invited guests, a social function, and/or a period of one or more planned activities). In some embodiments, the preview of the first current event includes content provided by (e.g., a default and/or preset background corresponding to) a user that created the first current event. In some embodiments, the preview of the first current event includes content added to the first current event when the first current event was created. In some embodiments, the first current event is an event that is configured for a date and/or a time that is in the future. In some embodiments, the first current event is an event that is configured for a date and/or a time that includes a current time. In some embodiments, in response to detecting the input corresponding to the request to view the one or more events, the computer system ceases display of, via the one or more display generation components, the preview of the first current event. Displaying a preview of a current event while detecting an input to view one or more past events allows a user to easily navigate between different types of events (e.g., upcoming and past events), thereby performing an operation when a set of conditions has been met without requiring further user input and/or providing improved feedback to the user.

In some embodiments, the portion of the content is added (and/or submitted) to the shared content (and/or the first event) by an attendee (e.g., a user that has indicated that they will attend and/or has attended the first event and/or not a host of the first event) of the first event (e.g., as described above with respect to FIG. 8AE). In some embodiments, the attendee of the first event is a user of the computer system. In some embodiments, the attendee of the first event is not a user of the computer system. Allowing attendees to add to a shared album that is reflected in a preview of a past event allows previews to serve as reminders of things that occurred rather than merely informative of biographical information, thereby performing an operation when a set of conditions has been met without requiring further user input and/or providing improved feedback to the user.

In some embodiments, the portion of the content is added (and/or submitted) to the shared content (and/or the first event) by a host of the first event (e.g., a user that created and/or is hosting the first event) (e.g., as described above with respect to FIG. 8AE). In some embodiments, the host is a user of the computer system. In some embodiments, the host is not a user of the computer system. Allowing a host to add to a shared album that is reflected in a preview of a past event allows previews to serve as reminders of things that occurred rather than merely informative of biographical information, thereby performing an operation when a set of conditions has been met without requiring further user input and/or providing improved feedback to the user.

In some embodiments, in accordance with a determination that a first set of one or more criteria is satisfied, the first preview of the first event includes an identification (e.g., 602) of an address for the first event. In some embodiments, the address was added to the first event by a host of the first event. In some embodiments, the address was not added to the first event by a host of the first event. In some embodiments, the address was identified by a computer system. In some embodiments, the first set of one or more criteria includes a criterion that is satisfied when the first event includes and/or was created with the identification of the address and/or an identification of a name of a location. In some embodiments, the third set of one or more criteria includes a criterion that is satisfied when a user of the computer system has indicated that they will be going to the first event. In some embodiments, in accordance with a determination that a second set of one or more criteria, different from the first set of one or more criteria, is satisfied, the first preview of the first event does not include an identification of an address for the first event. In some embodiments, the second set of one or more criteria includes a criterion that is satisfied when the first event does not include and/or was not created with an identification of an address and/or an identification of a name of a location. In some embodiments, the second set of one or more criteria includes a criterion that is satisfied when a user of the computer system has indicated that they will not be going to and/or might be going to the first event. A preview of an event selectively including an address for the event allows the preview to better show relevant information to a user, thereby performing an operation when a set of conditions has been met without requiring further user input and/or providing improved feedback to the user.

In some embodiments, in accordance with a determination that a third set of one or more criteria is satisfied, the first preview of the first event includes an identification (e.g., a name, an identifier automatically generated, and/or an identifier created by a host of the first event) (e.g., 602) of a location for the first event different from an address for the first event. In some embodiments, the third set of one or more criteria includes a criterion that is satisfied when the first event includes and/or was created with the identification of the location and/or the identification of the address. In some embodiments, the third set of one or more criteria includes a criterion that is satisfied when a user of the computer system has indicated that they will be going to the first event. In some embodiments, in accordance with a determination that a fourth set of one or more criteria, different from the third set of one or more criteria, is satisfied, the first preview of the first event does not include an identification of a location for the first event. In some embodiments, the fourth set of one or more criteria includes a criterion that is satisfied when the first event does not include and/or was not created with an identification of a location and/or an identification of an address. In some embodiments, the fourth set of one or more criteria includes a criterion that is satisfied when a user of the computer system has indicated that they will not be going to and/or might be going to the first event. A preview of an event selectively including a name of a location for the event allows the preview to better show relevant information to a user, thereby performing an operation when a set of conditions has been met without requiring further user input and/or providing improved feedback to the user.

Note that details of the processes described above with respect to process 900 (e.g., FIG. 9) are also applicable in an analogous manner to other processes described herein. For example, process 1000 optionally includes one or more of the characteristics of the various processes described above with reference to process 900. For example, the first event of process 1000 can be the first event of process 900. For brevity, these details are not repeated herein.

FIG. 10 is a flow diagram illustrating a process (e.g., process 1000) for adding user interface elements to events in accordance with some embodiments. Some operations in process 1000 are, optionally, combined, the orders of some operations are, optionally, changed, and some operations are, optionally, omitted.

As described below, process 1000 provides an intuitive way for adding user interface elements to events. Process 1000 reduces the cognitive burden on a user, thereby creating a more efficient human-machine interface. For battery-operated computing devices, enabling a user to interact with such devices faster and more efficiently conserves power and increases the time between battery charges.

In some embodiments, process 1000 is performed at a computer system (e.g., 600 and/or 610) that is in communication (e.g., wired communication and/or wireless communication) with one or more input devices (e.g., a camera, a depth sensor, a microphone, a hardware input mechanism, a rotatable input mechanism, a heart monitor, a temperature sensor, and/or a touch-sensitive surface) and one or more display generation components (e.g., a display screen, a projector, and/or a touch-sensitive display). In some embodiments, the computer system is a phone, a watch, a tablet, a fitness tracking device, a wearable device, an accessory, a speaker, a light, a head-mounted display (HMD), and/or a personal computing device.

The computer system displays (1002), via the one or more display generation components, a user interface (e.g., a preview, a configuration user interface, and/or a creation user interface) (e.g., 808) of a first event (e.g., an invitation, a calendar invite, a calendar event, an event from an application, a gathering of one or more invited guests, a social function, and/or a period of one or more planned activities), wherein the user interface of the first event includes a control (e.g., an affordance, a button, and/or an add user interface element) (e.g., 808d, 808g, 810, 810a, 810b, 810c, and/or 810d) for adding a user interface element (e.g., an icon, a widget, a control, and/or a window) of a respective application (e.g., a note-taking application, a word-processing application, a document-processing application, a presentation application, an email application, a form processing application such as a PDF viewer and/or editor, a game, a messaging application, a maps application, a fitness application, a health application, a digital payments application, a media application, and/or a social network application) (e.g., to the first event, to the user interface of the first event, and/or to another user interface of the first event different from the user interface of the first event). In some embodiments, the first event is an event that is ongoing (e.g., current) and/or an event that is upcoming (e.g., future). In some embodiments, an event from an application is of the computer system.

The computer system detects (1004), via the one or more input devices, a set of one or more inputs including an input (e.g., a selection input and/or a non-selection input) (e.g., 805d and/or 805f) corresponding to the control for adding the user interface element of the respective application. In some embodiments, in response to detecting an input of the set of one or more inputs, the computer system displays, via the one or more display generation components, a representation of the user interface element of the respective application. In some embodiments, the input corresponding to the control for adding the user interface element of the respective application includes a tap input on the control (e.g., an affordance, a button, and/or an add user interface element) for adding the user interface element of the respective application. In some embodiments, the input corresponding to the control for adding the user interface element of the respective application includes a press and slide input on the control to a location corresponding to a desired location to add the user interface element.

In response to (1006) detecting the set of one or more inputs, in accordance with a determination that the respective application is a first application, the computer system adds (1008) a user interface element (e.g., a preview, an icon, a widget, a control, and/or a window) (e.g., 810c and/or 810a) of the first application to the user interface of the first event. In some embodiments, after adding the user interface element of the first application to the user interface of the first event, the computer system displays, via the one or more display generation components, the user interface of the first event with and/or including the user interface element of the first application. In some embodiments, adding the user interface element of the first application to the user interface of the first event includes displaying, via the one or more display generation components, the user interface of the first event with and/or including the user interface element of the first application.

In response to (1006) detecting the set of one or more inputs, in accordance with a determination that the respective application is a second application different from the first application, the computer system adds (1010) a user interface element (e.g., 810c and/or 810a) of the second application to the user interface of the first event. In some embodiments, after adding the user interface element of the second application to the user interface of the first event, the computer system displays, via the one or more display generation components, the user interface of the first event with and/or including the user interface element of the second application. In some embodiments, adding the user interface element of the second application to the user interface of the first event includes displaying, via the one or more display generation components, the user interface of the first event with and/or including the user interface element of the second application. Adding user interface elements of different applications to a user interface of an event allows the user interface to provide functionality from different applications, thereby reducing the number of inputs needed to perform an operation (e.g., not requiring navigation to those applications), performing an operation when a set of conditions has been met without requiring further user input, and/or providing improved visual feedback to the user.

In some embodiments, after adding the user interface element of the first application to the user interface of the first event (e.g., while or without displaying the user interface of the first event with the user interface element of the first application), the computer system detects, via the one or more input devices, an input (e.g., a selection input and/or a non-selection input) (e.g., 805d and/or 805f) corresponding to a request to add a user interface element (e.g., a preview, an icon, a widget, a control, and/or a window) of a third application (e.g., the second application or another application different from the second application) different from the first application. In some embodiments, the input corresponding to the request to add the user interface element of the third application is a tap input on a representation of the user interface element of the third application. In some embodiments, the input corresponding to the request to add the user interface element of the third application is a tap input on a done button. In some embodiments, the input corresponding to the request to add the user interface element of the third application is a tap input on a configuration option for the user interface element of the third application. In some embodiments, in response to (and/or after) detecting the input corresponding to the request to add the user interface element of the third application, the computer system adds the user interface element (e.g., 810c and/or 810a) of the third application to the user interface of the first event such that the user interface of the first event includes the user interface element of the first application and the user interface element of the third application. In some embodiments, after adding the user interface element of the third application to the user interface of the first event, the computer system displays, via the one or more display generation components, the user interface of the first event with and/or including the user interface element of the third application. In some embodiments, adding the user interface element of the third application to the user interface of the first event includes displaying, via the one or more display generation components, the user interface of the first event with and/or including the user interface element of the third application. Adding user interface elements of multiple different applications to a user interface of an event allows the user interface to provide functionality from multiple applications, thereby reducing the number of inputs needed to perform an operation (e.g., not requiring navigation to those applications) and/or providing improved visual feedback to the user.

In some embodiments, after adding the user interface element of the first application to the user interface of the first event (e.g., while or without displaying the user interface of the first event with the user interface element of the first application), the computer system detects, via the one or more input devices, an input (e.g., a selection input and/or a non-selection input) corresponding to a request to display the user interface of the first event. In some embodiments, in response to detecting the input corresponding to the request to display the user interface of the first event, the computer system displays, via the one or more display generation components, the user interface of the first event (1) with the user interface element of the first application and (2) without the control for adding the user interface element of the respective application. In some embodiments, in response to detecting the input corresponding to the request to display the user interface of the first event, the computer system displays, via the one or more display generation components, the user interface of the first event (1) with the user interface element of the first application, (2) with a control for adding user interface elements of applications, and (3) without the control for adding the user interface element of the respective application. A user interface of an event including a control for adding a user interface element of an application until the user interface element is added allows the user interface to remove controls that have been used and/or are no longer needed, thereby reducing the number of inputs needed to perform an operation, performing an operation when a set of conditions has been met without requiring further user input, and/or providing improved visual feedback to the user.

In some embodiments, after adding the user interface element of the first application to the user interface of the first event (e.g., while or without displaying the user interface of the first event with the user interface element of the first application), the computer system detects, via the one or more input devices, an input (e.g., a selection input and/or a non-selection input) corresponding to a request to display the user interface of the first event. In some embodiments, the input is a tap input on a representation of the first event. In some embodiments, in response to detecting the input corresponding to the request to display the user interface of the first event, the computer system displays, via the one or more display generation components, the user interface of the first event (1) with a control for adding user interface elements of applications and (2) without the control for adding the user interface element of the respective application. Displaying one control for adding a specific user interface element (e.g., the control for adding the user interface element of the respective application) and another control for initiating a process for selecting a user interface element of an application from multiple user interface elements of one or more applications (e.g., the control for adding user interface elements of applications) allows the computer system to surface controls for adding certain user interface elements while still allowing other user interface elements to be added, thereby reducing the number of inputs needed to perform an operation, performing an operation when a set of conditions has been met without requiring further user input, and/or providing improved visual feedback to the user.

In some embodiments, the control for adding user interface elements of applications is included in the user interface of the first event that includes the control for adding the user interface element of the respective application. Displaying one control for adding a specific user interface element (e.g., the control for adding the user interface element of the respective application) and another control for initiating a process for selecting a user interface element of an application from multiple user interface elements of one or more applications (e.g., the control for adding user interface elements of applications) allows the computer system to surface controls for adding certain user interface elements while still allowing other user interface elements to be added, thereby reducing the number of inputs needed to perform an operation, performing an operation when a set of conditions has been met without requiring further user input, and/or providing improved visual feedback to the user.

In some embodiments, the first application is a media application (e.g., including a shared album for the first event) (e.g., 810b). In some embodiments, the media application is a photo, image, and/or video application. In some embodiments, the first application is a shopping application (e.g., an online shopping application that is used by customers to purchase goods and/or services from one or more businesses), a commerce application (e.g., an application that is used to send and/or receive value, such as money), a fundraiser application (e.g., an application that is used to contribute and/or send value, such as money), a food delivery application, a music application, or a navigation application. Enabling a user interface for an event to add a user interface element from a media application allows a host of the event to customize the user interface for attendees of the event with media-related functionality, thereby performing an operation when a set of conditions has been met without requiring further user input and/or providing improved visual feedback to the user.

In some embodiments, the second application is a weather application (e.g., provides a past, current, and/or future state of weather in an area) (e.g., 810a). Enabling a user interface for an event to add a user interface element from a weather application allows a host of the event to customize the user interface for attendees of the event with weather-related functionality (e.g., a predicted and/or current weather for the event), thereby performing an operation when a set of conditions has been met without requiring further user input and/or providing improved visual feedback to the user.

In some embodiments, the user interface of the first event with the control for adding the user interface element of the respective application includes a user interface element (e.g., an icon, a widget, a control, and/or a window) (e.g., 808f) of a third application (e.g., a navigation application or a weather application) different from the first application and the second application. In some embodiments, the user interface element of the third application is included in the user interface of the first event without a host of the first event adding the user interface element of the third application to the user interface of the first event (e.g., the user interface element of the third application is automatically added to the user interface of the first event based on information and/or data added to the first event by a host of the first event, such as the host adding an address and/or a day and/or a time of the first event). In some embodiments, the user interface of the first event corresponds to (and/or is from) a fourth application different from the first application, the second application, and the third application. Automatically including user interface elements of particular applications to a user interface of an event allows the user interface to automatically include functionality without requiring a host of the event to add such functionality, thereby reducing the number of inputs needed to perform an operation, performing an operation when a set of conditions has been met without requiring further user input, and/or providing improved visual feedback to the user.

In some embodiments, the user interface of the first event with the control for adding the user interface element of the respective application includes a control (e.g., 810d) for adding a link (e.g., to a website and/or a screen of an application) to the user interface of the first event. In some embodiments, while displaying the control for adding a link to the user interface of the first event, the computer system detects, via the one or more input devices, an input (e.g., a selection input and/or a non-selection input) corresponding to the control for adding a link to the user interface of the first event. In some embodiments, the input corresponding to the control for adding a link to the user interface of the first event includes a tap on the control for adding a link to the user interface of the first event. In some embodiments, in response to detecting the input corresponding to the control for adding a link to the user interface of the first event, the computer system initiates a process to add a link to the user interface of the first event (e.g., to provide a link and/or identify a location within the user interface to include the link). In some embodiments, in response to detecting an input corresponding to the control for adding user interface elements of applications, the computer system displays, via the one or more display generation components, the control for adding a link to the user interface of the first event. Including a control for adding a link to a user interface of an event in addition to a control for adding a user interface element of an application allows the user interface to be configured to include both links and user interface elements of applications, thereby performing an operation when a set of conditions has been met without requiring further user input and/or providing improved visual feedback to the user.

In some embodiments, the input corresponding to the control for adding the user interface element of the respective application is a first input. In some embodiments, the user interface of the first event corresponds to a fourth application (e.g., an events application and/or a calendar application) different from the first application and the second application. In some embodiments, in response to detecting a second input (e.g., the first input or another input different from the first input) of the set of one or more inputs, the computer system initiates a process to grant the fourth application access to the first application (and/or content of the first application). In some embodiments, the process is provided by an operating system of the computer system. In some embodiments, the process is provided by the first application and/or the fourth application. In some embodiments, different user interface elements and/or different applications are configured to require or to not require such access to be granted. For example, some user interface elements can be added without requiring access to an application be granted, such as because the user interface elements correspond to applications that the application already has access to and/or do not require personal information and/or information specific to an application. Initiating a process to grant an application access to another application when adding functionality from the other applications ensures that data from different applications is not accessed without user permission, thereby increasing security, performing an operation when a set of conditions has been met without requiring further user input, and/or providing improved visual feedback to the user.

In some embodiments, the user interface element of the first application is a widget (e.g., 810c and/or 810a). In some embodiments, the user interface element of the second application is a widget. In some embodiments, the user interface element of the second application is not a widget. A user interface element added to a user interface of an event being a widget allows the user interface to include dynamic information that is updated over time from different applications, thereby performing an operation when a set of conditions has been met without requiring further user input and/or providing improved visual feedback to the user.

Note that details of the processes described above with respect to process 1000 (e.g., FIG. 10) are also applicable in an analogous manner to other processes described herein. For example, process 1100 optionally includes one or more of the characteristics of the various processes described above with reference to process 1000. For example, the event of process 1100 can be the first event of process 1000. For brevity, these details are not repeated herein.

FIG. 11 is a flow diagram illustrating a process (e.g., process 1100) for sharing an event in accordance with some embodiments. Some operations in process 1100 are, optionally, combined, the orders of some operations are, optionally, changed, and some operations are, optionally, omitted.

As described below, process 1100 provides an intuitive way for sharing an event. Process 1100 reduces the cognitive burden on a user, thereby creating a more efficient human-machine interface. For battery-operated computing devices, enabling a user to interact with such devices faster and more efficiently conserves power and increases the time between battery charges.

In some embodiments, process 1100 is performed at a first computer system (e.g., 600 and/or 610) that is in communication (e.g., wired communication and/or wireless communication) with one or more input devices (e.g., a camera, a depth sensor, a microphone, a hardware input mechanism, a rotatable input mechanism, a heart monitor, a temperature sensor, and/or a touch-sensitive surface) and one or more display generation components (e.g., a display screen, a projector, and/or a touch-sensitive display). In some embodiments, the first computer system is a phone, a watch, a tablet, a fitness tracking device, a wearable device, an accessory, a speaker, a light, a head-mounted display (HMD), and/or a personal computing device.

The first computer system receives (1102), from a second computer system (e.g., via a peer-to-peer connection) different from the first computer system, an invitation to an event (e.g., an invitation, a calendar invite, a calendar event, an event from an application, a gathering of one or more invited guests, a social function, and/or a period of one or more planned activities) (e.g., as described above with respect to FIGS. 6A-6F and/or 8P-8Q). In some embodiments, the second computer system is a phone, a watch, a tablet, a fitness tracking device, a wearable device, an accessory, a speaker, a light, a head-mounted display (HMD), and/or a personal computing device. In some embodiments, the second computer system is in communication with one or more input/output devices, such as one or more cameras, speakers, microphones, sensors, and/or display components. In some embodiments, the first computer system is the same type of computer system as the first computer system. In some embodiments, the event is from an application of the second computer system. In some embodiments, the event is an event that is ongoing (e.g., current) and/or an event that is upcoming (e.g., future).

After receiving the invitation to the event (and/or while displaying, via the one or more display generation components, an indication and/or a preview of the event and/or the invitation to the event), the first computer system detects (1104), via the one or more input devices, an input (e.g., a selection input and/or a non-selection input) (e.g., 805q) corresponding to a request to attend the event (and/or a request to accept the invitation to the event). In some embodiments, a selection input includes a tap input, a verbal input, an audible command, a gaze input, an air gesture, a mouse click, and/or a submission of a user-interface element and/or a physical hardware element. In some embodiments, a non-selection input includes a verbal input, an audible request, an audible command, an audible statement, a swipe input, a hold-and-drag input, a gaze input, an air gesture, and/or a mouse movement. In some embodiments, the input corresponding to the request to attend the event includes a tap input on a control for accepting the invitation to the event. In some embodiments, the input corresponding to the request to attend the event includes an audible command to accept the invitation to the event (“e.g., I am going”).

After (and/or in response to) detecting the input corresponding to the request to attend the event (and/or while displaying, via the one or more display generation components, an indication and/or a preview of the event and/or without displaying, via the one or more display generation components, a preview of the event), the first computer system detects (1106), via the one or more input devices, an input (e.g., a selection input and/or a non-selection input) (e.g., 805x) corresponding to a request to view information corresponding to the event. In some embodiments, the input corresponding to the request to view information corresponding to the event is different from the input corresponding to the request to attend the event. In some embodiments, the input corresponding to the request to view information corresponding to the event includes a tap input on a button to view information corresponding to the event. In some embodiments, the input corresponding to the request to view information corresponding to the event includes an air gesture command to view information corresponding to the event (e.g., a swipe movement of the hand).

In response to (1108) detecting the input corresponding to the request to view information corresponding to the event, in accordance with a determination that a first set of one or more criteria is satisfied, the first computer system displays (1110), via the one or more display generation components, a control (e.g., an affordance, a button, and/or an add user interface element) (e.g., 636j and/or 828) to share the event with another computer system (e.g., a guest that was not previously invited) (e.g., different from the first computer system and the second computer system). In some embodiments, the first set of one or more criteria includes a criterion that is satisfied when the invitation to the event is an open invitation (e.g., a user can be invited by a user invited to the event and/or a user can be invited to the event regardless of if the user was invited by the host of the event). In some embodiments, a user is a subject, a person, an animal, another computer system different from the first computer system, a device, and/or an object.

In response to (1108) detecting the input corresponding to the request to view information corresponding to the event, in accordance with a determination that the first set of one or more criteria is not satisfied, the first computer system forgoes (1112) display of, via the one or more display generation components, the control to share the event with another computer system. Selectively displaying a control to share an event with another computer system allows a host of the event to control how their events are shared, thereby performing an operation when a set of conditions has been met without requiring further user input and/or providing improved visual feedback to the user.

In some embodiments, the control to share the event with another computer system is a first control. In some embodiments, before detecting the input corresponding to the request to attend the event and while displaying, via the one or more display generation components, a preview (e.g., 636) of the event, in accordance with a determination that a second set of one or more criteria (e.g., the first set of one or more criteria or another set of one or more criteria different from the first set of one or more criteria) is satisfied, the first computer system displays, via the one or more display generation components, a second control (e.g., an affordance, a button, and/or an add user interface element) (e.g., 636j and/or 828) to share the event with another computer system (e.g., a guest that was not previously invited) (e.g., different from the first computer system and the second computer system). In some embodiments, the second control is the first control. In some embodiments, the second control is different from the first control. In some embodiments, the second set of one or more criteria includes a criterion that is satisfied when the invitation to the event is configured to be able to be shared. In some embodiments, before detecting the input corresponding to the request to attend the event and while displaying, via the one or more display generation components, the preview of the event, in accordance with a determination that the second set of one or more criteria is not satisfied, the first computer system forgoes display of, via the one or more display generation components, the second control to share the event with another computer system. Selectively displaying a control to share an event with another computer system before accepting an invitation to the event allows a host of the event to control how their events are shared, thereby performing an operation when a set of conditions has been met without requiring further user input and/or providing improved visual feedback to the user.

In some embodiments, the preview of the event includes a control (e.g., a button and/or user interface element) (e.g., 636f) to indicate that a user (e.g., of the first computer system) will attend the event. In some embodiments, the input corresponding to the request to attend the event is an input corresponding to the control to indicate that the user will attend the event. Displaying a control to indicate that a user will attend an event while selectively displaying a control to share the event with another computer system allows the first computer system to use a single user interface for both responding to an invitation and sharing the invitation to others, thereby performing an operation when a set of conditions has been met without requiring further user input and/or providing improved visual feedback to the user.

In some embodiments, the preview of the event includes a list of one or more users that has indicated that they will attend the event (e.g., 636g and/or 838). Displaying a list of one or more users that has indicated that they will attend an event while selectively displaying a control to share the event with another computer system enables a user to see who is already going to the event to decide whether to share the event to others, thereby performing an operation when a set of conditions has been met without requiring further user input and/or providing improved visual feedback to the user.

In some embodiments, the preview of the event includes a list of one or more users that has indicated that they will not attend the event (e.g., 838). In some embodiments, the preview of the event includes a list of one or more users that have indicated that they might attend the event. Displaying a list of one or more users that has indicated that they will not attend an event while selectively displaying a control to share the event with another computer system enables a user to see who is not going to the event to decide whether to share the event to others, thereby performing an operation when a set of conditions has been met without requiring further user input and/or providing improved visual feedback to the user.

In some embodiments, the preview of the event includes a list of one or more users that has not responded to an invitation to the event (e.g., 838). Displaying a list of one or more users that has not responded to an invitation to an event while selectively displaying a control to share the event with another computer system enables a user to see who has been invited to the event to decide whether to share the event to others, thereby performing an operation when a set of conditions has been met without requiring further user input and/or providing improved visual feedback to the user.

In some embodiments, before receiving the invitation to the event, the first computer system detects, via the one or more input devices, an input (e.g. 805p) corresponding to a link (e.g., a uniform resource locator) (e.g., 836a) corresponding to the event, wherein the invitation to the event is received as a result of the input corresponding to the link. In some embodiments, the link is to a webpage. In some embodiments, the link is to a user interface of an application. In some embodiments, in response to detecting the input corresponding to the link, the first computer system displays, via the one or more display generation components, a webpage in a browser. In some embodiments, the webpage corresponds to the event. In some embodiments, in response to detecting the input corresponding to the link, the first computer system displays, via the one or more display generation components, a user interface of an application (e.g., an events application and/or a calendar application). In some embodiments, the user interface corresponds to the event. In some embodiments, the invitation to the event is a link (e.g., as described above). In some embodiments, after and/or in response to receiving the invitation to the event, the first computer system displays, via the one or more display generation components, a user interface including the link. In some embodiments, in response to detecting an input corresponding to the link, the first computer system displays, via the one or more display generation components, a user interface corresponding to the event. In some embodiments, the user interface corresponding to the event includes a control to request to attend the event. In some embodiments, an input corresponding to the control to request to attend the event is the input corresponding to the request to attend the event. Providing invitations to events using links and selectively allowing such invitations to be shared allows easy sharing of events while being able to restrict how those events are further shared outside of the links, thereby performing an operation when a set of conditions has been met without requiring further user input and/or providing improved visual feedback to the user.

In some embodiments, in response to detecting the input corresponding to the request to view the information corresponding to the event, the first computer system displays, via the one or more display generation components, the information (e.g., 636) corresponding to the event. Displaying information corresponding to an event with a control to share the event allows a user to identify what they are able to share with the information, thereby providing improved visual feedback to the user.

In some embodiments, the information corresponding to the event includes an indication that a user of the first computer system is attending the event (e.g., as a result of the input corresponding to the request to attend the event) (e.g., 636f). Including an indication that a user of the first computer system is attending an event with a control to share the event allows the user to identify that they have indicated they will be attending the event for which they are able to share, thereby providing improved visual feedback to the user.

In some embodiments, in response to detecting the input corresponding to the request to view information corresponding to the event, the first computer system displays, via the one or more display generation components, a control to indicate that a user of the first computer system will not be attending the event (e.g., 636d). In some embodiments, while displaying the control to indicate that the user of the first computer system will not be attending the event, the first computer system detects, via the one or more input devices, an input (e.g., a selection input and/or a non-selection input) corresponding to the control to indicate that the user of the first computer system will not be attending the event. In some embodiments, the input corresponding to the control to indicate that the user of the first computer system will not be attending the event is a tap input on the control to indicate that the user of the first computer system will not be attending the event. In some embodiments, in response to detecting the input corresponding to the control to indicate that the user of the first computer system will not be attending the event, the first computer system displays, via the one or more display generation components, an indication that the user of the first computer system will not be attending the event. In some embodiments, while detecting the input corresponding to the control to indicate that the user of the first computer system will not be attending the event, the first computer system displays (and/or maintains display of), via the one or more display generation components, first information corresponding to the event. In some embodiments, in response to detecting the input corresponding to the control to indicate that the user of the first computer system will not be attending the event, the first computer system ceases display of, via the one or more display generation components, the first information. In some embodiments, in response to detecting the input corresponding to the control to indicate that the user of the computer system will not be attending the event, the first computer system displays, via the one or more display generation components, second information (e.g., without displaying the first information) different from the first information. Displaying a control to indicate that a user of the first computer system will not be attending an event with information corresponding to the event allows the user to identify details about the event when deciding whether to indicate that the user will not be attending the event, thereby providing improved visual feedback to the user.

In some embodiments, the information corresponding to the event includes an address of the event (e.g., 602). In some embodiments, a host of the event provided the address of the event. In some embodiments, a host of the event did not provide the address of the event and, instead, the address of the event is automatically determined based on a name of a location of the event. Displaying an address of an event with a control to share the event allows a user to identify where the event will be when choosing whether to share the event, thereby providing improved visual feedback to the user.

In some embodiments, the information corresponding to the event includes a name of a location of the event (e.g., 602). In some embodiments, the name of the location of the event is different from an address of the event. In some embodiments, a host of the event provided the name of the location of the event. In some embodiments, a host of the event did not provide the name of the location of the event and, instead, the name of the location of the event is automatically determined based on an address of the event. Displaying a name of a location of an event with a control to share the event allows a user to identify where the event will be when choosing whether to share the event, thereby providing improved visual feedback to the user.

In some embodiments, the information corresponding to the event includes a time of the event (e.g., a start and/or an end time) (e.g., 602). In some embodiments, a host of the event provided the time of the event. Displaying a time of an event with a control to share the event allows a user to identify when the event will occur when choosing whether to share the event, thereby providing improved visual feedback to the user.

In some embodiments, the information corresponding to the event includes a title (e.g., a name) of the event (e.g., 602). In some embodiments, a host of the event provided the title of the event. In some embodiments, a host of the event did not provide the title of the event and, instead, the title of the event was automatically generated based on information provided by the host. Displaying a title of an event with a control to share the event allows a user to identify which event that they are choosing whether to share, thereby providing improved visual feedback to the user.

In some embodiments, the information corresponding to the event includes a description of the event (e.g., 818). In some embodiments, a host of the event provided the description of the event. In some embodiments, a host of the event did not provide the description of the event and, instead, the description of the event was automatically generated based on information provided by the host, a location of the event, and/or a time of the event. Displaying a description of an event with a control to share the event allows a user to identify which event that they are choosing whether to share, thereby providing improved visual feedback to the user.

In some embodiments, the information corresponding to the event includes a list of one or more users that have indicated that they will attend the event (e.g., 838). Displaying a list of one or more users that has indicated that they will attend an event while selectively displaying a control to share the event with another computer system enables a user to see who is already going to the event to decide whether to share the event to others, thereby performing an operation when a set of conditions has been met without requiring further user input and/or providing improved visual feedback to the user.

In some embodiments, the information corresponding to the event includes a list of one or more users that have indicated that they will not attend the event (e.g., 838). In some embodiments, the preview of the event includes a list of one or more users that have indicated that they might attend the event. Displaying a list of one or more users that has indicated that they will not attend an event while selectively displaying a control to share the event with another computer system enables a user to see who is not going to the event to decide whether to share the event to others, thereby performing an operation when a set of conditions has been met without requiring further user input and/or providing improved visual feedback to the user.

In some embodiments, the information corresponding to the event includes a list of one or more users that have not responded to an invitation to the event (e.g., 838). Displaying a list of one or more users that has not responded to an invitation to an event while selectively displaying a control to share the event with another computer system enables a user to see who has been invited to the event to decide whether to share the event to others, thereby performing an operation when a set of conditions has been met without requiring further user input and/or providing improved visual feedback to the user.

In some embodiments, in response to detecting the input corresponding to the request to view information corresponding to the event, in accordance with a determination that an attendee of the event has added media to the event, the first computer system displays, via the one or more display generation components, a representation (e.g., 612) of at least a portion of the media. In some embodiments, in response to detecting the input corresponding to the request to view information corresponding to the event and in accordance with the determination that the attendee of the event has added the media to the event, the first computer system displays, via the one or more display generation components, the media, a media item of the media, and/or a representation of a media item of the media. In some embodiments, in response to detecting the input corresponding to the request to view information corresponding to the event, in accordance with a determination that an attendee of the event has not added media to the event, the first computer system forgoes display of, via the one or more display generation components, a representation of media (and/or the representation of the portion of the media). Displaying media while selectively displaying a control to share the event with another computer system enables a user to see media added to the event when deciding whether to share the event to others, thereby performing an operation when a set of conditions has been met without requiring further user input and/or providing improved visual feedback to the user.

In some embodiments, while displaying the control (e.g., 636j) to share the event with another computer system, the first computer system detects, via the one or more input devices, an input (e.g., a selection input and/or a non-selection input) (e.g., 636j) corresponding to the control to share the event with another computer system. In some embodiments, the input corresponding to the control to share the event with another computer system is a tap input on the control to share the event with another computer system. In some embodiments, after (and/or in response to) detecting the input corresponding to the control to share the event with another computer system, the first computer system displays, via the one or more display generation components, a list (e.g., 842) of one or more contacts (e.g., of the first computer system). In some embodiments, each contact in the list of one or more contacts is associated with a communication application (e.g., messaging application, an emailing application, and/or a calling application). In some embodiments, each contact in the list of one or more contacts is associated with one or more communication applications (e.g., messaging application, an emailing application, and/or a calling application), such as a first contact is associated with a single communication application while a second contact, different from the first contact, is associated with multiple communication applications. In some embodiments, in response to detecting the input corresponding to the control to share the event with another computer system, the first computer system displays, via the one or more display generation components, a list of one or more communication applications (e.g., messaging application, an emailing application, and/or a calling application). Displaying a set of one or more contacts after detecting an input corresponding to a control to share an event with another computer system allows the first computer system to show who the event can be shared with without requiring contact information to be memorized, thereby performing an operation when a set of conditions has been met without requiring further user input and/or providing improved visual feedback to the user.

In some embodiments, the list of one or more contacts consists of one or more contacts that has not already been invited to the event (e.g., as described above with respect to FIG. 8T). Only displaying contacts that have not already been invited to an event allows the first computer system to reduce a number of contacts being displayed, thereby performing an operation when a set of conditions has been met without requiring further user input and/or providing improved visual feedback to the user.

In some embodiments, the list of one or more contacts includes a contact that has already been invited to the event (e.g., as described above with respect to FIG. 8T). Displaying a set of one or more contacts including a contact that has already been invited to an event after detecting an input corresponding to a control to share the event with another computer system allows the first computer system to show who the event can be shared with without requiring contact information to be memorized, thereby performing an operation when a set of conditions has been met without requiring further user input and/or providing improved visual feedback to the user.

In some embodiments, the list of one or more contacts includes an indication that the contact has already been invited to the event (e.g., as described above with respect to FIG. 8T). Displaying contacts that have already been invited to an event with an indication that a contact has already been invited to the event allows the first computer system to reduce unneeded invitations being sent, thereby performing an operation when a set of conditions has been met without requiring further user input and/or providing improved visual feedback to the user.

In some embodiments, while displaying the list of one or more contacts, the first computer system detects, via the one or more inputs devices, an input (e.g., a selection input and/or a non-selection input) (e.g., 805t) corresponding to a respective contact in the list of one or more contacts. In some embodiments, the input corresponding to the respective contact in the list of one or more contacts is a tap input on the respective contact in the list of one or more contacts. In some embodiments, after (and/or in response to) detecting the input corresponding to the respective contact in the list of one or more contacts, in accordance with a determination that the respective contact is a first contact (e.g., 842a), the first computer system sends (e.g., via an application corresponding to the event, such as an events application and/or a calendar application, or a communication application (e.g., different from the application corresponding to the event), such as a messaging application, an emailing application, and/or a calling application), to the first contact, an invitation to (and/or for) the event (e.g., as described above with respect to FIG. 8V). In some embodiments, in response to and/or after sending, to the first contact, the invitation to the event, the first computer system displays, via the one or more display generation components, an indication that the invitation to the event was sent to the first contact. In some embodiments, after detecting the input corresponding to the respective contact in the list of one or more contacts, in accordance with a determination that the respective contact is a second contact (e.g., 842a) different from the first contact, the first computer system sends (e.g., via the application corresponding to the event or a communication application (e.g., different from the application corresponding to the event), such as a messaging application, an emailing application, and/or a calling application), to the second contact, an invitation to (and/or for) the event (e.g., without sending an invitation to the event to the first contact) (e.g., as described above with respect to FIG. 8V). In some embodiments, in response to and/or after sending, to the second contact, the invitation to the event, the first computer system displays, via the one or more display generation components, an indication that the invitation to the event was sent to the second contact. Sending an invitation to an event to a contact in response to detecting an input corresponding to the contact allows the first computer system to know who to send the invitation to, thereby performing an operation when a set of conditions has been met without requiring further user input and/or providing improved feedback to the user.

In some embodiments, after (and/or in response to) detecting the input corresponding to the respective contact in the list of one or more contacts, the first computer system displays, via the one or more display generation components, a draft (e.g., 846c) of a message to the respective contact. In some embodiments, the draft of the message is addressed to the respective contact based on detecting the input corresponding to the respective contact in the list of one or more contacts. Displaying a draft of a message to a contact after detecting an input corresponding to the contact allows the first computer system to initiate a process to send an invitation to the event to the contact without requiring a user to navigate one or more user interfaces and/or provide input to make the message, thereby performing an operation when a set of conditions has been met without requiring further user input and/or providing improved feedback to the user.

In some embodiments, the draft of the message includes auto-generated content (e.g., 846c) corresponding to the event. In some embodiments, the auto-generated content includes a personalized message to the respective contact. In some embodiments, the auto-generated content includes a preview of the event. A draft of a message including auto-generated content allows the first computer system to automatically prepare the draft without requiring a user to provide input to make the message, thereby performing an operation when a set of conditions has been met without requiring further user input and/or providing improved feedback to the user.

In some embodiments, after detecting the input corresponding to the request to attend the event and while displaying media (e.g., an image, a video, a song, and/or a movie), the first computer system detects, via the one or more input devices, an input (e.g., a selection input and/or a non-selection input) corresponding to a request to share the media. In some embodiments, the input corresponding to the request to share the media includes a tap input on a share button. In some embodiments, after (and/or in response to) detecting the request to share the media, the first computer system displays, via the one or more display generation components, a control to send the media to the event. In some embodiments, while displaying the control to send the media to the event, the first computer system detects, via the one or more input devices, an input (e.g., a selection input and/or a non-selection input) corresponding to the control to send the media to the event. In some embodiments, the input corresponding to the control to send the media to the event is a tap input on the control to send the media to the event. In some embodiments, in response to detecting the input corresponding to the control to send the media to the event, the first computer system sends the media to the event such that other attendees and/or invitees of the event are able to view the media. Displaying a control to send media to an event allows the first computer system to integrate media sharing with event sharing such that the two features can be combined in a way that allows easier access to the media when viewing information about an event, thereby performing an operation when a set of conditions has been met without requiring further user input and/or providing improved feedback to the user.

In some embodiments, after sending the media to the event and in response to detecting the input corresponding to the request to view information corresponding to the event, the first computer system displays, via the one or more display generation components, an indication (and/or a representation) of the media. In some embodiments, after sending the media to the event and in response to detecting the input corresponding to the request to view information corresponding to the event, the first computer system displays, via the one or more display generation components, the media. Displaying media that was shared to an event while selectively display a control to share the event with another computer system enables a user to see media added to the event when deciding whether to share the event to others, thereby performing an operation when a set of conditions has been met without requiring further user input and/or providing improved visual feedback to the user.

In some embodiments, the first set of one or more criteria includes a criterion that is satisfied when a user of the first computer system is a first user (e.g., a user that has been assigned an ability to share the event with another computer system by a host of the event). In some embodiments, the criterion is not satisfied when the user of the first computer system is a second user (e.g., a user that has not been assigned an ability to share the event with another computer system by a host of the event) different from the first user. In some embodiments, the first set of one or more criteria includes a criterion that is satisfied based on a user of the first computer system. Selectively displaying a control to share an event with another computer system based on a user of the first computer system allows a host of the event to control how the event is shared, thereby performing an operation when a set of conditions has been met without requiring further user input and/or providing improved visual feedback to the user.

In some embodiments, the first set of one or more criteria includes a criterion that is satisfied when the invitation is a first type of invitation (e.g., a public invitation and/or an invitation that has been configured to be able to share with other users). In some embodiments, the criterion is not satisfied when the invitation is a second type of invitation (e.g., a private and/or personal invitation and/or an invitation that has not been configured to be able to share with other users) different from the first type of invitation. In some embodiments, the first set of one or more criteria includes a criterion that is satisfied based on a type of the first computer system. Selectively displaying a control to share an event with another computer system based on a type of an invitation to the event allows a host of the event to control how the event is shared, thereby performing an operation when a set of conditions has been met without requiring further user input and/or providing improved visual feedback to the user.

In some embodiments, the first set of one or more criteria includes a criterion that is satisfied when the event is a first type of event (e.g., a public event and/or an event that has been configured to be able to be shared with other users). In some embodiments, the criterion is not satisfied when the event is a second type of event (e.g., a private and/or personal event and/or an event that has not been configured to be able to be shared with other users) different from the first type of event. In some embodiments, the first set of one or more criteria includes a criterion that is satisfied based on a type of the event. Selectively displaying a control to share an event with another computer system based on a type of the event allows a host of the event to control how the event is shared, thereby performing an operation when a set of conditions has been met without requiring further user input and/or providing improved visual feedback to the user.

In some embodiments, the first set of one or more criteria includes a criterion that is satisfied when a current time is a threshold time (e.g., 1 hour to 5 days) before a time of the event. In some embodiments, the criterion is not satisfied when the event is the current time is not the threshold time (e.g., 1 hour to 5 days) before the time of the event. In some embodiments, the first set of one or more criteria includes a criterion that is satisfied based on a current time. Selectively displaying a control to share an event with another computer system based on a current time allows a host of the event to control how the event is shared, thereby performing an operation when a set of conditions has been met without requiring further user input and/or providing improved visual feedback to the user.

Note that details of the processes described above with respect to process 1100 (e.g., FIG. 11) are also applicable in an analogous manner to the processes described herein. For example, process 700 optionally includes one or more of the characteristics of the various processes described herein with reference to process 1100. For example, the event of process 700 can be the event of process 1000. For brevity, these details are not repeated herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to improve managing events. The present disclosure contemplates that in some instances, this gathered data may include personal information data that uniquely identifies or can be used to contact or locate a specific person. Such personal information data can include demographic data, location-based data, telephone numbers, email addresses, social media identifiers, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used for managing events. Accordingly, use of such personal information data enables users to have a computer system perform operations for managing events. Further, other uses for personal information data that benefit the user are also contemplated by the present disclosure. For instance, calendar data may be used to provide insights into a attendee's availability, or may be used as feedback to determine if a recipient can attend or not attend the event.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of some services, the present technology can be configured to allow users to select to “opt in” or “opt out” of participation in the collection of personal information data during registration for services or anytime thereafter. In another example, users can select not to provide certain data for some services. In yet another example, users can select to limit the length of time data is maintained or entirely prohibit the development of user profile. In addition to providing “opt in” and “opt out” options, the present disclosure contemplates providing notifications relating to the access or use of personal information. For instance, a user may be notified upon downloading an application that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other processes.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to some services, or publicly available information.

What is claimed is:

1. A method, comprising:
at a first computer system that is in communication with one or more input devices and one or more display generation components:
receiving, from a second computer system different from the first computer system, an invitation to an event;
after receiving the invitation to the event, detecting, via the one or more input devices, an input corresponding to a request to attend the event;
after detecting the input corresponding to the request to attend the event, detecting, via the one or more input devices, an input corresponding to a request to view information corresponding to the event; and
in response to detecting the input corresponding to the request to view information corresponding to the event:
in accordance with a determination that a first set of one or more criteria is satisfied, displaying, via the one or more display generation components, a control to share the event with another computer system; and
in accordance with a determination that the first set of one or more criteria is not satisfied, forgoing display of, via the one or more display generation components, the control to share the event with another computer system.

2. The method of claim 1, wherein the control to share the event with another computer system is a first control, the method further comprising:
before detecting the input corresponding to the request to attend the event and while displaying, via the one or more display generation components, a preview of the event:
in accordance with a determination that a second set of one or more criteria is satisfied, displaying, via the one or more display generation components, a second control to share the event with another computer system; and
in accordance with a determination that the second set of one or more criteria is not satisfied, forgoing display of, via the one or more display generation components, the second control to share the event with another computer system.

3. The method of claim 2, wherein the preview of the event includes a control to indicate that a user will attend the event, and wherein the input corresponding to the request to attend the event is an input corresponding to the control to indicate that the user will attend the event.

4. The method of claim 2, wherein the preview of the event includes a list of one or more users that has indicated that they will attend the event.

5. The method of claim 2, wherein the preview of the event includes a list of one or more users that has indicated that they will not attend the event.

6. The method of claim 2, wherein the preview of the event includes a list of one or more users that has not responded to an invitation to the event.

7. The method of claim 1, further comprising:
before receiving the invitation to the event, detecting, via the one or more input devices, an input corresponding to a link corresponding to the event, wherein the invitation to the event is received as a result of the input corresponding to the link.

8. The method of claim 1, further comprising:
in response to detecting the input corresponding to the request to view the information corresponding to the event, displaying, via the one or more display generation components, the information corresponding to the event.

9. The method of claim 8, wherein the information corresponding to the event includes an indication that a user of the first computer system is attending the event.

10. The method of claim 8, further comprising:
in response to detecting the input corresponding to the request to view information corresponding to the event, displaying, via the one or more display generation components, a control to indicate that a user of the first computer system will not be attending the event.

11. The method of claim 8, wherein the information corresponding to the event includes an address of the event.

12. The method of claim 8, wherein the information corresponding to the event includes a name of a location of the event.

13. The method of claim 8, wherein the information corresponding to the event includes a time of the event.

14. The method of claim 8, wherein the information corresponding to the event includes a title of the event.

15. The method of claim 8, wherein the information corresponding to the event includes a description of the event.

16. The method of claim 8, wherein the information corresponding to the event includes a list of one or more users that have indicated that they will attend the event.

17. The method of claim 8, wherein the information corresponding to the event includes a list of one or more users that have indicated that they will not attend the event.

18. The method of claim 8, wherein the information corresponding to the event includes a list of one or more users that have not responded to an invitation to the event.

19. The method of claim 8, further comprising:
in response to detecting the input corresponding to the request to view information corresponding to the event:
in accordance with a determination that an attendee of the event has added media to the event, displaying, via the one or more display generation components, a representation of at least a portion of the media; and
in accordance with a determination that an attendee of the event has not added media to the event, forgoing display of, via the one or more display generation components, a representation of media.

20. The method of claim 1, further comprising:
while displaying the control to share the event with another computer system, detecting, via the one or more input devices, an input corresponding to the control to share the event with another computer system; and
after detecting the input corresponding to the control to share the event with another computer system, displaying, via the one or more display generation components, a list of one or more contacts.

21. The method of claim 20, wherein the list of one or more contacts consists of one or more contacts that has not already been invited to the event.

22. The method of claim 20, wherein the list of one or more contacts includes a contact that has already been invited to the event.

23. The method of claim 22, wherein the list of one or more contacts includes an indication that the contact has already been invited to the event.

24. The method of claim 20, further comprising:
while displaying the list of one or more contacts, detecting, via the one or more inputs devices, an input corresponding to a respective contact in the list of one or more contacts; and
after detecting the input corresponding to the respective contact in the list of one or more contacts:
in accordance with a determination that the respective contact is a first contact, sending, to the first contact, an invitation to the event; and
in accordance with a determination that the respective contact is a second contact different from the first contact, sending, to the second contact, an invitation to the event.

25. The method of claim 24, further comprising:
after detecting the input corresponding to the respective contact in the list of one or more contacts, displaying, via the one or more display generation components, a draft of a message to the respective contact.

26. The method of claim 25, wherein the draft of the message includes auto-generated content corresponding to the event.

27. The method of claim 1, further comprising:
after detecting the input corresponding to the request to attend the event and while displaying media, detecting, via the one or more input devices, an input corresponding to a request to share the media; and
after detecting the request to share the media, displaying, via the one or more display generation components, a control to send the media to the event.

28. The method of claim 27, further comprising:
after sending the media to the event and in response to detecting the input corresponding to the request to view information corresponding to the event, displaying, via the one or more display generation components, an indication of the media.

29. The method of claim 1, wherein the first set of one or more criteria includes a criterion that is satisfied when a user of the first computer system is a first user, and wherein the criterion is not satisfied when the user of the first computer system is a second user different from the first user.

30. The method of claim 1, wherein the first set of one or more criteria includes a criterion that is satisfied when the invitation is a first type of invitation, and wherein the criterion is not satisfied when the invitation is a second type of invitation different from the first type of invitation.

31. The method of claim 1, wherein the first set of one or more criteria includes a criterion that is satisfied when the event is a first type of event, and wherein the criterion is not satisfied when the event is a second type of event different from the first type of event.

32. The method of claim 1, wherein the first set of one or more criteria includes a criterion that is satisfied when a current time is a threshold time before a time of the event, and wherein the criterion is not satisfied when the event is the current time is not the threshold time before the time of the event.

33. A non-transitory computer-readable storage medium storing one or more programs configured to be executed by one or more processors of a first computer system that is in communication with one or more input devices and one or more display generation components, the one or more programs including instructions for:
receiving, from a second computer system different from the first computer system, an invitation to an event;
after receiving the invitation to the event, detecting, via the one or more input devices, an input corresponding to a request to attend the event;
after detecting the input corresponding to the request to attend the event, detecting, via the one or more input devices, an input corresponding to a request to view information corresponding to the event; and
in response to detecting the input corresponding to the request to view information corresponding to the event:
in accordance with a determination that a first set of one or more criteria is satisfied, displaying, via the one or more display generation components, a control to share the event with another computer system; and
in accordance with a determination that the first set of one or more criteria is not satisfied, forgoing display of, via the one or more display generation components, the control to share the event with another computer system.

34. A first computer system configured to communicate with one or more input devices and one or more display generation components, comprising:
one or more processors; and
memory storing one or more programs configured to be executed by the one or more processors, the one or more programs including instructions for:
receiving, from a second computer system different from the first computer system, an invitation to an event;
after receiving the invitation to the event, detecting, via the one or more input devices, an input corresponding to a request to attend the event;
after detecting the input corresponding to the request to attend the event, detecting, via the one or more input devices, an input corresponding to a request to view information corresponding to the event; and
in response to detecting the input corresponding to the request to view information corresponding to the event:
in accordance with a determination that a first set of one or more criteria is satisfied, displaying, via the one or more display generation components, a control to share the event with another computer system; and
in accordance with a determination that the first set of one or more criteria is not satisfied, forgoing display of, via the one or more display generation components, the control to share the event with another computer system.
